(19) United States
(12) Patent Application Publication
(10) Pub. No.: US 2013/0011704 A1
(43) Pub. Date: Jan. 10, 2013

(54) Redox Flow Battery System with Multiple Independent Stacks

(75) Inventors: Craig Richard Horne, Sunnyvale, CA (US); Darren Bawden Hickey, Santa Clara, CA (US); On Kok Chang, San Jose, CA (US); Sumitha Durairaj, San Jose, CA (US); Ronald James Mosso, Fremont, CA (US); Deepak Bose, Fremont, CA (US)

(73) Assignee: EnerVault Corporation, Sunnyvale, CA (US)

(21) Appl. No.: 13/345,575

(22) Filed: Jan. 6, 2012

Related U.S. Application Data
(63) Continuation-in-part of application No. 12/883,511, filed on Sep. 16, 2010.
Application No. 12/883,511 is a division of application No. 12/498,103, filed on Jul. 6, 2009, now Pat. No. 7,820,321.
(60) Provisional application No. 61/430,812, filed on Jan. 7, 2011.
(60) Provisional application No. 61/078,691, filed on Jul. 7, 2008.
(60) Provisional application No. 61/093,017, filed on Aug. 29, 2008.

(51) Int. Cl. H01M 2/36; H02J 7/00; H01M 2/38

(52) U.S. Cl. 429/72; 429/101; 320/128

(57) ABSTRACT

A redox flow battery system is provided with independent stack assemblies dedicated for charging and discharging functions. In such a system, characteristics of the charging stack assembly may be configured to provide a high efficiency during a charging reaction, and the discharging stack may be configured to provide a high efficiency during a discharging reaction. In addition to decoupling charging and discharging reactions, redox flow battery stack assemblies are also configured for other variables, such as the degree of power variability of a source or a load. Using a modular approach to building a flow battery system by separating charging functions from discharging functions, and configuring stack assemblies for other variables, provides large-scale energy storage systems with great flexibility for a wide range of applications.

### RELATED APPLICATIONS

This application is a continuation-in-part of U.S. patent application Ser. No. 12/883,511 filed Sep. 16, 2010, which is a Divisional of U.S. patent application Ser. No. 12/498,103, filed on Jul. 6, 2009, now U.S. Pat. No. 7,820,321, which claims the benefit of priority to U.S. Provisional Application No. 61/078,691 filed Jul. 7, 2008 and U.S. Provisional Application No. 61/093,017 filed Aug. 29, 2008. This application also claims the benefit of U.S. Provisional Patent Application 61/430,812, filed Jan. 7, 2011. The entire contents of each of the above patent applications are hereby incorporated by reference herein for all purposes.

### STATEMENT REGARDING FEDERALLY SPONSORED RESEARCH

Inventions conceived after the filing of the priority application (U.S. patent application Ser. No. 12/498,103, filed on Jul. 6, 2009) that are included in this continuation-in-part patent application were made with Government support under DE-OE0000225 “Recovery Act—Flow Battery Solution for Smart Grid Renewable Energy Applications” awarded by the US Department of Energy (DOE). The Government has certain rights in such inventions. However, the Government does not have rights in U.S. Pat. No. 7,820,321 which was conceived and filed without Government support, nor in the direct continuation and divisional applications thereof.

### FIELD OF THE INVENTION

This invention generally relates to redox flow battery energy storage systems, and more particularly to redox flow battery energy storage systems comprising a plurality of independent purpose-configured stack assemblies.

### BACKGROUND

The current electric grid in the US suffers from a substantial limitation due to its lack of any storage capacity. All electricity produced by generation facilities must by consumed immediately. This need to exactly match supply with demand has created a complex network of electric generation facilities whose output can be increased or decreased to match demand at any given moment.

Many renewable energy technologies, while economically viable and environmentally beneficial, suffer from the disadvantage of periodic and unpredictable power generation. It is very difficult, if not impossible to control such intermittent generation technologies in order to match grid demand. Such technologies can arguably be used to provide a minimum “baseline” power to the grid, but this limits the expansion possibilities for such alternative generation technologies. To enable renewable energy technologies to expand, large scale energy storage systems are required in order to allow electricity generated by intermittent generation technologies to be reliably delivered to the grid to match demand.

Additionally, many conventional electric generation technologies, such as coal, gas-fired and nuclear power plants, as well as promising alternative energy generation technologies, such as fuel cells, function best when operated at constant power. Because power demanded by the electric grid fluctuates dramatically based on the variable needs of electricity consumers, such generation facilities are often operated in less-efficient modes. Thus, these conventional generation facilities can also benefit from energy storage systems that can store energy during off-peak hours and deliver peak power during times of peak demand.

Reduction/oxidation or “redox” flow batteries represent a promising large-scale energy storage technology. Redox flow batteries are electrochemical systems in which both the anode and cathode are dissolved in liquid electrolytes. With all four reactant states (i.e. charged and discharged states of cathode and anode), dissolved in a liquid, the storage capacity of such systems is a function of tank size.

### SUMMARY

In order to build a general purpose flow battery systems (i.e. one which can be charged by a wide variety of power sources and discharged to a wide variety of loads), many engineering compromises are typically made. Such compromises often result in sacrificed efficiencies during either or both of the charging process and the discharging process.

The all-liquid nature of flow batteries provides the unique advantage of allowing for the decoupling of charging and discharging processes. Thus, it is possible to provide a single collection of electrochemical reaction cells (also referred to herein as a “stack assembly”) for a charging operation, while providing a second, independent collection of electrochemical reaction cells for a discharging operation. In such a system, characteristics of the charging stack assembly may be configured to provide a high efficiency during a charging reaction, and the discharging stack may be configured to provide a high efficiency during a discharging reaction.

In addition to decoupling charging and discharging reactions, it is also possible to configure stack assembly characteristics for other variables, such as the degree of power variability of a source or a load. The systems and methods herein provide a modular approach to building a flow battery system in which charging functions are separated from discharging functions. Furthermore, systems and stack assemblies may be configured for the type of power source and/or load. For example, in some embodiments, system components are configured for intermittent or highly variable power sources or loads. In other embodiments, system components are configured for constant-voltage, constant-power, or minimally variable power sources or loads.

### BRIEF DESCRIPTION OF DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a system diagram of an embodiment large stack redox battery system showing a cross sectional schematic illustration of a redox battery stack from a first viewing perspective.

FIG. 2 is cross sectional schematic illustration of an embodiment redox battery stack cell layer of three cells from a second viewing perspective.

FIG. 3A is a cross section diagram of an embodiment single redox battery cell from a third viewing perspective.

FIG. 3B is an exploded view of an embodiment single redox battery cell.

FIG. 4 illustrates two chemical equations of a chemical reaction that may be employed within a redox battery embodiment.

FIG. 5 is a graph of design parameters that may be implemented within a redox battery system embodiment.

FIG. 6 is a graph of electrical potential versus current of a redox battery.

FIG. 7A is a schematic diagram of a redox flow battery stack according to an embodiment.

FIG. 7B is an assembly drawing illustrating how cell layers may be assembled into a flow battery stack according to an embodiment.

FIG. 7C is assembly drawing illustrating how cell layers may be assembled into a flow battery stack according to an alternative embodiment.

FIG. 8 is an illustration of a separator portion of a redox battery cell according to an embodiment.

FIG. 9 is system diagram of a wind farm system implementation embodiment with thermal integration.

FIG. 10 is system diagram of a solar power system implementation embodiment with the electrolyte fluid heated directly by the solar panels.

FIG. 11 is system diagram of an alternative solar power system embodiment with thermal integration via a secondary fluid flowing around the power stack.

FIG. 12 is a table of system design parameters according to an embodiment.

FIG. 13A is a system block diagram of an embodiment system including a redox flow battery used as an AC to DC power conversion/isolation direct current electrical power source.

FIG. 13B is a system block diagram of an embodiment system including a redox flow battery used as a surge electrical power source for recharging electric vehicles.

FIG. 13C is a system block diagram of an alternative embodiment system including a redox flow battery used as a surge electrical power source for recharging electric vehicles.

FIG. 13D is a system block diagram of an embodiment system including a redox flow battery used as an electrical power storage and load following power management system enabling a fuel cell to provide AC power to an electrical grid.

FIG. 14 is a cross sectional component block diagram of a gravity driven redox flow battery embodiment.

FIGS. 15A-15C are a series of cross sectional component block diagrams of a gravity driven redox flow battery embodiment illustrating a transition from charging mode to discharging mode.

FIGS. 16A-16C are micrographs showing representative separator materials suitable for use in each of three cells of a three-cell stack cell layer redox flow battery embodiment.

FIG. 17 is a system diagram of an embodiment large stack redox battery system showing a cross sectional schematic illustration of a redox battery stack with reactant storage tanks including tank separators.

FIG. 19 is a graph of battery cell potential versus time illustrating effects of mixing of charged and discharged reactants.

FIGS. 18A-18F are cross sectional diagrams of an embodiment electrolyte storage tank including a tank separator illustrating movement of the tank separator through a charging or discharging cycle.

FIGS. 20A-20F are cross sectional diagrams of an embodiment electrolyte storage tank including a tank separator illustrating movement of the tank separator through a charging or discharging operations.

FIG. 21 is a matrix illustrating examples of design permutations for a redox flow battery system with multiple independent stack assemblies.

FIG. 22A is schematic illustration of a power arrangement for a flow battery stack assembly.

FIG. 22B is schematic illustration of a power arrangement for a flow battery stack assembly.

FIG. 24A is a block diagram illustrating an embodiment of a converging cascade flow battery stack assembly.

FIG. 24B is a block diagram illustrating an embodiment of a bi-directional converging cascade flow battery stack assembly.

FIG. 25 is a schematic illustration of an embodiment of a redox flow battery having a pair of independent stack assemblies configured to operate in a two-tank mode.

FIG. 23 is a schematic illustration of a cascade redox flow battery stack assembly configured with a variable number of active cascade stages.

FIG. 26 is a flow chart illustrating an embodiment of a generic process for configuring a flow battery stack assembly for a particular application.

FIG. 27 is a schematic illustration of a redox flow battery system with one stack assembly configured for charging, and a second stack assembly configured for discharging.

FIG. 28 is a schematic illustration of a redox flow battery system with two stack assemblies configured for charging, and a third stack assembly configured for discharging.

FIG. 29 is a schematic illustration of a redox flow battery system with two stack assemblies configured for discharging, and a third stack assembly configured for charging.

FIG. 30 is a schematic illustration of a redox flow battery system with two stack assemblies configured for charging, and two stack assemblies configured for discharging.

FIG. 31 is a schematic illustration of a redox flow battery system with multiple independent stacks, at least one of which is configured to operate in a two-tank mode.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the terms “about” or “approximately” for any numerical values or ranges indicates a suitable temperature or dimensional tolerance that allows the part or collection of components to function for its intended purpose as described herein.

Unless otherwise specified, the terms “flow battery cell” “cell,” “electrochemical cell” and similar terms refer to a single electrochemical reaction unit. In most embodiments, a flow battery cell comprises a positive electrode separated from a negative electrode by a separator membrane. As used herein, a “block” or “cell block” is a group or collection of electrochemical cells which may be (but are not necessarily) housed within a common unitary housing. Electrochemical cells within a single cell block are typically (but are not necessarily) configured similarly to one another. Also as used herein, the term “stage” refers to one cell block within an arrangement of a plurality of stages arranged in hydraulic series such that an electrolyte flowing out of cells of one stage is directed into cells of another stage. Such an arrangement of stages may also be referred to as a “cascade” arrangement.

The term “engineered cascade flow battery” or “engineered cascade stack assembly” is used herein to refer generally to a cascade flow battery or a cascade flow battery stack assembly in which cells, stages (i.e. blocks or bundles of cells similarly configured and experiencing a substantially similar electrolyte state-of-charge) and/or arrays within the battery are configured in terms of materials (including material properties, quantities and other characteristics), design shapes and sizes, reactant flow, and/or other design variables based on an expected condition of reactants (e.g., the state of charge of electrolytes) so as to increase the battery's performance (e.g., energy storage efficiency, power generation efficiency, reduced electrolyte breakdown, reduced hydrogen generation, or other performance) over that achievable in a cascade flow battery in which all cells, stages and/or arrays along the reactant flow path are substantially the same as one another. Such cell or stage configurations may be made to optimize a cell's operation for an expected state of charge of electrolytes in that cell or stage.

References to “optimized” or “optimum” are merely intended to indicate design parameters which may be controlled or varied in an engineered cascade flow battery in order to improve performance and to distinguish the embodiments from designs in which there is no configuration based on expected local properties of reactants. Use of these terms is not intended to imply or require that the any cells, stages and/or arrays or components thereof are designed for the best possible or theoretical performance.

As used herein the phrase “state of charge” and its abbreviation “SOC” refer to the chemical species composition of at least one liquid electrolyte. In particular, state of charge and SOC refer to the proportion of reactants in the electrolyte that have been converted (e.g. oxidized or reduced) to a “charged” state from a “discharged” state. For example, in a redox flow battery based on an Fe/Cr redox couple, the state of charge of the catholyte (positive electrolyte) may be defined as the percent of total Fe which has been oxidized from the Fe²⁺ state to the Fe³⁺ state, and the state of charge of the anolyte (negative electrolyte) may be defined as the percent of total Cr which has been reduced from the Cr³⁺ state to the Cr²⁺ state. In some embodiments, the state of charge of the two electrolytes may be changed or measured independent of one another. Thus, the terms “state of charge” and “SOC” may refer to the chemical composition of only one or of both electrolytes in an all-liquid redox flow battery system. The skilled artisan will also recognize that the state of charge of one or both electrolytes can be changed by processes other than electrochemical processes (e.g., by adding quantities of one or more reactant species).

The embodiments provide an energy storage system based upon a reduction/oxidation (redox) flow battery system that is suitable for storing and delivering electric energy under a wide variety of conditions. Electric energy stored by the redox flow battery system can be produced from a wide variety of electric generation or conversion methods, including hydroelectric, natural gas, coal, gasoline, diesel or other liquid petroleum fuel, nuclear, wave power, tidal power, solar, thermal energy, wind, etc. The redox flow battery systems of the various embodiments are also capable of delivering stored energy to a wide variety of loads, including a distributed electrical grid, a data center, an irrigation pump, a cellular telephone station, another energy storage system, a vehicle, a vehicle charging system, a building, or any other electrical load.

Flow batteries are electrochemical energy storage systems in which electrochemical reactants are dissolved in liquid electrolytes (sometimes referred to herein collectively as “reactant” or “reactants”), which are pumped through reaction cells (referred to herein as “cells”) where energy is either added to or extracted from the battery. In applications where megawatts of electrical energy must be stored and discharged, a redox flow battery system can be expanded to the required energy storage capacity by increasing tank sizes and expanded to produce the required output power by adding electrochemical cells or cell blocks (i.e., groups of multiple cells which are sometimes referred to herein as “cell arrays”).

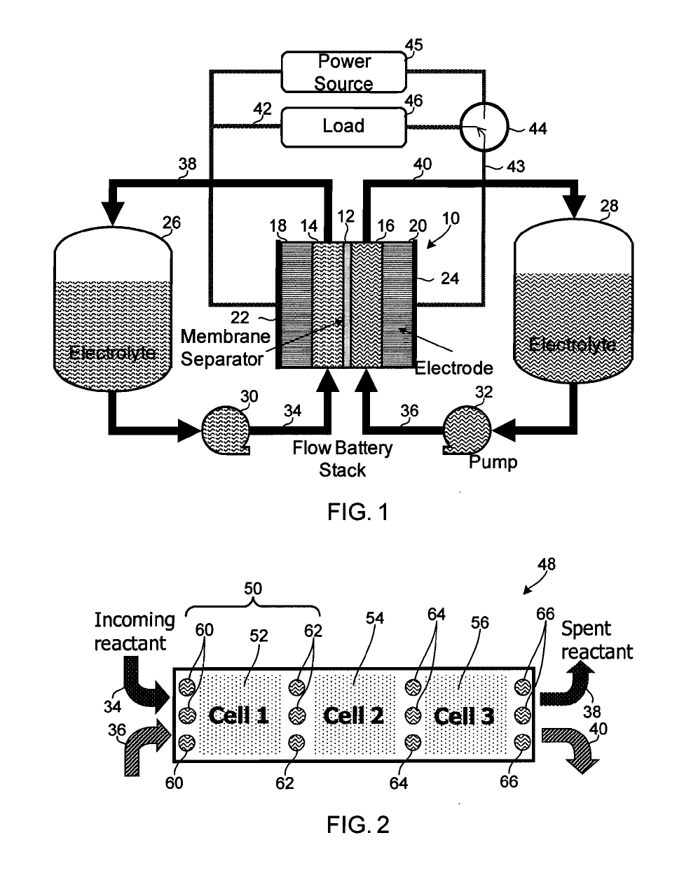

A system diagram of an embodiment of a redox flow battery energy storage system is illustrated in FIG. 1. The embodiment illustrated in FIG. 1 utilizes a stack design for the redox flow battery which enables large scale applications to be implemented with common affordable battery components. In applications where megawatts of electrical energy must be stored and discharged, e.g., a wind turbine farm or solar power plant coupled to a power grid, the redox flow battery system illustrated in FIG. 1 can be expanded to the required capacity by increasing tank sizes and, expanded in terms of produced power by adding redox flow battery stack assemblies or cell blocks. Simply put, the amount of energy that can be stored is determined by the amount of electrolyte stored in the system. Thus, to store more energy, larger electrolyte storage tanks are used. To increase the output power, more redox flow battery cells and/or stack assemblies are added. Thus, the systems shown and described herein provide great flexibility in addressing a wide range of energy storage requirements.

Referring to FIG. 1, the main components of the redox flow battery system include the redox flow battery stack assembly 10 through which two electrolytes flow through porous electrodes 18, 20 which are separated by a separator membrane 12. Reduction and oxidation reactions that can occur in the respective electrolytes cause electricity to flow through the reaction chamber which is captured by porous electrodes 18, 20 and conducted to conductive surfaces 22, 24. In some embodiments flow channels 14, 16 may be included in the redox flow battery stack assembly 10 to reduce electrolyte flow restrictions through the stack. Including such flow channels 14, 16 can be used to reduce electrolyte pressure drops. In an embodiment, the flow channels 14, 16 may be incorporated so that the electrolytes have sufficient interaction with the porous electrodes 18, 20 to enable the required reduction and oxidation reactions to take place.

The conductive surfaces 22, 24 are coupled to conductors 42, 43 which complete a circuit through either an electrical power source 45 (for charging) or an electrical power load 46 (for discharge), which may be selected in single stack embodiments via an electrical switch 44. The cathode electrolyte (“catholyte) and anode electrolyte (“anolyte”) are stored in electrolyte tanks 26, 28, and are pumped by pumps 30, 32 to provide the input flows 34, 36 to the redox flow battery stack assembly 10, with battery output flows 38, 40 returning to the electrolyte tanks 26, 28. The redox flow battery stack assembly 10 is designed for reduce cost by keeping the complexity and part count of the stack to a minimum. The redox flow battery stack assembly 10 is further designed to minimize shunt current losses and maximizing reactant utilization.

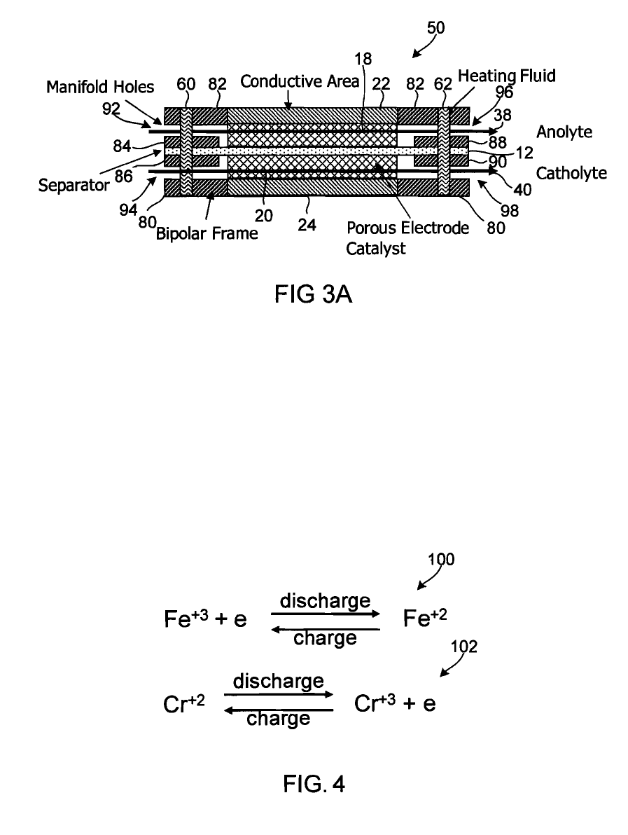

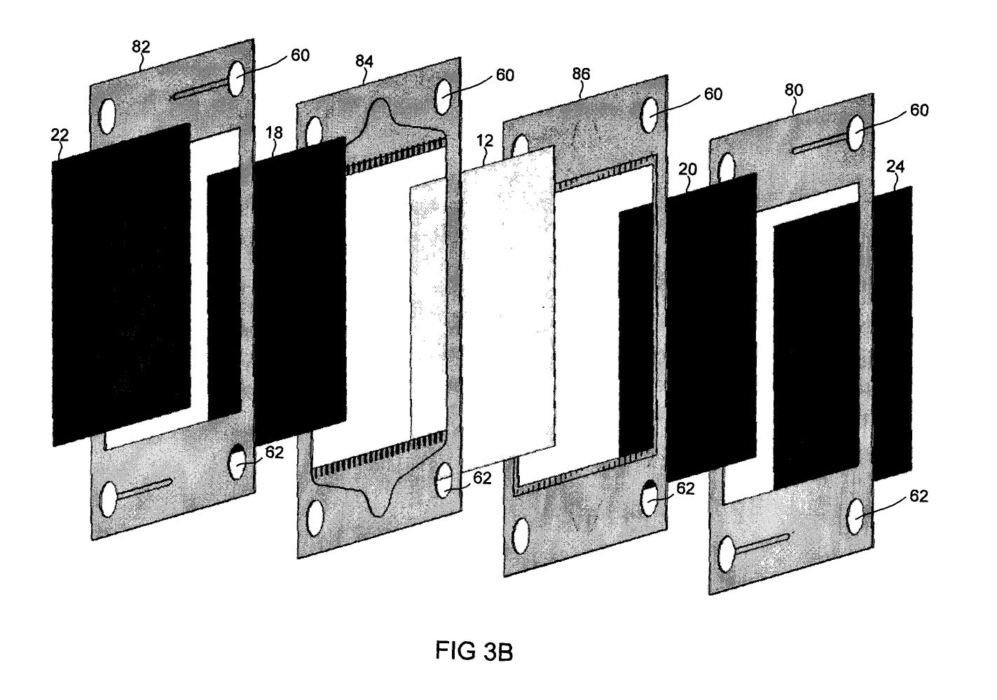

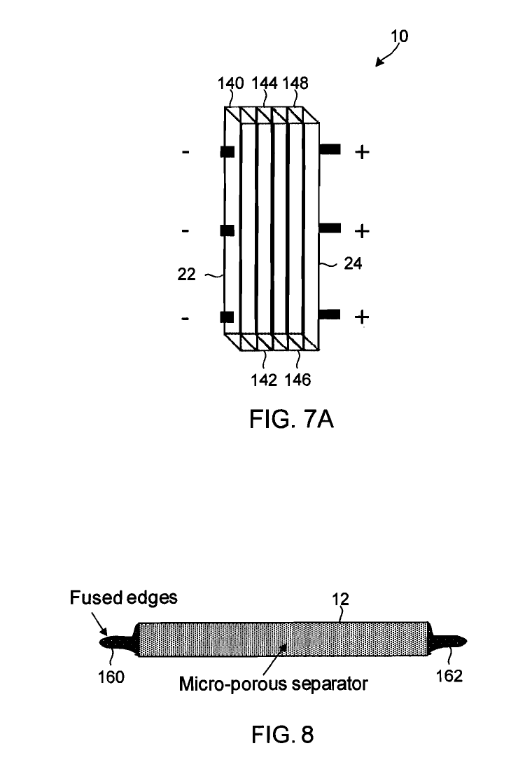

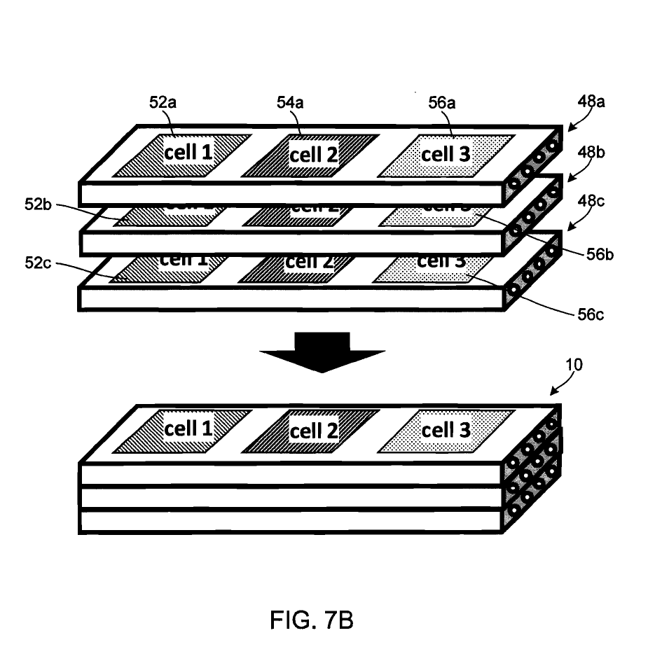

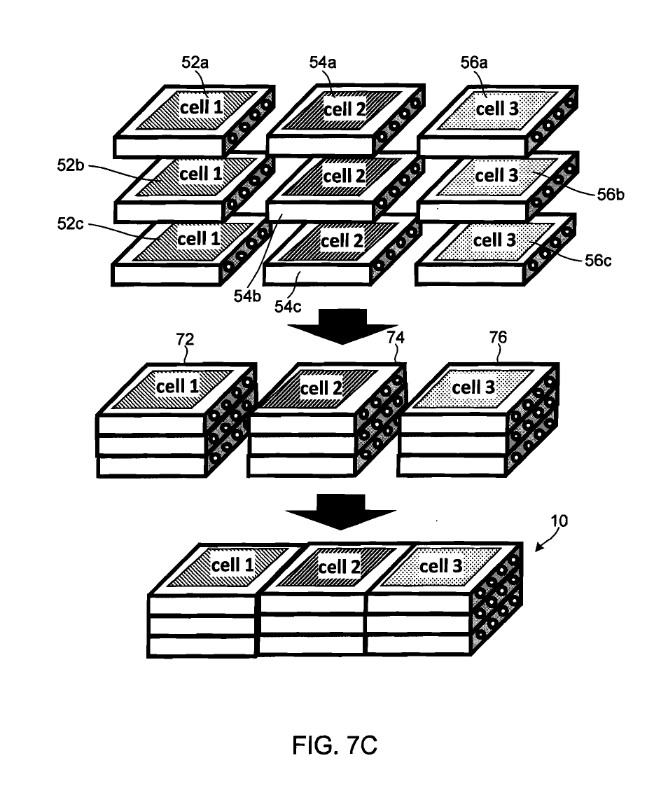

The redox flow battery stack assembly 10 is configured to include an array of independent battery cells, assembly frames as shown in FIGS. 2 and 3. The independent battery cells are arranged so that electrolyte reactant flows from one cell to the next within a stack layer 48 (see FIG. 2). Multiple layers 48 of battery cells are stacked together connected in series to form a stack assembly 10 as described below with reference to FIG. 7A. Further, the independent battery cells are configured to increase their electrochemical performance based upon their location within the reactant flow path, thus resulting in a redox flow battery assembly that has greater overall electrical storage performance than possible with identical battery cells.

FIG. 2 illustrates a cross-section of an individual single cell layer 48 within a redox flow battery stack assembly 10 as viewed from a perspective perpendicular to the plane of the electrodes 18, 20 and the membrane separator 12 (i.e., short axis of layer 48 is into and out of the page of FIG. 1). The illustrated cell layer 48 includes three independent cells 52, 54, 56, as an example embodiment; in other embodiments each cell layer 48 may include fewer or more independent cells. In a preferred embodiment, the electrolyte reactant flows across all the cells in a cell layer 48 within the array (i.e., parallel to the image surface of FIG. 2) in a cascading manner (i.e., one cell to the next within a given layer). This multiple cell configuration within each cell layer mitigates problems with shunt currents. To enhance overall efficiency and battery performance, the battery cells are configured with varying catalyst loadings, electrode tortuosity, chamber volumes, and/or membrane separator porosities or selectivity to handle the variations in reactant concentration along the flow path, minimize undesired reactions, and optimize coulombic and voltage efficiencies. For example, as illustrated in FIG. 2, in a three-cell redox flow battery cell layer assembly 48, a first cell 52 near the reactant inlet flows 34, 36 may be configured with structural and material properties to offer greater efficiency with the higher state of charge condition of the electrolyte at the input to the battery cell layer assembly. A second cell 54 may then be configured with structural and material properties to provide efficient operation with the intermediate state of charge condition of the electrolytes that will exist after the electrolytes have passed through the first cell 52. The third cell 56 may be configured with structural and internal properties to provide efficient operation with the relatively low state of charge condition that will exist in the electrolytes after they have reacted in the first and second cells 52, 54. As described in more detail below, configuring the redox flow battery cell layer assembly 48 in this manner provides efficient operation while enabling the battery to be assembled with lower-cost materials.

The selectivity of a separator membrane refers to the degree to which particles, ions and/or compounds are restricted from moving through the separator. As used herein, “selectivity” is a broad term which encompasses several possible material properties which may work individually or in combination to restrict the movement of ions and/or other compounds from moving from one half-cell through the separator membrane into another. For example, the number of pores, pore size, path tortuosity, pore surface chemistry and other physical properties of a membrane may contribute to a membrane's selectivity. Thus, separator membranes with a higher selectivity restrict the movement of more ions (i.e. allow fewer ions to pass through), while membranes with lower selectivities provide less restriction to the movement of certain ions, allowing more ions to pass through. High selectivity membranes may include any number of ion exchange membranes, such as a Nafion®-117 ion-exchange membrane (DuPont, USA), which allows protons to pass through, while restricting the crossover of other larger positively charged ions and negatively charged ions. Low selectivity membranes may include any number of micro porous membranes, which may allow the passage of particles substantially larger than ions. As used herein, the term “selectivity” may be equivalent to alternative terms such as “inverse transmitivity.”

Some types of flow battery electrolytes operate more efficiently (i.e., retaining and discharging electrical power with lower losses) when the fluids are heated to an optimum temperature. To take advantage of this characteristic, the redox flow battery cell layer assembly 48 may be configured with tubes 60, 62, 64, 66 or channels through which a heating fluid can be circulated. Circulating a heating fluid around and/or within the battery stack assembly can keep the electrolytes at a controlled temperature. By including heating fluid tubes 60, 62, 64, 66 before and after each battery cell, the operating temperature of each cell can be controlled individually so as to enable each cell to operate at a preferred or optimum temperature corresponding to the state of charge of electrolytes within the cell. The heating fluid tubes are optional because in an embodiment the electrolytes may be preheated within the tanks 26, 28, such as via a heat exchanger circulating a heating fluid so that the electrolytes enter the cell layers 48 at a sufficient temperature for charging or discharging operations. As described more fully below, the heating fluid may draw thermal energy from waste heat generated by either the source of the charging power 45 (e.g., from a generator cooling system) or the load 46 (e.g., from an equipment cooling system).

A conceptual build of a single cell of a cell section within the cell layer 48 of a flow battery stack is illustrated in FIGS. 3A and 3B. FIG. 3A shows a cross-sectional view of a single layer of a single cell chamber 50 viewed from a perspective that is perpendicular to the cross-sectional perspectives in FIGS. 1 and 2. FIG. 3B shows an exploded view of a single cell 50 of an individual single cell layer. A bipolar frame formed from first and second planar structural members 80, 82 provides the structural support for the redox flow battery stack assembly 10. The planar structural members 80, 82 may be made from polyethylene, polypropylene or other materials which are resistant to the mild acid of the electrolyte reactants. Between the planar structural members 80, 82 is formed a cavity which contains the porous electrode catalyst 18, through which anolyte and catholyte reactants flow 38, 40, respectively. The porous electrode may be made from a separate carbon fiber felt material or may be part of the bipolar frame itself. The porous electrode catalysts 18, 20 may be made from carbon felt material coated with a catalyst layer. In some implementations a surface catalyst layer may be lead (Pb), bismuth (Bi) or zirconium carbide (ZrC) to facilitate reduction-oxidation reactions with the electrolytes while suppressing generation of hydrogen gas. Within each planar structural member 80, 82 may be provided cutouts or inserts for conductor surfaces 22, 24, as illustrated in FIG. 3B. The conductor surfaces 22, 24 pass electric current from the porous electrode catalysts to the exterior of the cell layer.

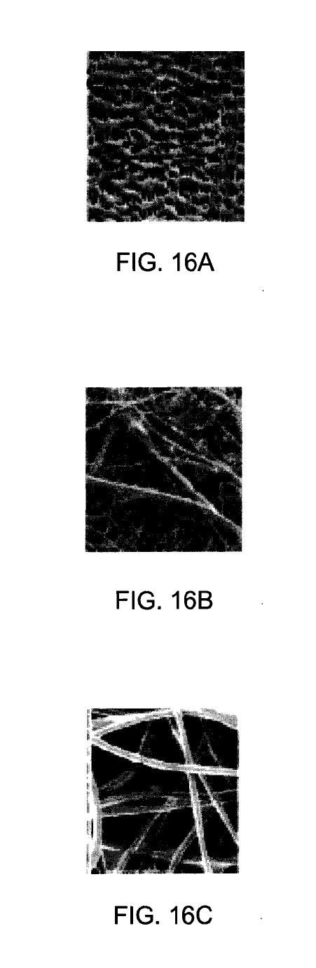

The anolyte and catholyte reactants are separated by a planar membrane separator 12 which is suspended between the two planar structural members 80, 82 by frame members 84, 86, 88, and 90. It should be noted that the frame members 84, 86, 88, 90 maybe in the form of two exterior frames as illustrated in FIG. 3B such that frame members 84 and 88 are part of a single frame 84 and frame members 86 and 90 are part of another single frame 86. The membrane separator 12 allows ions to transport through the material while inhibiting bulk mixing of the reactants. As described more fully below with reference to FIGS. 16A-16C, the membrane separator 12 may be made from different materials so as to exhibit varying diffusion selectivity and electrical resistance as appropriate for the expected state of charge within each battery cell.

At the reactant inlet of each battery cell 50, manifold holes 92, 94 may be provided to direct the incoming electrolyte flows into the reaction area of the cell 50. In an embodiment, the manifolds may include flow directing structures to cause proper mixing of the electrolytes as they enter each reaction cell 50. Such flow directing structures may be configured to adjust or control the reactant flow in each cell 50 within the redox flow battery stack assembly 10 based upon the expected state of charge and other fluid properties within each cell.

The planar structural members 80, 82, as well as separator frame members 84, 86, 88, 90 may include passages through which heat exchanger fluid pipes 60, 62 can pass. Positioning optional heat exchanger fluid pipes 60 within the cell input manifolds 92, 94 enables heat from the thermal fluid within the pipes to raise the temperature of the reactant flows before the reactants enter the cell chamber. Similarly, positioning heat exchanger pipes 62 within the cell output manifolds 96, 98 enables the thermal fluid to extract heat from the electrolytes after the reactants leave a final cell 56, thereby conserving thermal energy and enabling the electrolytes to be returned to storage tanks at a cooler temperature. In a preferred embodiment the thermal fluid is heated to a temperature of about 40 to 65° C. for Fe/Cr reactants.

A redox flow battery stack assembly 10 may be formed by stacking layers 48 in series to form a battery stack. In this battery stack assembly the conductive surfaces 22, 24 provide the electrical connectivity between cells in each stack cell layer as described below with reference to FIG. 7A.

The planar structural members 80, 82 which form the bipolar frame may be electrically conductive throughout their area, or may be made in such a way that only the conductive surfaces 22, 24 immediately adjacent to the electrochemically active portion of the cell 50 are electrically conductive, as illustrated in FIG. 3B. In the latter embodiment, the area around the conductive surfaces 22, 24 may be electrically insulating. Electrically insulating the areas around conductive surfaces 22, 24 allows for discrete control and monitoring of the current or potential of each type of cell in the redox flow battery stack assembly 10.

To form each cell layer 48 as illustrated in FIG. 2, multiple cells 50 as illustrated in FIGS. 3A and 3B are fluidically connected to form a cascade of cells within a single layer. Thus, the cell output manifolds 96, 98 of one cell line up with the cell input manifolds 92, 94 of the next cell within the cell layer 48 so the electrolyte flows from one cell to the next within each cell layer.

In the redox flow battery system of the various embodiments the cells can be replaceable and recyclable. Since the materials of construction are primarily plastics (e.g., polypropylene or polyethylene), carbon fiber felts, and carbon fiber electrodes, the cells contain no heavy metals or toxins that could pose an environmental impact. Further, the reactants, such as Fe/Cr, are no more toxic or dangerous than battery acid. Thus, the redox flow battery system of the various embodiments are ideal for providing the energy storage capacity required for renewable energy systems in a distributed fashion close to the population and load centers.

As explained more fully below with reference to FIG. 8, the porous separator 12 may be fused to a dense or partially dense state around the edges to prevent electrolyte reactants from seeping through the sealed edge regions. This reduces reactant mixing and leakage out of the redox flow battery stack assembly 10. Electrolyte reactant mixing through the porous membrane separator 12 is minimized because the concentration of the reactants on both sides of the membrane separator 12 are approximately the same, as the described below, with similar ion densities, thereby eliminating concentration gradients and reducing osmotic pressure across the membrane separator 12.

A variety of reactants and catalysts may be used in the redox flow battery system. A preferred embodiment set of electrolyte reactants is based upon the iron and chromium reactions illustrated in FIG. 4. The reactants in the Fe/Cr redox flow battery system stores energy in FeCl₃ (Fe³⁺) in the catholyte, which reacts at the positive electrode, and CrCl₂ (Cr²⁺) in the anolyte, which reacts at the negative electrode within cells of the battery.

An undesirable non-faradic electron transfer reaction can occur between Fe³⁺ and Cr²⁺ if these ions come into proximity to one another. Therefore, to maintain a high level of coulombic efficiency, electrolyte cross-mixing within a Fe/Cr redox flow battery stack should be minimized. One way to minimize electrolyte cross-mixing is to use a highly selective membrane separator 12 such as Nafion®-117 ion-exchange membrane (DuPont, USA). A disadvantage of highly-selective membrane separators is that they have low ionic conductivity which results in lower voltage efficiency within the redox flow battery stack. Additionally, ion-exchange membranes are expensive, with a price in the neighborhood of $500/m². Since the DC energy storage efficiency of a redox flow battery is the product of coulombic and voltage efficiencies, an optimization tradeoff exists.

A particular embodiment of the Fe/Cr system is what is known as the mixed reactant system where FeCl₂ (Fe²⁺) is added to the anolyte and CrCl₃ (Cr³⁺) is added to the catholyte, as described in U.S. Pat. No. 4,543,302, the entire contents of which are incorporated herein by reference. An advantage of the mixed reactant system is that the discharged anolyte and discharged catholyte are identical. Furthermore, when the total concentration of Fe in the anolyte is the same as the catholyte, and the total concentration of Cr in the catholyte is the same as the anolyte, the concentration gradients across the membrane separators 12 are eliminated. In this way the driving force for cross-mixing between anolyte and catholyte is reduced. When the driving force for cross-mixing is reduced less selective membrane separators may be used, thereby providing lower ionic resistance and lower system costs. Examples of less-selective membrane separators include microporous membrane separators manufactured by Celgard LLC, and membrane separators made by Daramic LLC, both of which cost in the neighborhood of $5 to 10/m². By optimizing the cell characteristics for the reactant state of charge and completing the charge or discharge in one pass, the embodiments described herein provide suitably high efficiency in a redox flow battery stack comprised of materials that are approximately two orders of magnitude lower cost than in conventional redox flow battery designs.

In both the unmixed and mixed reactant embodiments, the reactants are dissolved in HCl, which is typically about 1-3 M concentration. The electrocatalyst, which may be a combination of Pb, Bi and Au or ZrC, is provided at the negative electrode to improve the rate of reaction of recharging when Cr³⁺ in the anolyte is reduced to Cr²⁺, thereby reducing or eliminating hydrogen evolution. Hydrogen evolution is undesirable as it unbalances the anolyte from the catholyte and is a competing reaction to Cr³⁺ reduction leading to a reduction in coulombic efficiency.

The cell, cell layer and redox flow battery stack designs described herein can be used with other reactant combinations that include reactants dissolved in an electrolyte. One example is a stack containing the vanadium reactants V(II)/V(III) or V²⁺/V³⁺ at the negative electrode (anolyte) and V(IV)/V(V) or V⁴⁺/V⁵⁺ at the positive electrode (catholyte). The anolyte and catholyte reactants in such a system are dissolved in sulfuric acid. This type of battery is often called the all-vanadium battery because both the anolyte and catholyte contain vanadium species. Other combinations of reactants in a flow battery that can utilize the embodiment cell and stack designs include Sn (anolyte)/Fe (catholyte), Mn (anolyte)/Fe (catholyte), V (anolyte)/Ce (catholyte), V (anolyte)/Br₂ (catholyte), Fe (anolyte)/Br₂ (catholyte), and S (anolyte)/Br₂ (catholyte). In each of these example chemistries, the reactants are present as dissolved ionic species in the electrolytes, which permits the use of battery cell and stack designs in which electrolyte flow through a plurality of battery cells series along the flow path (i.e., cascade flow), with the cells and having different physical properties along the flow path (cell size, type of membrane or separator, type and amount of catalyst). A further example of a workable redox flow battery chemistry and system is provided in U.S. Pat. No. 6,475,661, the entire contents of which are incorporated herein by reference.

A number of cell chambers are formed in each bipolar frame in a redox flow battery stack array. FIG. 2 depicts a 1×3 array, but any combination is possible, e.g., a 2×2 or a 1×4 array. As described above, the electrolyte reactant flows from one cell 52, 54, and 56 to the next in a cascade arrangement. This cascade flow means that a cell 52 closest to the inlet will see higher reactant concentrations than downstream cells 54, 56 in the discharge mode. For example, for the Fe/Cr system in discharge mode, the Fe³⁺ and Cr⁺² species are the relevant ion concentrations as shown in FIG. 4. This cascading of battery cells arrangement provides the advantage of limiting shunt currents and improving overall reactant utilization. Shunt currents are formed due to short circuiting within the liquid reactants. It is therefore advantageous to form long conductive paths between one cell and the next, as well as limit the stack voltage. The various embodiments accomplish both objectives by flowing the reactants across multiple cells within the same layer. This cascade flow regime also improves reactant utilization compared to that of a single cell per layer stack arrangement. Improving reactant utilization helps to improve the roundtrip DC efficiency of the redox flow battery stack assembly 10 and reduces or eliminates the need to re-circulate the reactants. Recirculation can be disadvantageous because it may involve more pumping power per kW or stored capacity, which increases parasitic losses.

Due to the variation in reactant ion concentrations as the reactants flow through the various cells in each layer, the amounts of catalytic coating may be varied to match the state of charge condition in each of the respective cells. Additionally, the catalytic coating formations applied to the porous electrodes 18, 20 may be varied in formulation (e.g., varying amounts of zirconia or bismuth compounds) to better match the state of charge condition in each cell. For example, typically the cell with the lower reactant concentrations will require a higher catalyst loading on the porous electrodes to achieve optimum performance.

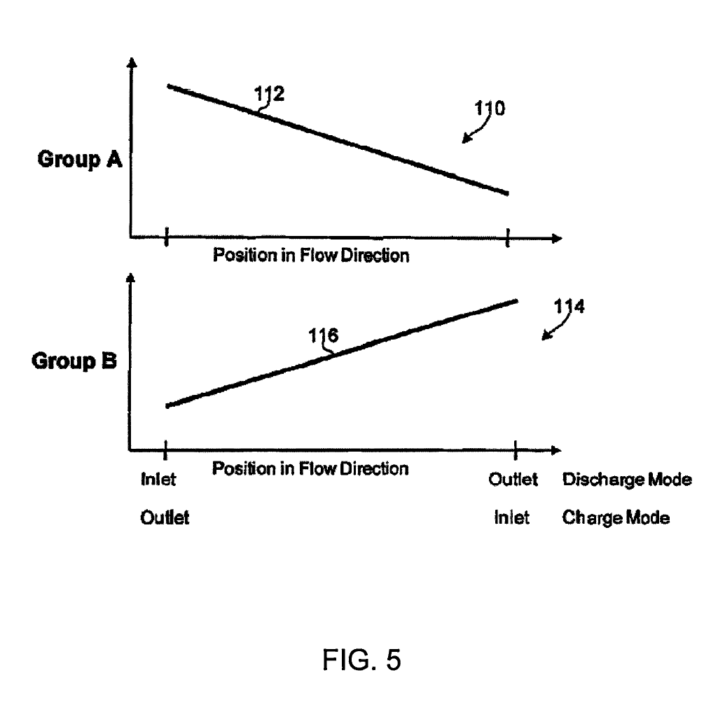

The various embodiments include a unique redox flow battery stack configuration that includes multiple independent cells within a flow path as illustrated in FIG. 2, with each independent cell configured in terms of size, shape, electrode materials and membrane separator layer material for optimum average performance with the state-of-charge of reactants within each cell. FIG. 5 summarizes some of the design configuration parameters that can be controlled and the manner in which the parameters are varied along the reactant flow path in order to maximize electrical performance of each independent cell in the redox flow battery stack assembly 10. As illustrated in design trend line 112, some design parameters—illustrated as Group A parameters—may be decreased from one end of a cell layer 48 to the other to configure the battery design so that the values decrease from reactant inlet to outlet from the cell layer in discharge mode and increase from reactant inlet to outlet from the cell layer in charging mode.

As illustrated in design trend line 116, other design parameters—illustrated as Group B parameters—may be increased from one end of a cell layer 48 to the other to configure the battery design so that the values increase from reactant inlet to outlet from the cell layer in discharge mode and decrease from reactant inlet to outlet from the cell layer in charging mode. As illustrated in FIG. 5, the design parameters that may be varied to configure battery cell designs according to design trend line 112 include: membrane selectivity; charge catalyst loading; charge catalyst activity; temperature (when optimizing charging); chamber volume (when optimizing charging); mass transport (when optimizing charging). The design parameters that may be varied to configure battery cell designs according to design trend line 116 include: ionic conductivity; discharge catalyst loading; discharge catalyst activity; temperature (when optimizing discharging); chamber volume (when optimizing discharging); mass transport (when optimizing discharging).

For example, as described above, the discharge catalyst loading and discharge catalyst activity (both Group B design parameters) may be increased in each cell along the flow path of redox flow battery stack assembly 10 from inlet to outlet in the discharge mode and decreased in each cell along the flow path of redox flow battery stack assembly 10 from inlet to outlet in the charge mode to compensate for decreasing reactant concentrations, as indicated by the design trend line 116.

Similarly, the charge catalyst loading and charge catalyst activity (both Group A design parameters) may be decreased in each cell along the flow path of redox flow battery stack assembly 10 from inlet to outlet in the discharge mode and increased in each cell along the flow path of redox flow battery stack assembly 10 from inlet to outlet in the charge mode to compensate for decreasing reactant concentrations, as indicated by the design trend line 112. The specific catalyst loading and catalysts activity implemented within each cell along the flow path can be determined using the design trend line 116 with respect to discharging, trend line 112 with respect to charging, and the number of cells in the path.

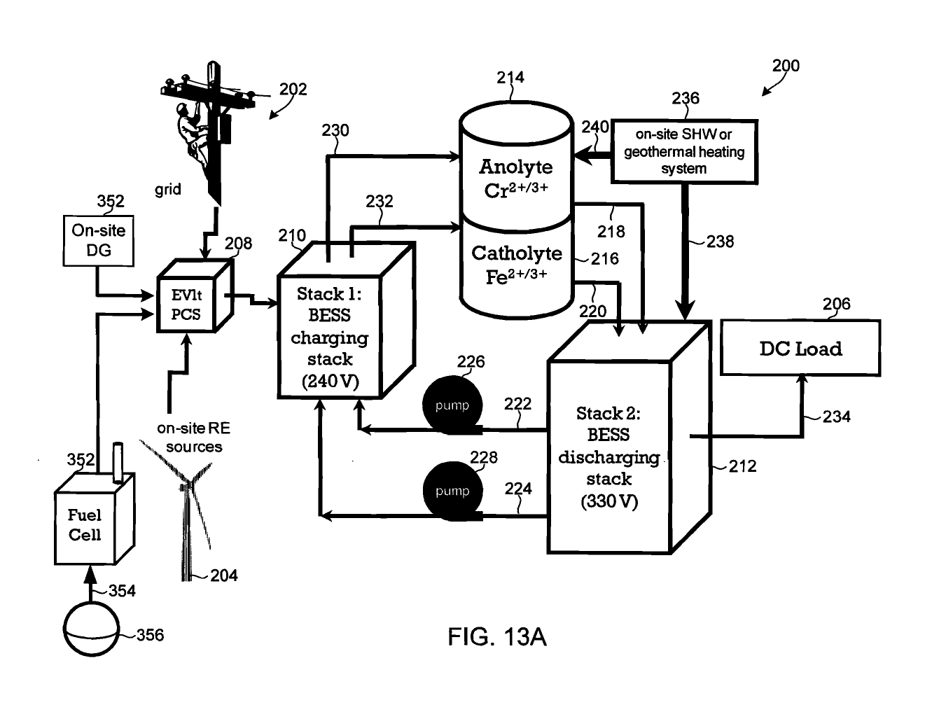

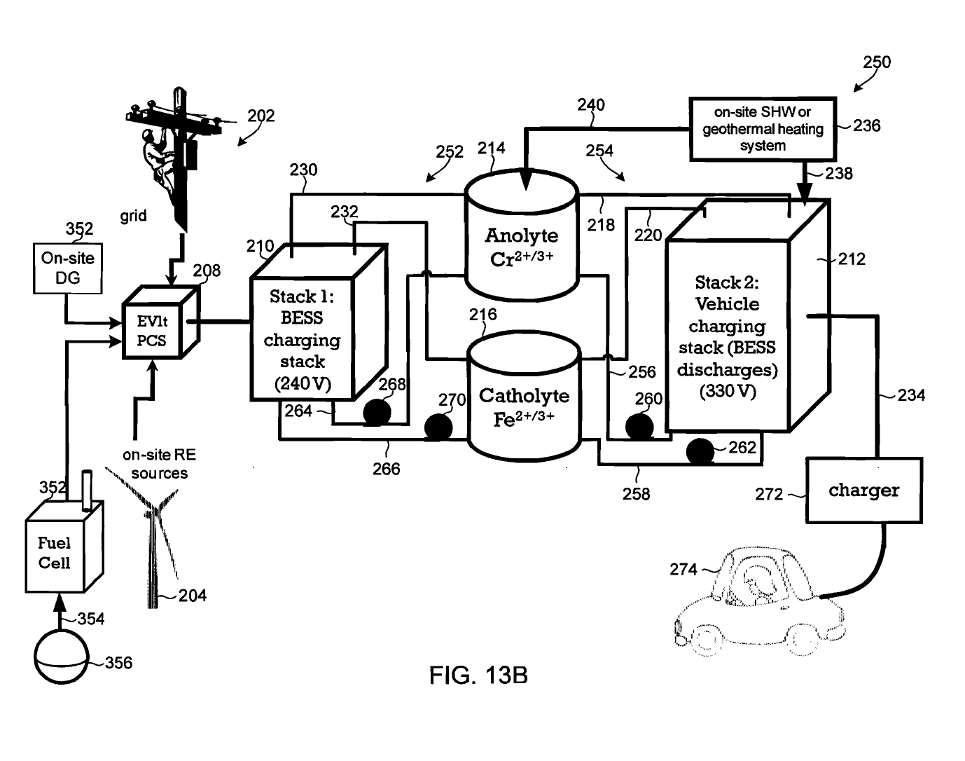

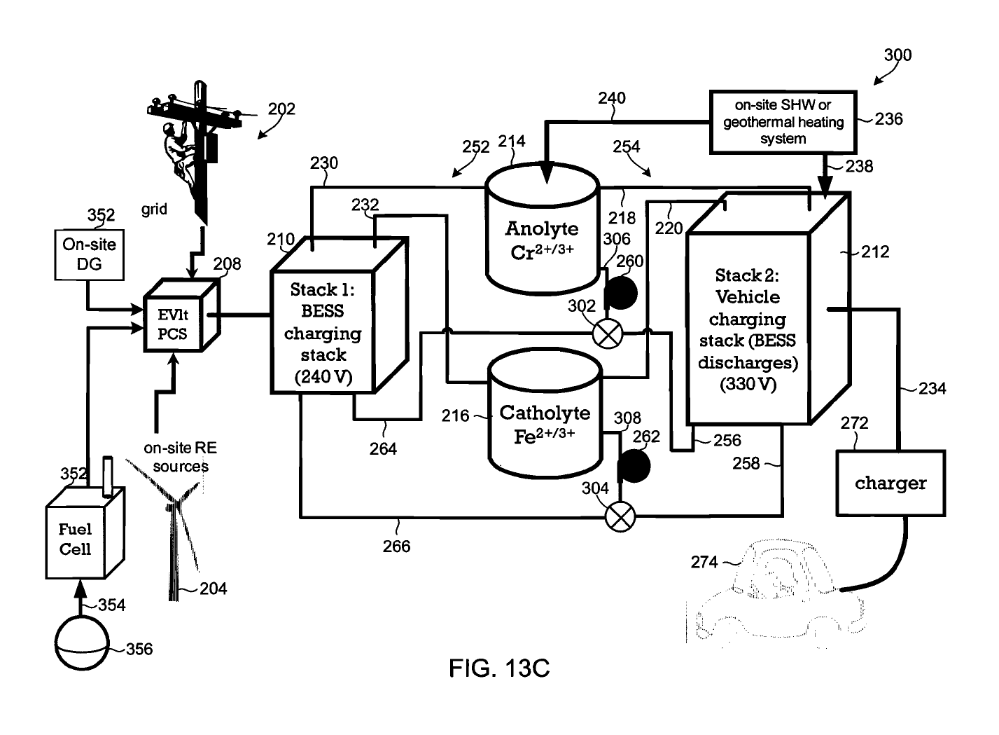

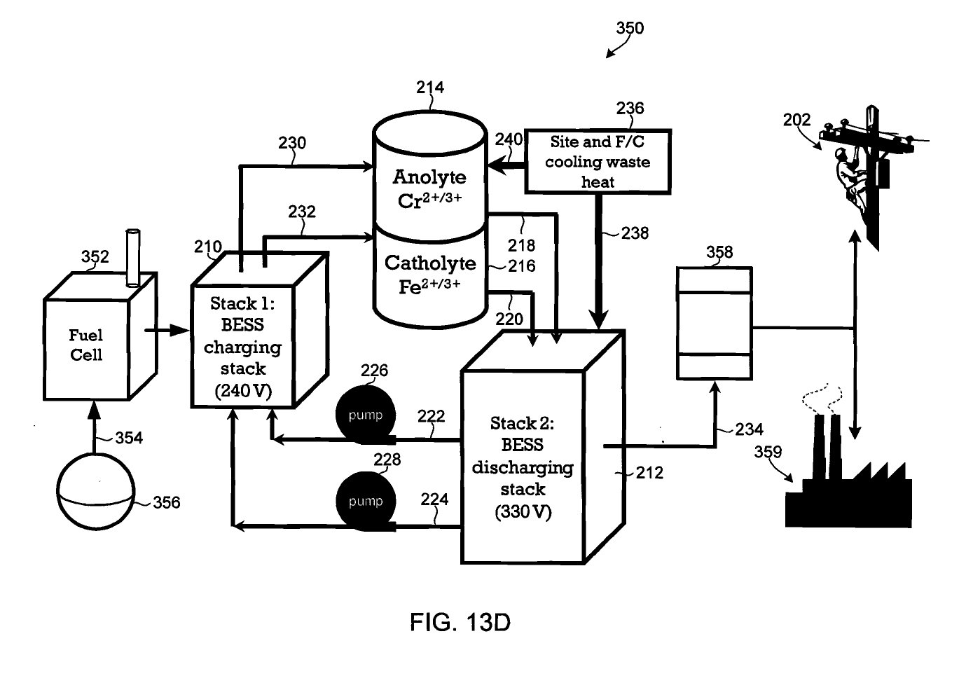

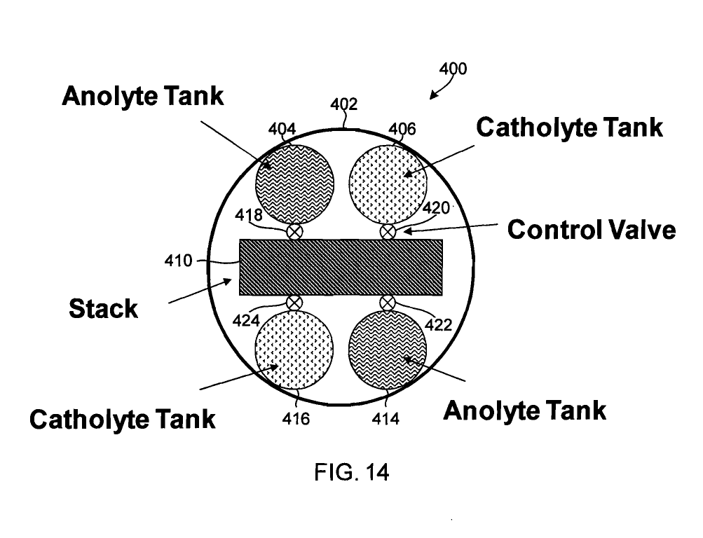

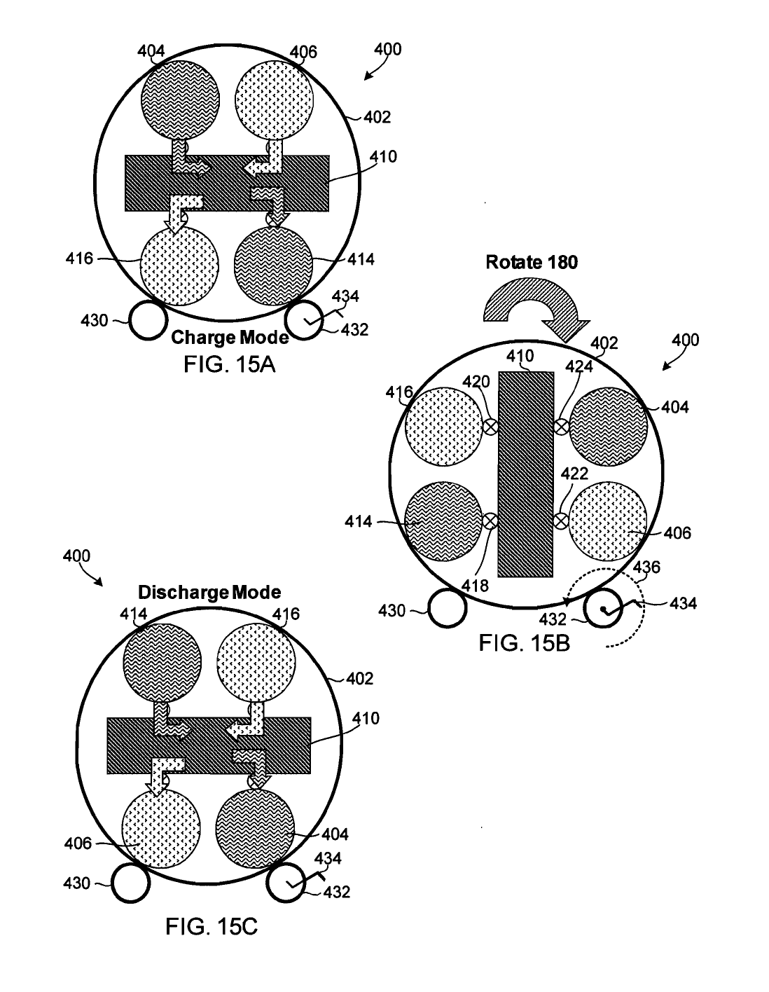

Using the design trend lines 112, 116 illustrated in FIG. 5, in some redox flow battery embodiments provide improved electrochemical performance by optimizing design parameters, such as the charge and discharge catalyst loadings and/or catalyst activities, in each layer in either direction through the battery stack, and flowing the reactants through the battery stack in one direction for discharging and in the opposite direction for charging. In some embodiments, such as described below with reference to FIGS. 14-15C, the reactants are directed through the redox flow battery in one direction in the charging mode and in the opposite direction in the discharging mode. In other embodiments, such as described below with reference to FIGS. 13A-13D, separate charging redox flow battery stacks are provided for charging and for discharging so the reactants flow in a single direction consistent with the cell configuration. In a third embodiment described below with reference to FIG. 1, electrolyte reactants flow through the redox flow battery stack in a single direction for both charging and discharging with the battery cells configured as a compromise between charging and discharging (e.g., preferentially configured for charging or discharging) so that the system can switch between charging and discharging modes very quickly simply by electrically disconnecting the redox flow battery stack assembly 10 from the charging power source (e.g., with an electrical switch) and connecting the stack to the load, or vice versa.

Similarly, the various embodiments may control the temperature of reactants as they flow through the redox flow battery stack depending upon whether the stack is charging or discharging. FIG. 5 illustrates in design curves 112 and 116 how the temperature may be controlled in an embodiment along the flow path through the redox flow battery cell layer 48 and stack assembly 10. For the chosen optimized half-cycle, at each cell along the reactant flow path in the discharge mode the temperature is increased so the cell closest to the outlet, which will have the lowest concentration of reactants, runs at a higher temperature than the cell closest to the inlet. The design curve to employ a given redox flow battery cell layer 48 and stack assembly 10 may be based on whether a greater improvement in battery efficiency is achieved by optimizing the discharge reactions or the charge reactions. In the Fe/Cr system, the anolyte charge reaction has the most limited reaction rates so design trend line 112 would be selected for the temperature profile design parameter. As with catalyst loading and catalysts activity, the redox flow battery cell layer 48 and stack assembly 10 can be configured so that reactants flow in one direction for charging and in the other direction for discharging, or as two separate redox flow battery stacks can be used with one configured for charging and the other configured for discharging.

In a similar manner, the various embodiments improve electrochemical performance by configuring the redox flow battery stack assembly 10 so that the reactant mass transport rate varies from cell to cell along the flow path. FIG. 5 also illustrates in design curve 116 how cells are configured so that the reactant mass transport rate increases in each cell along the flow path from inlet to outlet in the discharge mode, and decreases in each cell along the flow path from the inlet to the outlet while in the charging mode. The mass transport rate may be increased by decreasing the physical dimensions of each cell and selecting electrode catalyst materials to vary the electrode porosity. Thus, an embodiment redox flow battery stack assembly 10 may have a restricted flow area at one end and a more open and less constricted flow area at the other end, with the reactant mass transport rate increasing in each cell along the reactant flow path when operated in the discharge mode, and decreasing in each cell along the reactant flow path when operated in the charging mode.

In a similar manner, embodiment redox flow battery cells may be configured with different membrane separator 12 materials along the reactant flow path. FIG. 5 illustrates in the design curve 112 how the membrane separator 12 selectivity (i.e., the degree to which the reactants are restricted from moving through the separator) in each cell is varied along the reactant flow path. Cells near the inlet to the redox flow battery stack assembly 10 in the discharge mode will experience a high concentration of reactants (e.g., Cr²⁺ and Fe³⁺), and thus mixing of the reactants through the membrane separator 12 will result in greater losses of stored energy than is the case in cells near the outlet of the assembly. Therefore, the various embodiments achieve greater electrical charge/discharge efficiency by limiting the diffusion of reactants through the membrane separator 12 near the battery inlet. On the other hand, membrane separator materials which have high membrane selectivity typically also exhibit high ohmic losses (i.e., electrical resistance), which increases energy losses through the battery due to internal resistance. The countervailing properties result in the design curve 112 shown in graph 110 in FIG. 5 used to select separator materials depending upon the number of cells in the reactant flow path.

Thus, in an embodiment redox flow battery stack assembly 10 may include cells at one end of the flow path having membrane separators 12 made from a material with high membrane selectivity at the cost of greater ohmic losses, while cells at the other end of the flow path will have membrane separators 12 made from a material with lower ohmic losses. This design approach works because the driving force for cross mixing is greatly diminished due to the low concentrations of spontaneously-reacting active species at the outlet end in the discharge mode and at the inlet end in the charge mode. In the case of an Fe/Cr redox flow battery (FIG. 4) the concentration of Cr²+ and Fe³+ species are at a minimum at the outlet end in the discharge mode and at the inlet in the charge mode.

As mentioned above, the particular design configuration of each cell within a particular redox flow battery stack assembly 10 may be determined by applying the design trend lines illustrated in FIG. 5 to the number of cells along the reactant flow path within the assembly. Cells may be configured with design parameters selected for the average electrolyte concentration expected within each cell, which may provide a stair step approximation of the design trend lines illustrated in FIG. 5. By increasing the number of independent cells along the reactant flow path, the cell design parameters can better match the design trend lines. However, increasing the number of independent cells may add design complexity which may increase system costs. Thus, the number of cells and the design configurations applied to each cell will be varied based upon the design goals and performance requirements of particular implementations.

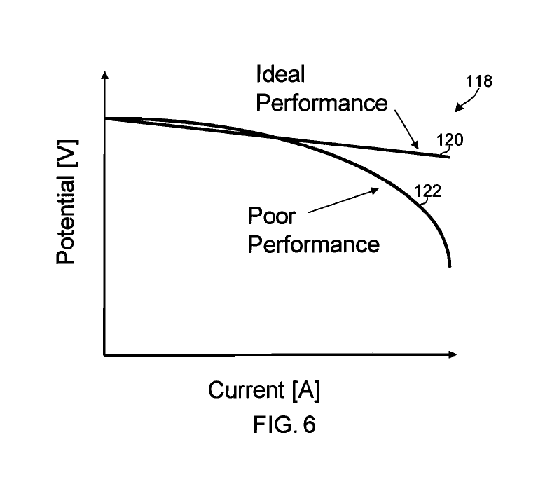

By varying the design configurations of independent cells along the reactant flow path through the redox flow battery cell layer 48 and stack assembly 10 the various embodiments are able to achieve significant charging/discharging performance improvements over conventional redox flow battery designs. This performance improvement is illustrated in FIG. 6 which shows the polarization curve 122 (output voltage as a function of output current) of a convention redox flow battery that does not include the embodiment enhancements. This poor performance curve 122 falls well below the ideal performance curve 120 which may be approached by the embodiment redox flow battery designs implementing the embodiment configurations described above.

By forming the conducting regions (e.g., conductive surfaces 22, 24) only on the active areas of the bipolar frame as illustrated in FIG. 3B, the redox flow battery stack assembly 10 can be made quite flexible. A plurality of cell layers 140-148 can be formed into a stack by assembling the layers one on top of another so that the conductive surfaces 22, 24 of each cell chamber in the cell layers 48 (one of which is illustrated in FIGS. 3A and 3B) connect electrically in series, and turning the stack into a vertical orientation as illustrated in FIG. 7A. Positioning the redox flow battery stack assembly 10 in a vertical orientation, so that one cell 52 within a layer is on the bottom and the opposite cell 56 is on the top, aids in venting any hydrogen that may be formed during charging or discharging reactions. Separate terminals may be coupled to the exterior conductive surfaces 22, 24 as depicted in FIG. 7A in order to connect the battery to a load. Coupling a number of terminals in the manner illustrated in FIG. 7A, can enable separate monitoring of each of the cell columns (i.e., the cells connected electrically in series across a stack) along the flow path which can enable better control of the stack. By monitoring the voltage across each of the cell columns along the vertical length, the precise state of charge can be determined. Depending on the power demand placed upon the redox flow battery stack assembly 10, the battery can be fully utilized for peak demand or just partially utilized when the demand is small. Each stack can be individually controlled in terms of current loading to provide for longer life or higher efficiency.

FIG. 7B illustrates an embodiment of a redox flow battery stack assembly 10 in which the stack is formed by stacking cell layers 48 which are formed in unibody frames 48a, 48b, 48c. As illustrated in FIG. 7B, in this embodiment, individual cells are formed within frames that span the length of the cell layer. As mentioned above, the design parameters of each cell 1 52a, 52b, 52c are configured according to the charge state of reactants in those cells, and thus may be different from the design parameters of each cell 2 56a, 56b, 56c within the cell layers 48a, 48b, and 48c of the stack 10.

Instead of assembling cells within a unibody frame for each cell layer, each cell may be assembled within cell frames 52a-56c in an embodiment illustrated in FIG. 7C, as well as FIG. 3B. In this embodiment, the redox flow battery stack can be assembled by fitting cells 52a, 54a, 56a (e.g., electrode 18, membrane separator 12, and electrode 20 of FIG. 3B) into cell frames (e.g., frames 84 and 86 of FIG. 3B) and then stacking the like design framed cells (e.g., all cell 52's in a configuration like FIG. 3A) with interleaved bipolar plates (e.g., conductive areas 22 within frame 82 of FIG. 3B) to form cell columns 72, 74, 76, which are then fit together to complete the stack 10.

As mentioned above, one source of losses in a redox flow battery is due to mixing or leakage of reactants along the edges of the membrane separator 12. As illustrated in FIG. 8, such losses may be eliminated by sealing the membrane separator material edges 160, 162. Such edge sealing may be accomplished by fusing the material by heating it to an elevated temperature while compressing it, such as with an iron or vise. Alternatively, gaskets can be used around the periphery of each cell chamber for sealing.

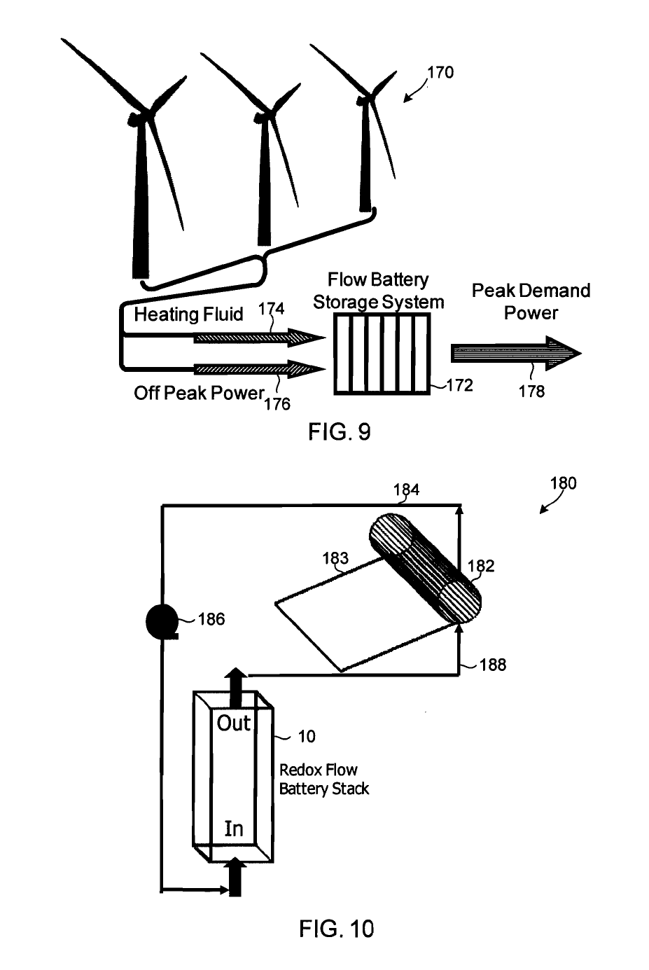

As mentioned above, the performance of a redox flow battery stack assembly 10 can be enhanced by heating the reactants to optimum temperatures at various stages within the battery flow path. Various embodiments accomplish such heating by using waste heat or alternative energy heat sources, thereby enhancing electrical performance while reducing parasitic losses. The various embodiments have a number of useful applications in energy generation applications as well as industrial applications which use electrical power and generate waste heat (e.g., heat sinks from air-conditioning and equipment cooling systems). As discussed in the embodiments below, alternative energy sources such as wind turbines and solar panels require cooling to enhance performance and prevent mechanical breakdown. Larger energy storage systems using the Fe/Cr redox flow battery technology can be thermally integrated with wind turbine farms and photovoltaic solar farms as illustrated in FIGS. 9-11 to use low grade waste heat in a complimentary fashion. For example, a 1 MWh/4 MWh redox flow battery system can be thermally and electrically connected to a small number of wind turbines.

Integrating a wind turbine system with a redox flow battery system provides a renewable power generation system which can operate more efficiently and economically than a wind turbine farm that does not have energy storage capacity. Such a system can store power whenever the wind is blowing, and meet the power demands of the electrical power grid regardless of the current wind conditions. This enables a wind turbine/redox flow battery system to meet utility contractual obligations to provide consistent power to the electrical power grid, thereby avoiding economic penalties for failing to supply contracted power levels during times of little or no wind. Additionally, the system allows electrical power to be supplied to the power grid during periods of peak demand, enabling the system owner to sell electrical power at the most favorable rates regardless of when peak winds occur.

An embodiment energy generation and storage system combining a wind turbine farm 170 with a redox flow battery is illustrated in FIG. 9. As mentioned above, wind turbines generally require a cooling water system to ensure that the mechanical systems operate within design temperature ranges as described. The cooling water circulated through the turbine structures 170 can be used as a heating fluid 174 for the redox flow battery system 172. Thus, the waste heat generated by mechanical friction in the wind turbines can be partially recovered in terms of overall energy output performance by using that energy to maintain the reactants in the flow battery system 172 at an optimum operating temperature. The electrical power 176 generated by the wind turbine farm 170, which is often generated at times that do not correspond with peak power demand, can be stored in the redox flow battery system 172. The stored electrical power 178 can then be used to provide dispatchable peak power to the grid in response to demand, such as during times of peak power demand. FIG. 9 depicts a 1 MW flow battery system integrated with three 600 kW wind turbines. Thus, a redox flow battery stack assembly 10 provides an ideal solution to the energy storage challenge of inconsistent energy generators while utilizing the waste heat required for cooling such alternative energy systems.

Similar to the wind turbine/redox flow battery system described above with reference to FIG. 10, integrating a solar energy conversion system with a redox flow battery system provides a renewable power generation system which can operate more efficiently and economically than a solar generation system that does not have energy storage capacity. Such a system can charge the battery to store power whenever the sun is shining, and meet the power demands of the electrical power grid regardless of the time of day or weather conditions. This enables such a solar generator/redox flow battery system to meet utility contractual obligations for providing consistent power to the electrical power grid, thereby avoiding economic penalties for failing to supply contracted power levels during times of cloudy weather or at night. Additionally, the system allows electrical power to be supplied to the power grid during periods of peak demand, enabling the system owner to sell electrical power at the most favorable rates regardless of the time of day or weather.

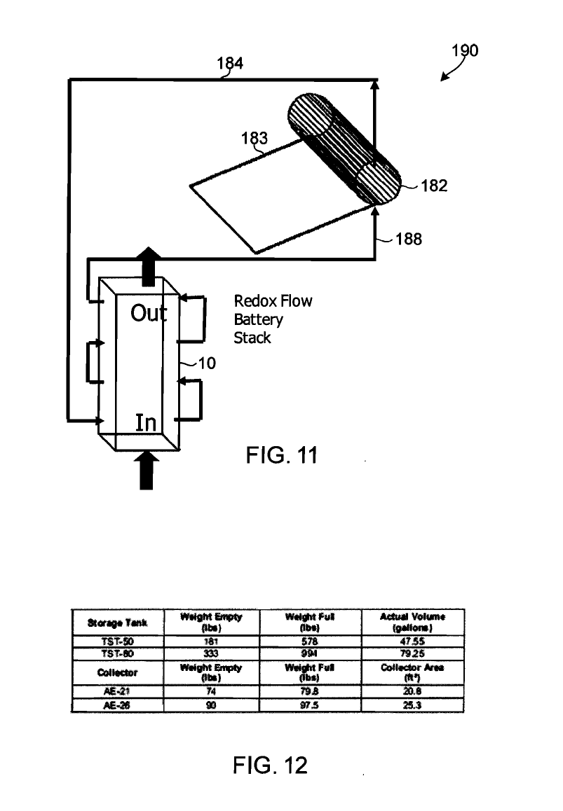

A solar energy conversion system, such as a photovoltaic (PV) array, concentrating photovoltaic (CPV) array, a solar thermal energy power plant, or a solar hot water system, can be thermally and electrically integrated with the redox flow battery system to provide a more economical and efficient renewable energy generation system 180, 190 as illustrated in FIGS. 10 and 11. A solar collector 183 may generate electricity as well as capture solar heat energy. In a solar electric generation system water may be circulated through or under the photovoltaic panels to maintain the photovoltaic cells within design operating temperatures. The heat energy received by the solar collector 183 may be stored in a thermal storage tank 182. As described above, the Fe/Cr redox flow battery operates at optimum efficiency at temperatures in the range of about 40 to 65° C. Heating fluids (e.g., water) from the thermal storage tank 182 can be used to provide the required heat energy to maintain this temperature in the redox flow battery stack assembly 10 without incurring costly parasitic losses or additional operating costs (and greenhouse gas emissions), as would be the case in an electric or gas fired heating system. Solar collectors and thermal storage systems represent a very mature technology, particularly in residential markets. In an embodiment, the electrolyte itself can be the working fluid in a thermosiphon hot water system.

Thermally integrating a solar thermal energy collection system with a redox flow battery system can be accomplished in at least two configurations. In a first configuration illustrated in FIG. 10, the solar collector 183 and thermal storage tank 182 are designed to hold the electrolyte reactant, which is a solution of HCl in the case of the Fe/Cr system. In this configuration the reactant is raised to a temperature of about 40 to 65° C. in the solar collector 183 and thermal storage tank 182, so that reactant flowing out of the thermal storage tank 182 is pumped (via pump 186) directly into the redox flow battery stack assembly 10 where it takes part in the electrochemical reactions. Reactants exiting the redox flow battery stack assembly 10 are returned to the thermal storage tank 182 for reheating. Alternatively, a closed loop heating fluid can be used in the solar collector 183 with heat transferred from the heating fluid to the electrolyte stored in the thermal storage tank 182 in a heat exchanger within the tank as in the closed loop solar hot water system embodiment.

In a third configuration illustrated in FIG. 11, hot water (or another fluid) produced by solar collector 183 may be used as the heating fluid stored in the thermal storage tank 182 which is pumped into and around the redox flow battery stack assembly 10, such as through heat exchange tubes. In this configuration, the heating fluid from the thermal storage tank 182 does not mix with the electrolyte reactants.

Thermally integrating a solar collector or solar energy conversion system with a redox flow battery system can use either pump circulation as illustrated in FIG. 10, or natural circulation (thermo siphon) as illustrated in FIG. 11. Pumping the heating fluid through the redox flow battery stack assembly 10 (as the reactants or as a heating fluid flowing through heat exchanger pipes) can provide improved thermal performance, but at the cost of parasitic losses from the power consumed by the pump 186. In a natural circulation configuration as illustrated in FIG. 11, the buoyancy of the heated water or reactant is used to cause the fluid to circulate through the redox flow battery stack assembly 10 without the need for a pump. The hot water rises from the top of the thermal storage tank 182 and passes through the redox flow battery stack assembly 10 where it is cooled, increasing its density. With no moving parts or fossil fuels required the solar heated natural circulation configuration does not suffer parasitic losses which would limit the overall roundtrip efficiency of the energy storage system. The natural circulation configuration avoids parasitic losses associated with running cooling pumps and provides a very simple system with a single working fluid, which may well be a good solution for smaller systems because of the constrained tank volume. On the other hand, enabling natural circulation flow may require configuration compromises, such as locating the redox flow battery stack assembly 10 above the thermal storage tank 182, such as on the roof of a building in close proximity to the solar collector 183 or thermal storage tank 182.

The thermosiphon solar heating system operates in closed loop configuration for both embodiments illustrated in FIGS. 10 and 11. The thermal storage tank 182 can be of a manageable size for larger energy storage systems because it is just circulating a high heat capacity fluid (e.g., water) when used to maintain the temperature of the redox flow battery stack assembly 10.

The table in FIG. 12 exemplifies sizing parameters for commercially available solar hot water systems that would be suitable for use with various configurations of redox flow battery systems.

Thermal integration of a redox flow battery system with conventional power generation systems, such as nuclear and coal-fired power plants, can provide significant energy and economic efficiencies since such systems generate a large amount of low grade waste heat. As described above, thermally integrating the redox flow battery system with sources of waste heat improves the battery operating efficiency without the expense or parasitic losses of electrical or fossil fuel heaters. Electrically integrating a redox flow battery energy storage system with conventional power generation systems also provides significant economic advantages since the battery system can enable base-loaded power plants to accommodate grid support (ancillary services) or peak power demands without varying their output. As is well known, nuclear and coal-fired power plants operate most efficiently and economically when run at constant power levels. Peak power demands can be met by charging the redox flow battery energy storage system during periods of reduced demand (e.g., off-peak hours in the late evening) and then augmenting the electrical output of the power plant with electricity drawn from the battery system during periods of peak power demand. Such a combined power plant/energy storage system can be economically advantageous since electrical power can be generated in the most economical manner (i.e., at constant output 24 hours per day) but sold at times of peak demand when electricity prices are greatest. Further economic benefits can be obtained by adding a redox flow battery energy storage system to an established conventional power plant to meet growing demands for peak power without building additional power plants. The sizing flexibility of redox flow battery systems, in which energy storage capacity can be increased simply by increasing the size or number of reactant storage tanks, means the economic advantages of adding a flow battery storage system to a conventional power plant can be obtained without having to invest in a system sized for future demands.

Geothermal energy can also be used to heat the reactant storage tanks. This approach could provide a stable system with a large amount of thermal inertia. Low grade geothermal energy can be used to provide heat to the redox flow battery stack assembly 10 or to the reactant storage tanks. In this embodiment heat is obtained from geothermal energy deep within the Earth which can be conveyed by a thermal fluid around the reactant storage tanks and/or through a heat exchanger before and after the battery stack.

The redox flow battery storage system does not necessarily need to be placed in close proximity to the power generation system. For example, if there is a low cost source of waste heat from an industrial process or a solar array (PV or CPV) used to a building, it may be economically and efficiently advantageous to locate a redox flow battery within or near the building in which the process is accomplished or the solar array located. In this manner, the waste heat from the industrial process or on-site power or thermal energy generation can be used to enhance the battery efficiency, while the energy storage capacity of the battery is used to meet peak power demands or enable purchasing electrical power during off-peak hours when electricity rates are lower. Thus, if the industrial process uses large amounts of electricity, thermally and electrically integrating the process with a redox flow battery system can meet the process's demand for electrical power while electricity is purchased to charge the battery system during off-peak hours when electricity rates are lower. This type of implementation may reduce cooling costs for the industrial process over periods when the electricity rates are high, thus providing further cost savings.

All the previously mentioned low grade heat sources can also be applied to heating the reactant tanks instead of or in addition to heating the redox flow battery stack assembly 10. Heating the reactant tanks enables the system to respond very quickly to load changes without any thermal management problems because the reactant fluid is constantly maintained at the operating temperature ready to be utilized in the flow battery. Costs and complexities of heating and insulating the reactant storage tanks may be offset by the cost advantages of simplifying the redox flow battery stack design because this approach eliminates the need for heat exchanger elements within the battery stack assembly. Further, combining these alternative embodiments, such as heating storage tanks and providing heat exchangers within the stack may provide the optimum design approach for providing clean, low cost and reliable heat to the redox flow battery.

Four additional example system embodiments of the redox flow battery system for use in battery energy storage systems (BESS) are illustrated in FIGS. 13A-13D. These example embodiments are intended to illustrate how various battery system components can be assembled into energy generation systems in order to provide stored electrical power to different applications.

In a first example embodiment illustrated in FIG. 13A, a redox flow battery energy storage system configuration different from the system shown in FIG. 1 is used to provide a reliable source of direct current (DC) electrical power 200 that is fully isolated from fluctuations and surges of the utility power grid. This embodiment system uses dual redox flow battery stacks 210, 212 to enable simultaneous charging and discharging operations. In this embodiment system 200, electrical power may be received from a conventional electric utility grid 202, from an on-site renewable energy source 204, such as a wind turbine farm or solar photovoltaic panels, and/or from an onsite distributed generator (DG) 205, such as a fuel cell 352, a propane generator (not shown), a natural gas micro-turbine (not shown), or a diesel generator set (not shown). Power from the grid 202, some renewable energy sources 204 or distributed generator 205 may be rectified to generate DC power in a power conversion system 208, while DC power from a fuel cell 352, photovoltaic solar source 183 (see FIG. 10), or other DC generator will not require the rectifier. The received DC power may be provided to a first redox flow battery stack 210 which is configured for and dedicated to charging the redox flow battery reactants. As DC power is provided to the first (charging) redox flow battery stack 210, anolyte and catholyte reactants are pumped into the charging redox flow battery stack 210 by pumps 226, 228. The DC power causes the anolyte and catholyte reactants to be charged by converting Fe⁺² ions to the Fe⁺³ state and Cr⁺³ ions to the Cr⁺² state (see FIG. 4). Such charged reactants emerge from the first redox flow battery stack 210 in outlet flows 230, 232 which are directed to the anolyte tank 214 and catholyte tank 216, respectively. Thus, electrical power is stored in the Fe⁺³ and Cr⁺² electrolyte concentrations in the storage tanks 214, 216.

Electrical power is generated from the chemical energy stored in the electrolytes in a second (discharging) redox flow battery stack 212. Electrolyte from the storage tanks 214, 216 is directed to the second redox flow battery stack 212 via inlet flows 218, 220. Within the second redox flow battery stack 212, electricity is generated by converting Fe⁺³ ions to the Fe⁺² state and Cr⁺² ions to the Cr⁺³ state (see FIG. 4). The generated electrical output 234 is provided to a DC load 206.

Reactants flowing out of the second redox flow battery stack 212 (outflows 222, 224) may be pumped into the first redox flow battery stack 210 for recharging, thereby providing a single charging and discharging loop. Since the electricity provided to the DC load 206 is generated from electrolytes in the second redox flow battery stack 212, the output current is completely isolated from the electrical sources of charging power, enabling the output power to reliably follow the DC load without power spikes or power drops. This arrangement ensures power variations from the grid, on-site renewable energy generators, or on-site distributed generators do not disrupt power to the DC load 206. Conversely, the power fluctuations associated with a large and widely varying load, such as an electric vehicle charging station or industrial batch process (e.g., a mixer), remain isolated from the utility grid 202 and other energy sources. This is beneficial to utilities as it reduces stress on the grid and also is beneficial to charge station owners as it circumvents large power demand charges. The unique characteristics of the redox flow battery system also enables DC□DC conversion to be accomplished with high overall system efficiency by a suitable choice of the number of cells connected in series within each stack to achieve V1 in the charge stack and V2 in the discharge stack. Also, the facility owner can choose when to charge the system so as to select the lowest cost electricity in order to maximize gross profit margins.

As described above, electrical efficiencies of the first and second redox flow battery stacks 210, 212 can be enhanced by heating the reactants to an elevated temperature, such as about 40 to 65° C., using on-site waste heat from equipment or facility cooling systems or geothermal heating systems 236. As described above, a heating fluid from waste heat recovery systems, solar hot water system, or geothermal heating systems 236 may be provided to a heat exchanger within the redox flow battery stacks 210, 212 (as illustrated in flow 238) and/or to heat the reactant storage tanks 214, 216 (as illustrated in flow 240).

The embodiment illustrated in FIG. 13A provides a source of power for the load 206 which is electrically isolated from the variability of the input power, such as the utility grid 202, on-site renewable energy source 204 or onsite distributed generator 205. If the design goal is to simply provide electrical isolation, the system 200 may use small electrolyte reactant tanks 214, 216 (e.g., sufficient tankage to accept thermal expansion of the electrolyte and to store the electrolytes when the redox flow battery stack assemblies 210, 212 are drained for maintenance). This is because the reactants can be charged at the same rate they are discharged. However, by employing larger electrolyte reactant tanks 214, 216 the system can also serve as a backup power supply to provide electrical power to the load 206 when input power (e.g., from a utility grid 202) is not available.

A particularly attractive application for the Fe/Cr redox flow battery system 200 embodiment illustrated in FIG. 13A is as a power isolator/uninterruptible power supply for a data center. Data centers require a particularly high quality of DC power and also emit a large amount of waste heat. Presently, lead-acid battery based Uninterruptible Power Supplies (UPS) are used in data centers to ensure high-quality DC power as well as short-duration back-up power. Heat exacerbates the positive-grid corrosion and sulfation failure mechanisms of lead-acid batteries necessitating operating such UPS systems in a temperature-controlled environment. In contrast to lead-acid battery UPS, a Fe/Cr redox flow battery system of the embodiment illustrated in FIG. 13A can provide a reliable power supply while utilizing the waste heat of the data center to improve overall system efficiencies, thereby providing substantial advantages over lead-acid based UPS.

As described above with reference to FIG. 2 and FIG. 5, the first and second redox flow battery stacks 210, 212 of FIG. 13A are configured to have multiple cells in each cell layer of the stack, with the cells within each cell layer configured to design parameters, such as match catalyst loading, catalyst activity, temperature, reactant mass transport rate and separator membrane selectivity, to the electrolyte concentration expected in each cell along the reactant flow path. In the Fe/Cr redox flow battery embodiment illustrated in FIG. 13A, the first redox flow battery stack 210 is configured for charging so charge catalyst loading, charge catalyst activity, temperature, mass transport rate, and separator membrane selectivity increase in succeeding cells along the flow path from inlet to outlet. In contrast, the second redox flow battery stack 212 is configured for discharging so discharge catalyst loading, discharge catalyst activity, temperature and mass transport rate increase, and separator membrane selectivity decrease in succeeding cells along the flow path from inlet to outlet.

In a second example embodiment illustrated in FIG. 13B, a redox flow battery energy storage system can be used to provide the electrical power for an electric vehicle (EV) or plug-in hybrid electric vehicle (PHEV) charging station 250. This embodiment utilizes many of the components described above with reference to FIG. 13A, except that a separate charging loop 252 is provided between the first redox flow battery stack 210 and the electrolyte storage tanks 214, 216, and a separate discharge loop 254 is provided between the second redox flow battery stacks 210, 212 and the electrolyte storage tanks 214, 216. For example, a set of discharge loop pumps 260, 262 pumps electrolyte inlet flows 256, 258 from the electrolyte storage tanks 214, 216 into the second redox flow battery stack 212, and a set of charging loop pumps 268, 270 pumps electrolyte inlet flows 264, 266 into the first redox flow battery stack 210. This enables the charging and discharging processes to be operated independently of one another. Thus, if demands on the system for discharging electricity require a higher electrolyte mass flow rate in the discharge loop 254 than in the charging loop 252, the discharge loop pumps 260, 262 can be operated at a different speed than the charging loop pumps 268, 270. Similarly, if no discharging electricity is required, the charging loop pumps 268, 270 may be operated to continue charging the system while the discharge loop 254 remains idle. Thus, during the off peak evening hours the charging loop 252 can be operated to store energy in the reactants while the discharging loop is operated intermittently as required to meet load demands.

The vehicle charging station 250 embodiment illustrated in FIG. 13B provides output power 234 to a vehicle charger 272 which is configured to provide electrical power at the voltage and current density required to charge electric powered vehicles 274. This embodiment takes advantage of the load following capacity of the redox flow battery system since it is anticipated that rapid charging of electric vehicles will require large power demands. Since the charging of electric vehicles is unlikely to be a constant process, and is more likely to occur randomly when vehicles arrive at the charging station, such periodic requirements for significant electrical power would cause unacceptable demands on the electrical utility grid 202, renewable energy sources 204, and/or distributed generator sources 205, such as a fuel cell 352. The redox flow battery system can meet the demand for charging power simply by increasing the mass flow rate of the electrolytes through the discharge loop 254. Thus, while the charging loop 252 draws a constant amount of power from the utility grid 202, renewable energy sources 204, and/or distributed generator sources 205, the discharge loop 254 and its second redox flow battery stack 212 can be operated to meet the periodic demands for recharging electric vehicles. This embodiment ensures that variations in power received from the grid 202 or on-site renewable energy power sources do not disrupt vehicle charging or damage vehicle storage batteries. The unique characteristics of the redox flow battery system enables DC□DC conversion with high overall system efficiency, further providing an economical vehicle charging system. Also, the charging station operator can charge the electrolytes during off-peak hours when electricity rates are lower, thereby improving the operator's overall gross profit margins.

Similar to the embodiment described above with reference to FIG. 13A, the first and second redox flow battery stacks 210, 212 are configured in design for their respective functions of charging and discharging. In the Fe/Cr redox flow battery embodiment illustrated in FIG. 13B, the first redox flow battery stack 210 is configured for charging so charge catalyst loading, charge catalyst activity, temperature, mass transport rate, and separator membrane selectivity increase in succeeding cells along the flow path from inlet to outlet. In contrast, the second redox flow battery stack 212 is configured for discharging so discharge catalyst loading, discharge catalyst activity, temperature and mass transport rate increase, and separator membrane selectivity decreases in succeeding cells along the flow path from inlet to outlet.

FIG. 13C illustrates an alternative embodiment electric vehicle charging station 300. This embodiment utilizes many of the components described above with reference to FIGS. 13A and 13B, except that valves 302, 304 are used to control the electrolyte reactant flows through the charging loop 252 and discharge loop 254 so that electrolyte reactants are pumped through one or both of the loops by a single set of electrolyte pumps 260, 262. This embodiment may have cost advantages since it requires fewer pumps.

Similar to the embodiments described above with reference to FIGS. 13A and 13B, the first and second redox flow battery stacks 210, 212 are configured for their respective functions of charging and discharging. In the Fe/Cr redox flow battery embodiment illustrated in FIG. 13C, the first redox flow battery stack 210 is configured for charging so charge catalyst loading, charge catalyst activity, temperature, mass transport rate, and separator membrane selectivity increases in succeeding cells along the flow path from inlet to outlet. In contrast, the second redox flow battery stack 212 is configured for discharging so discharge catalyst loading, discharge catalyst activity, temperature and mass transport rate increase, and separator membrane selectivity decreases in succeeding cells along the flow path from inlet to outlet.

In a fourth example embodiment illustrated in FIG. 13D, the redox flow battery energy storage system can be used with a fuel cell to provide a fuel cell/redox flow battery power generation system 350 for providing reliable load-following power to a power grid or industrial facility. This embodiment utilizes many of the components described above with reference to FIG. 13A. In this embodiment, electrical power is received from a fuel cell 352 which generates electricity from the chemical conversion of a fuel, such as hydrogen, received from a fuel source 356. Fuel cells are very efficient generators of electricity which produce less pollution that most other fuel-based energy generation systems. As is well-known, fuel cells operate most efficiently and last longer when operated at a constant output power level. However, the power demand on a typical utility grid 202 or an industrial facility 359 fluctuates significantly throughout the day. Thus, while fuel cells may represent a promising and efficient alternative source of electrical power, their characteristics are ill-suited to utility grid application. This embodiment fuel cell/redox flow battery system 350 overcomes this limitation of fuel cells by using dual redox flow battery stacks 210, 212 to enable simultaneous charging and discharging operations so that power can be received at a fixed power level from the fuel cell 352 while meeting the fluctuating demands of the power grid 202 or an industrial facility 359.

In this embodiment, the chemical fuel, such as hydrogen or natural gas, may be provided from a fuel source 356 via a fuel pipe 354 to the fuel cell 352. For example, the fuel cell/redox flow battery system 350 may be located at or near a source of natural gas, such as in an oil field, so that natural gas extracted from the ground can be provided to the fuel cell. The fuel cell 352 converts the fuel into electricity and effluents (e.g., water and carbon dioxide). Electricity output from the fuel cell 352 is provided to the first redox flow battery stack 210 where the power is used to charge the electrolytes stored in the electrolyte storage tanks 214, 216. As described above, electrical energy stored in the electrolyte species is converted into electricity in the second redox flow battery stack 212. Electricity output 234 from the second redox flow battery stack 212 can be provided to an inverter 358 which converts the DC current generated by the battery into AC current compatible with the utility grid 202 or industrial facility 359. The inverter 358 may be a solid-state electrical DC□AC inverter or a motor-generator as are well-known in the art. In this embodiment, flow of the electrolyte through the second redox battery stack 212 can be controlled by adjusting the speed of the pumps 226, 228 so as to generate electricity to meet the demands of the grid 202. When demand from the utility grid 202 or industrial facility 359 exceeds the steady-state output of the fuel cell 252, stored energy in the electrolyte is used to meet the additional demand. When demand from the utility grid 202 is less than the steady-state output of the fuel cell 252, the excess energy is stored in the electrolyte. Thus, the system 350 can follow the peak demands of the utility grid 202 or industrial facility 359 without having to operate the fuel cell 352 in an inefficient or potentially damaging manner. In a similar but alternative manner, the system 350 can be used as an on-site distributed generator to follow the peak demands of a co-located industrial facility load 359. The base load demand of an industrial facility 359 can be satisfied by the utility grid 202 or an independent stand-alone fuel cell system 352.

Similar to the embodiments described above with reference to FIGS. 13A-13C, the first and second redox flow battery stacks 210, 212 are configured for their respective functions of charging and discharging. In the Fe/Cr redox flow battery embodiment illustrated in FIG. 13D, the first redox flow battery stack 210 is configured for charging so charge catalyst loading, charge catalyst activity, temperature, mass transport rate, and separator membrane selectivity increases in succeeding cells along the flow path from inlet to outlet. In contrast, the second redox flow battery stack 212 is configured for discharging so discharge catalyst loading, discharge catalyst activity, temperature and mass transport rate increase, and separator membrane selectivity decreases in succeeding cells along the flow path from inlet to outlet.

In a further embodiment illustrated in FIG. 14, a redox flow battery system 400 is configured to use gravity to flow reactants through the battery cells, thereby reducing or eliminating the need for pumps. The gravity-driven redox flow battery system 400 has fewer components and is less complex than other flow battery systems, thereby reducing its acquisition costs. Eliminating the pumps also reduces parasitic losses resulting in a more efficient overall energy storage system. Energy is stored in the chemical species concentrations in the electrolyte stored in the tanks 404, 406. The electrolyte is passed through a redox flow battery stack 410 which either charges the electrolyte or discharges the electrolyte depending on the direction of flow and applied power or load. Electrolyte fluid exiting the redox flow battery stack 410 is then collected in a matching set of tanks 414, 416 positioned below the redox flow battery stack 410. The illustrated example embodiment includes four reactant tanks 404, 406, 414, 416, two (404, 414) for the anolyte reactant and two (406, 416) for the catholyte reactant. Optional valves 418, 420, 424, 422 may be included to enable control or throttling of reactant flows through the redox flow battery stack 410. The redox flow battery stack 410 and the four reactant tanks 404, 406, 414, 416 may be integrated within a support structure 402, such as a cylinder. When the valves 418, 420, 422, 424 are opened, reactant flows from the top tanks 404, 406 through the redox flow battery stack 410 and into the bottom tanks 414, 416 via gravity. In the charge mode, electricity is consumed by the redox flow battery stack 410 at a rate consistent with the electrolyte flow rate and the state of charge of the electrolyte. Once the energy stored in the reactants is replenished or it is otherwise time to discharge the system, the gravity-driven redox flow battery system 400 is rotated 180° so that discharging operations can begin. Thus, the charge/discharge operation of the redox flow battery stack 410 depends upon the orientation of the system.

Since the goal of the embodiment illustrated in FIG. 14 is simplicity of operation and design, a single redox flow battery stack 410 is used for both the charging and discharging modes, although separate battery stacks could be used. As described above with reference to FIG. 5, the single redox flow battery stack 410 is configured to match catalyst loading, catalyst activity, temperature, reactant mass transport rate and separator membrane selectivity to the electrolyte concentrations expected in each independent cell along the reactant flow path in the charging and discharging modes. Specifically, the single redox flow battery stack 410 is configured so catalyst loading, catalyst activity, temperature and mass transport rate change depending on which half cycle (charge or discharge) requires optimization and separator membrane selectivity increases in succeeding cells from one end of the battery stack to the other. In operation the reactant flows through the redox flow battery stack 410 in one direction for charging, and in the opposite direction for discharging.

Additionally, since the goal of the embodiment illustrated in FIG. 14 is simplicity of operation and design, the redox flow battery stack 410 and the tanks 404, 406, 414, 416 may not include thermal management or heat exchangers for controlling the temperature of the reactants.

Operation of the gravity-driven redox flow battery system 400 is illustrated in FIGS. 15A-15C. In the charging mode illustrated in FIG. 15A reactant flows from the top tanks 404, 406 through the redox flow battery stack 410 and into the bottom tanks 414, 416 via gravity while electrical power is applied to the battery stack. Flow of the reactants through the redox flow battery stack 410 may be controlled using the valves 418, 420, 422, 424 to match the amount of charging power being applied to the stack. Thus, when no power is available for charging, the valves 418, 420, 422, 424 may remain closed, and when less than full charging power is available the valves 418, 420, 422, 424 may be partially opened to provide a metered flow through the battery stack 410. The redox flow battery stack 410 and the tanks 404, 406, 414, 416 are plumbed with flow directing piping and configured so that the reactant flows through the battery stack during charging in the direction in which the catalyst loading, catalyst activity and mass transport decrease and the separator membrane selectivity increases from inlet to outlet.

As illustrated in FIGS. 15A-15C, the redox flow battery system 400 may be integrated within a cylindrical support structure 402 that is supported on rollers 430, 432 or an axle (not shown) so that the system can be rotated about its long axis to shift from charging to discharging modes or discharging to charging modes. For example, in an embodiment, one or more of the rollers 430, 432 may be equipped with a drive mechanism, such as an electric drive motor (not shown), a chain driven mechanism (which may couple with a motor or bicycle peddles, for example) or a simple hand crank 434 to, enable rotation of the cylindrical support structure 402. This operation is illustrated in FIG. 15B which shows the valves 418, 420, 422, 424 closed and the cylindrical support structure 402 being rotated in the clockwise direction by rotation of a hand crank 434 drive mechanism connected to one of the rollers 432. The hand crank 434 illustrated in FIG. 15A-15C is for illustration purposes only as a variety of mechanical power sources may be used as the drive mechanism, such as a chain-drive connected to a bicycle, an electric or internal combustion motor, a water wheel, etc.

As illustrated in FIG. 15C, rotating the redox flow battery system 400 through 180° places the system in the configuration for discharging operations so that charged reactant from tanks 414, 416 flows through the redox flow battery stack 410 and into the bottom tanks 404, 406 via gravity, thereby generating electricity from the battery stack 410. Due to the configuration of the system, the reactants flow through the redox flow battery stack 410 in a direction opposite that during charging. Flow of the reactants through the redox flow battery stack 410 may be controlled using the valves 418, 420, 422, 424 to match the amount of electrical power that is generated. Thus, when no power is required the valves 418, 420, 422, 424 may remain closed, and when less than full capacity power is required the valves 418, 420, 422, 424 may be partially opened to provide a metered flow through the battery stack 410.

The advantage of eliminating pumps from the flow battery system in the embodiment illustrated in FIGS. 14-15C are several fold. First, the embodiment enables the system to be fully sealed. It is very important for the redox flow battery system to be completely sealed as any leakage of air into the electrolyte tanks or pipes will oxidize the reactant thereby reducing performance and potentially generating dangerous gases. Therefore, a very well-sealed system is important. Eliminating the need for pumps ensures a more robust and simplified closed system. Second, eliminating pumps improves overall system efficiency. Pumps are a source of parasitic losses which directly reduces the roundtrip efficiency of the system. Thus, this embodiment maximizes roundtrip efficiency, especially if the rotation is performed with cheap energy, e.g., a manual crank 434. Third, eliminating the need for pumps reduces the cost and maintenance requirements since the acidic nature of the electrolyte reactants require special pumps and pump materials. Fourth, the method used to rotate the structure 402 does not contact the reactants, so low cost, reliable mechanisms, including human power, can be used to rotate the system to shift operating modes. Fifth, system operation is quiet as there are no moving parts when the system is operating.

The control valves 418, 420, 422, 424 are the only moving mechanical components apart from the rotation mechanism. The system can be operated flexibly by switching between charge and discharge mode at any time. For example, once the system has discharged through one cycle it may be advantageous to discharge a second time by rotating the system through 180° to flow reactants back into the proper tanks for discharging without applying power to the battery stack 410, and then rotating the system another 180° to restart the discharge process. Doing so will generate more electrical power stored in the reactants, although the power output will be lower than the first discharge cycle. Likewise the system can be charged through a number of cycles in a similar process. Also the system can switch from charge to discharge mode without the need to rotate the tanks if needed, although the efficiency of the system will be reduced.

The simplicity of design and operation of the embodiment described above with reference to FIGS. 14 and 15A-15C, as well as the safety of the Fe/Cr electrolyte reactants, makes the embodiment system ideal for small power storage applications. For example, this embodiment may be ideally suited for use in remote power applications, such as remote towns and villages beyond the reach of a utility grid that use solar photovoltaic arrays and/or wind turbine generators for electricity. Adding a redox flow battery system similar to this embodiment would allow remote towns and villages to be supplied with electrical power at night, for example. Similarly, one or two systems according to this embodiment may be used in remote electric vehicle charging stations using utility grid power or local renewable energy sources to charge the system when no cars need to be charged, and rotating the storage system to provide electrical power for recharging an electric vehicle when required.

It is also possible to size this embodiment system to fit inside standard sized shipping containers. Because these systems are fully sealed and self-contained they can be safely operated inside the shipping container, enabling the systems to be packaged for rapid deployment. For transportation purposes the electrolyte may be transported as a salt, e.g., a ferric chloride, which may be stored in the tanks. This can significantly reduce the weight of the system for transportation. Then once the system is in place, water can be added to reach the required concentrations for operation. In this manner, systems such as the embodiment described above with reference to FIGS. 14-15C can be built and stored in a condition ready for immediate transportation, and moved to a location requiring energy storage when needed. For example, such deployable energy storage systems may be set up at natural disaster sites, such as a hurricane landfall or earthquake epicenter, to help provide emergency electrical power until reliable utility services can be restored.

FIGS. 14 and 15A-15C show the battery stack 410 fully integrated with the tanks 404, 406, 414, 416, and fixed plumbing within the support structure 402. However, in another embodiment the tanks 404, 406, 414, 416 may be separated from the battery stack 410 so that the tanks may be rotated to achieve the desired gravity feed through the battery stack 410 which remains stationary. This alternative embodiment may be more flexible in terms of the ability to easily add more tank/storage capacity. This alternative embodiment will require flexible piping or include fluid couples that accommodate rotation without leaking.

As mentioned above, the various embodiments utilize independent cells with different configurations along the reactant flow path to increase overall electrical performance. FIGS. 16A-16C show micrographs of example separator materials that would be appropriate for use in the independent reaction cells in a three-cell redox flow battery configuration illustrated in FIG. 2. The separator material illustrated in FIG. 16A, which is appropriate for use in a cell adjacent to the stack inlet in discharge mode and to the stack outlet in charging mode, is made of a microporous material with a membrane porosity of less than about 0.1 micron. This microporous material exhibits an area specific resistance of about 0.8 ohm-cm2 and has a reactant selectivity of about 2000 μg Fe/hr-cm/M. The separator material illustrated in FIG. 16B, which is appropriate for use in a cell half way between the stack inlet and stack outlet, is made of a melt blown material with a membrane porosity of about two to about five microns exhibiting an area specific resistance of about 0.5 ohm-cm2 and having a reactant selectivity of about 4000 μg Fe/hr-cm/M. The separator material illustrated in FIG. 16C, which is appropriate for use in a cell adjacent to the stack outlet in discharge mode and to the stack inlet in charging mode, is made of a spunbond material with a membrane porosity of about 15 to about 30 microns exhibiting an area specific resistance of about 0.2 ohm-cm2 and having a reactant selectivity of 12,000 μg Fe/hr-cm/M.

Further representative stack design parameters and performance characteristics for a three-cell configuration are listed in Table 1 below. All values are approximate.

TABLE 1
1.

| | | | |
|---|---|---|---|
| State of Charge (%) | 90-62 | 62-34 | 34-6 |
| Utilization (%) | 31% | 45% | 82% |
| Electrolyte Concentration | | | |
| [M] | | | |
| [Cr²⁺] | 1.80-1.24 | 1.24-0.68 | 0.68-0.12 |
| [Cr³⁺] | 0.20-0.76 | 0.76-1.32 | 1.32-1.88 |
| [Fe³⁺] | 1.80-1.24 | 1.24-0.68 | 0.68-0.12 |
| [Fe²⁺] | 0.20-0.76 | 0.76-1.32 | 1.32-1.88 |
| Electrode Surface Area | Lower | Medium | Higher |
| Electrode Discharge | Lower | Medium | Higher |
| Catalyst Loading | | | |
| Electrode Charge | Higher | Medium | Lower |
| Catalyst Loading | | | |
| Electrode Residence Time | Higher | Medium | Lower |
| Separator Selectivity | 2,000 | 4,000 | 12,000 |
| (μg Fe/hr-cm/M) | | | |
| Separator Area Specific | 0.8 | 0.5 | 0.2 |
| Resistance (ohm-cm²) | | | |
| Separator Porosity (μm) | <0.1 microns | 2-5 microns | 15-30 microns |

The various system embodiments may employ a variety of electrolyte storage tank configurations as described below. In a simple embodiment, a single tank may be used to store each electrolyte as illustrated in FIG. 1. This configuration reduces the number of tanks and may enable rapid switching from charge to discharge modes (and vice versa). However, such a system embodiment will suffer from efficiency losses from mixing of charged and discharged electrolytes.

In a second approach, charged and discharged electrolytes can be stored separately in system embodiments illustrated in FIGS. 1 and 13 by using separate tanks for each, resulting in a total of four tanks in the system (i.e., one for each of the charged anolyte, discharged anolyte, charged catholyte, and discharged catholyte). The use of four tanks in a battery system is illustrated in FIGS. 14-15C. Additional pumps and valves may be used within the system to flow the electrolytes to/from the appropriate tank depending upon the charge/discharge mode for the embodiments illustrated in FIGS. 1 and 13A-13D.

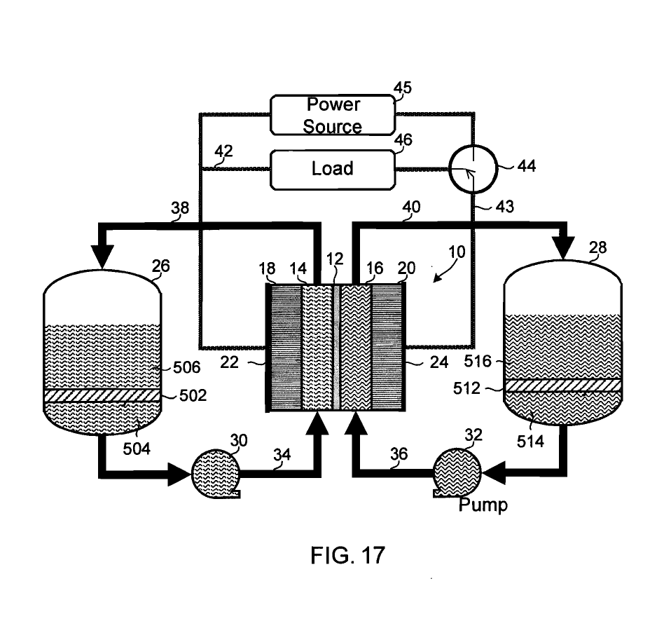

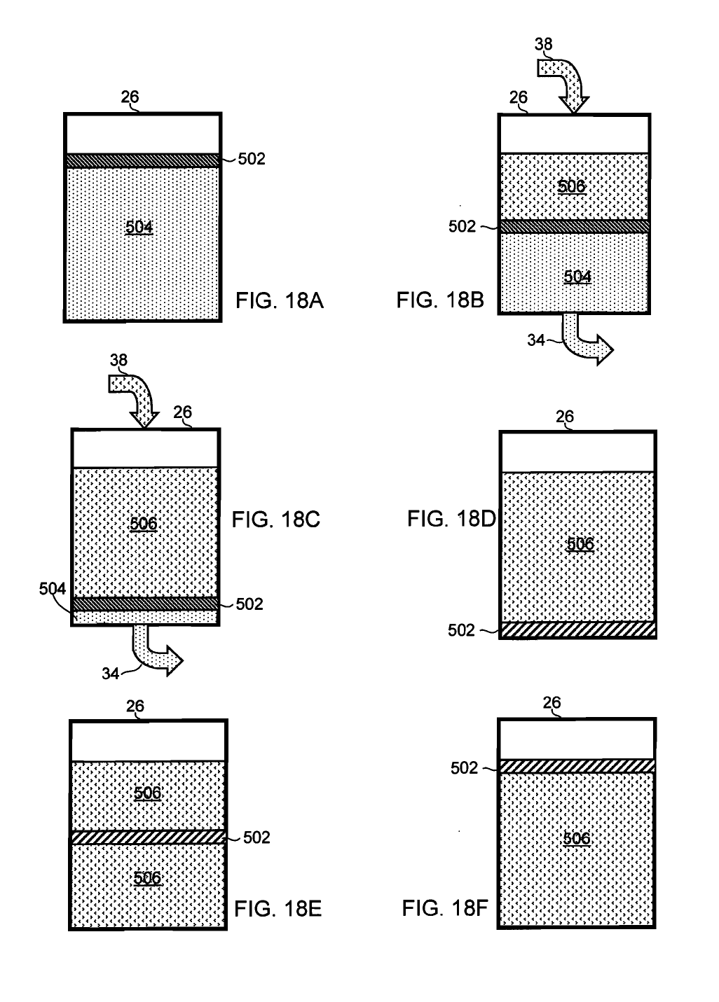

In a further embodiment illustrated in FIG. 17, the redox flow battery system can be configured with electrolyte storage tanks that minimize mixing of the charged and discharged electrolytes. In such a system, the electrolyte storage tanks 26, 28 and a flow system are fluidically coupled to the redox flow battery stack assembly 10 so that electrolyte fluid pumped out of each of the electrolyte storage tanks 26, 28 flows through the redox flow battery stack assembly 10, and then back into the same tank 26, 28 without diluting charged electrolytes. In this embodiment, each electrolyte tank 26, 28 will store both charged reactant 504, 514 and discharged reactant 506, 516, with a tank separator 502, 512 include in each tank which prevents or at least inhibits the mixing of charged electrolyte 504, 514 with discharged electrolyte 506, 516. This embodiment reduces the number of electrolyte storage tanks required in the system while improving system efficiency.

The tank separator 502, 506 inhibits mixing of the charged electrolyte 504, 514 that is fed to the redox flow battery stack assembly 10 with the discharged electrolyte 506, 516 which flows back into the electrolyte tanks 26, 28. This prevents dilution of the charged electrolytes and keeps the charged electrolyte concentrations at a constant level throughout the discharging cycle, thereby maintaining the battery cell potentials constant. If mixing were to occur the electrolyte concentrations in the electrolyte tanks 26, 28 would be reduced over time as more and more discharged electrolyte 506, 516 is returned to the tanks. FIG. 18 illustrates the impact on cell voltage over time if charged and discharged electrolytes allowed to mix, line 552, compared to the cell voltage over time if the charged and discharged electrolytes are kept separate, line 550. By including a tank separator 502, 512, a single electrolyte tank can be used for each of the anolyte and catholyte reactants while ensuring that battery potential remains constant throughout the discharge cycle. This saves the cost of an extra set of tanks. Additionally, by maintaining a more constant voltage over the course or charging or discharging, the efficiency of any DC-DC, DC-AC, or AC-DC conversion of the electricity going into/out of the redox flow battery stack will be higher than designs in which charged electrolyte mixes with discharged electrolyte. This is because these types of converters operate more efficiently in narrower voltage ranges. Lastly, redox flow battery stack output power will remain more constant than designs where charged electrolyte mixes with discharged electrolyte.

While FIG. 18 illustrates the impact on battery discharge potential, a similar impact on system efficiency will occur if charged electrolyte is allowed to mix with discharged electrolyte during a charging cycle. Thus, the tank separator 502 functions to prevent or reduce mixing of charged and discharged electrolyte during both charging and discharging cycles leading to lower system cost, a more constant power output, and higher DC efficiency.

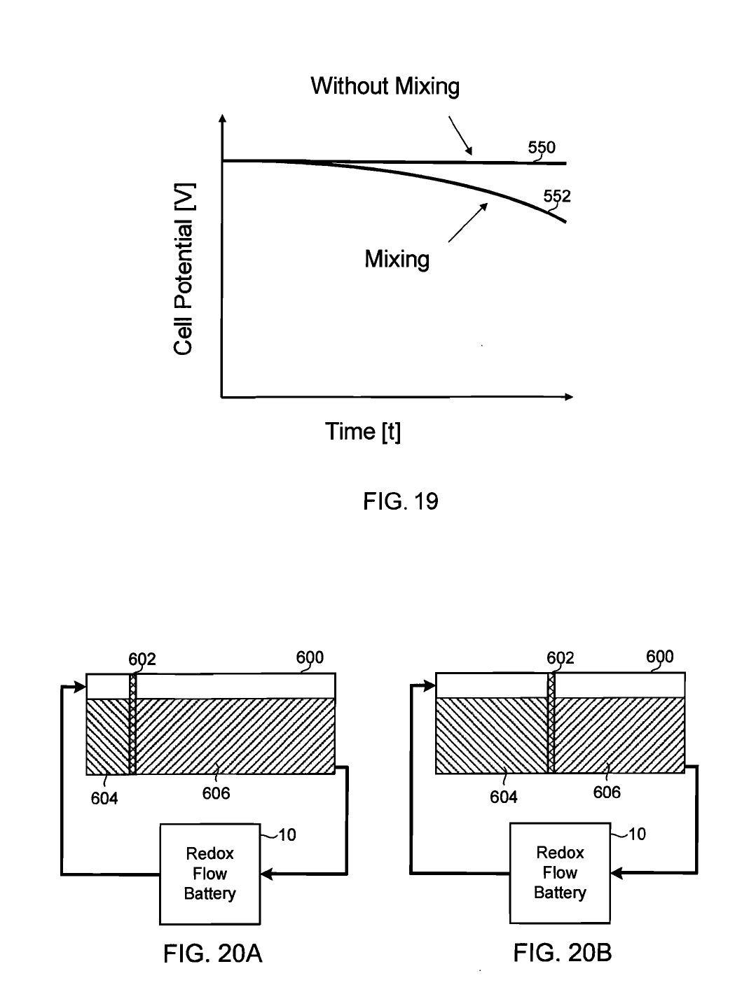

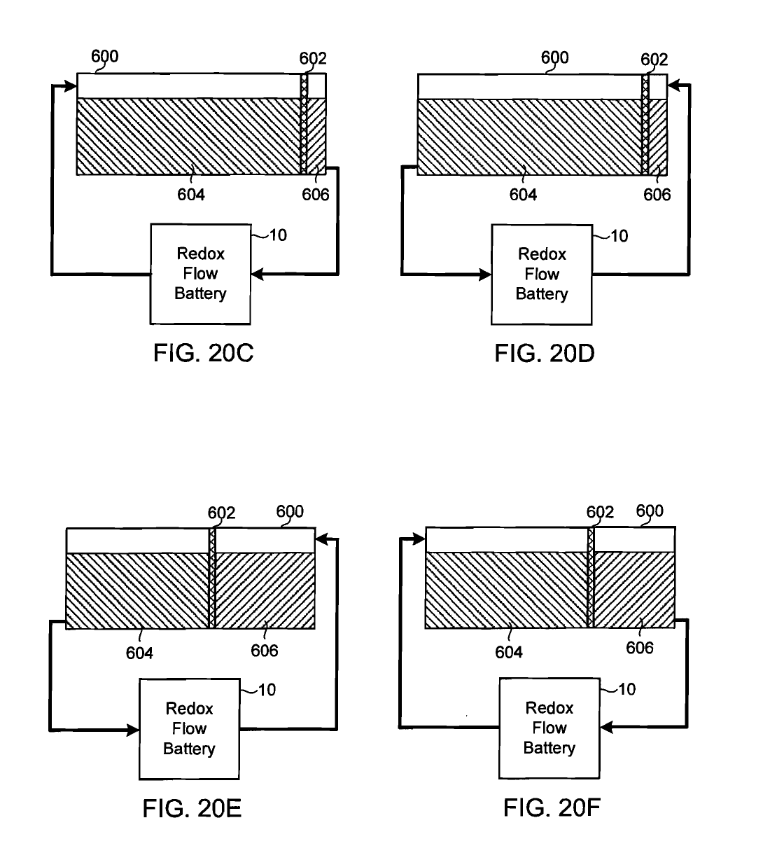

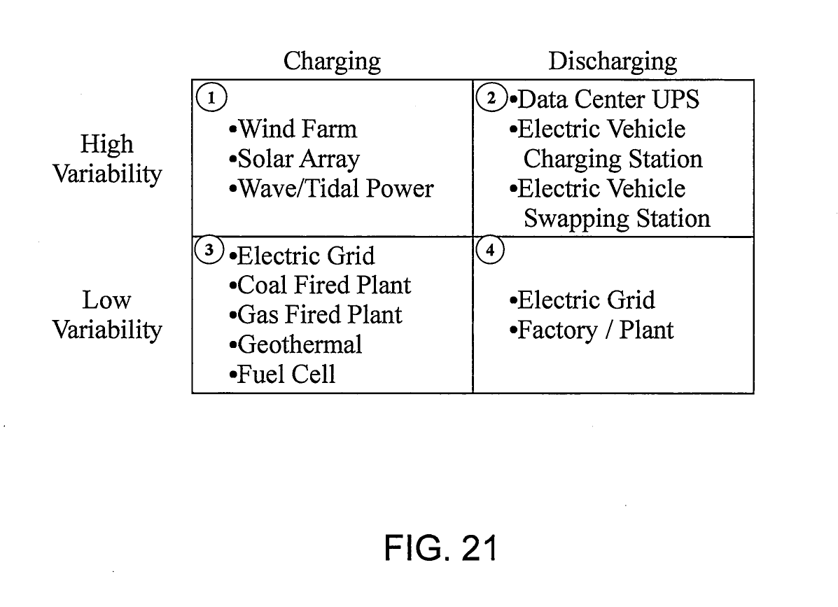

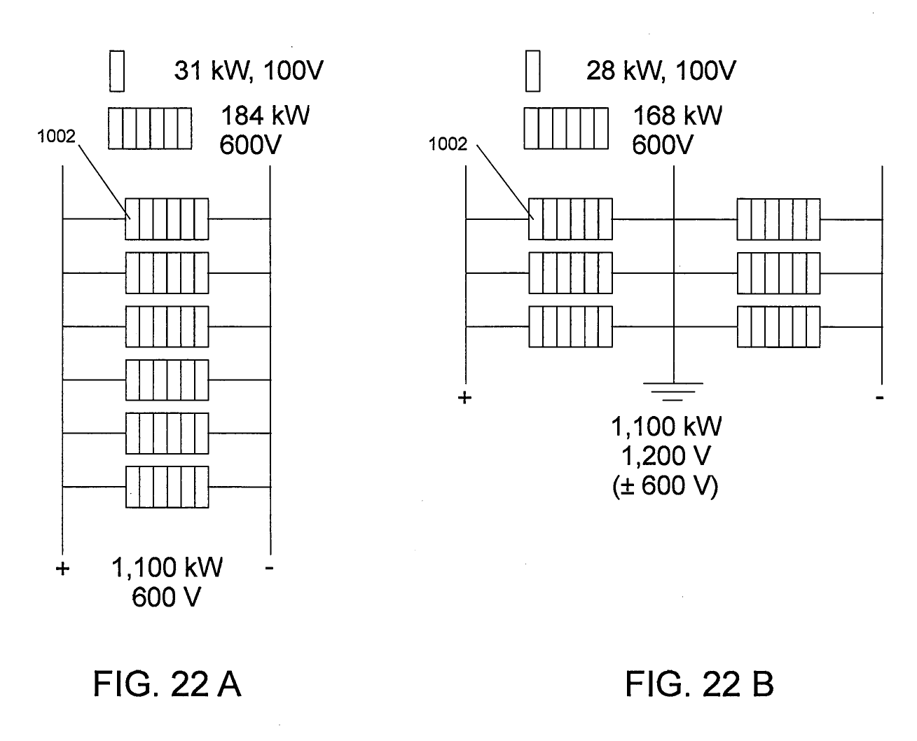

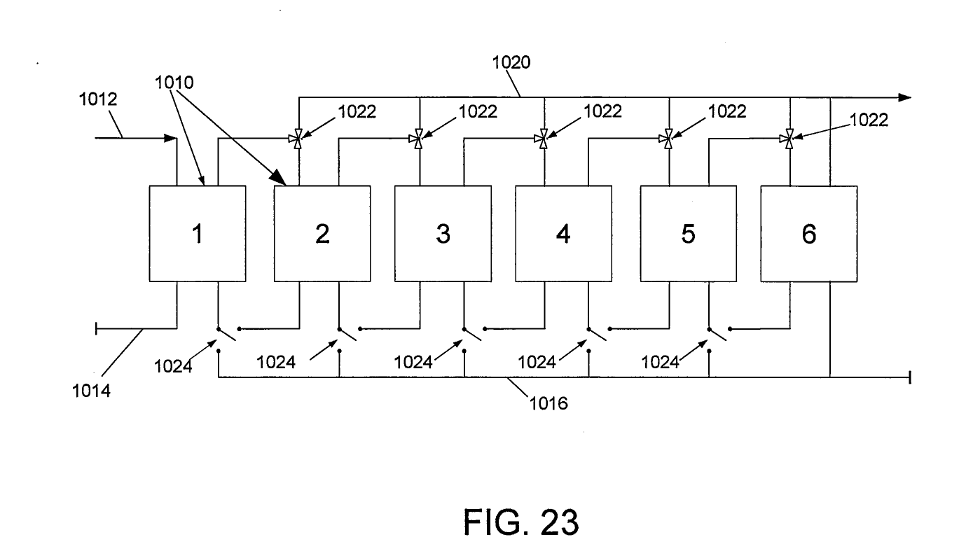

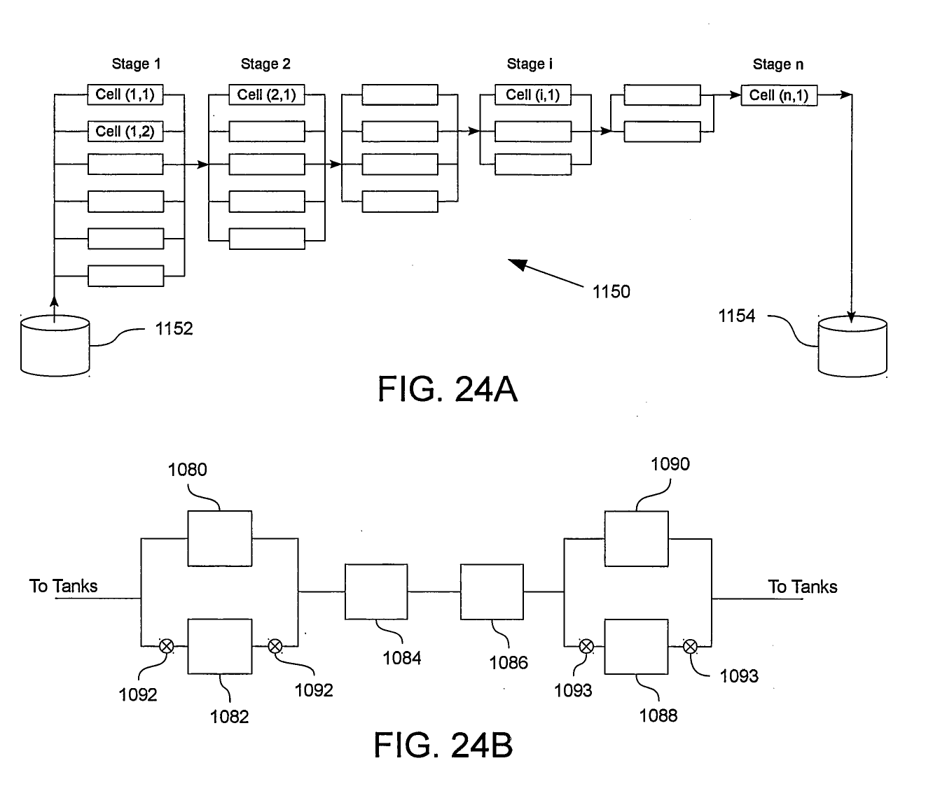

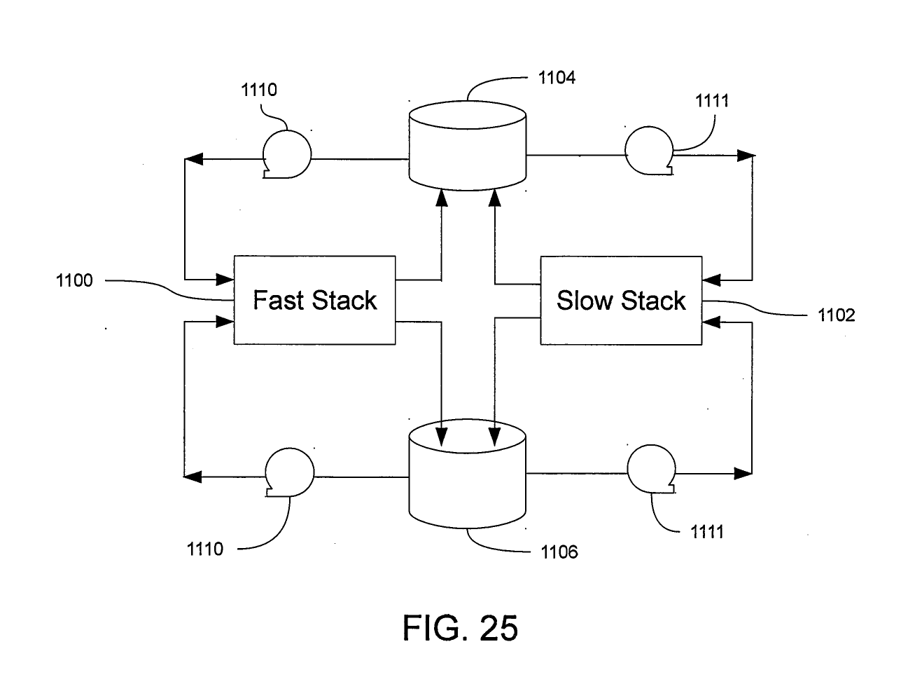

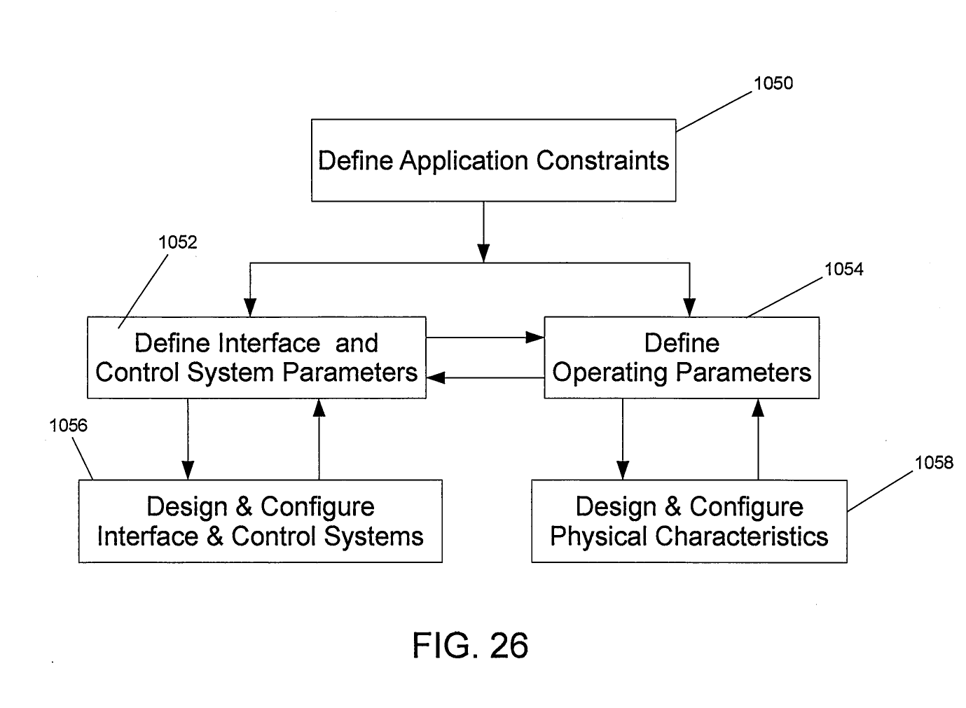

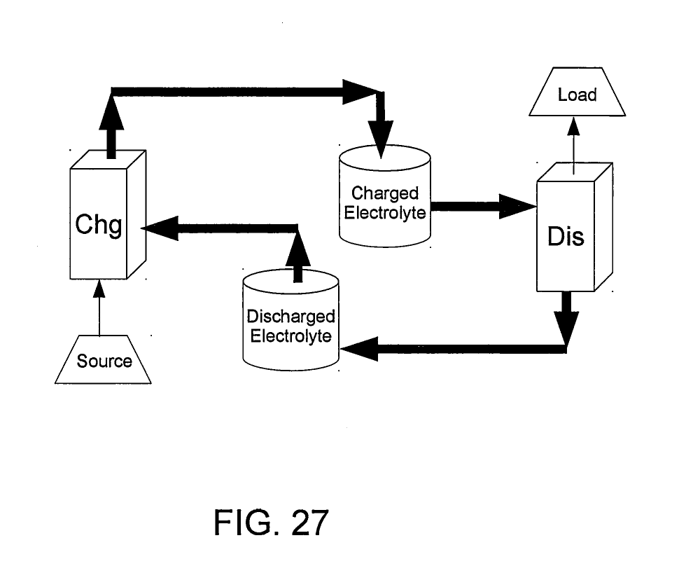

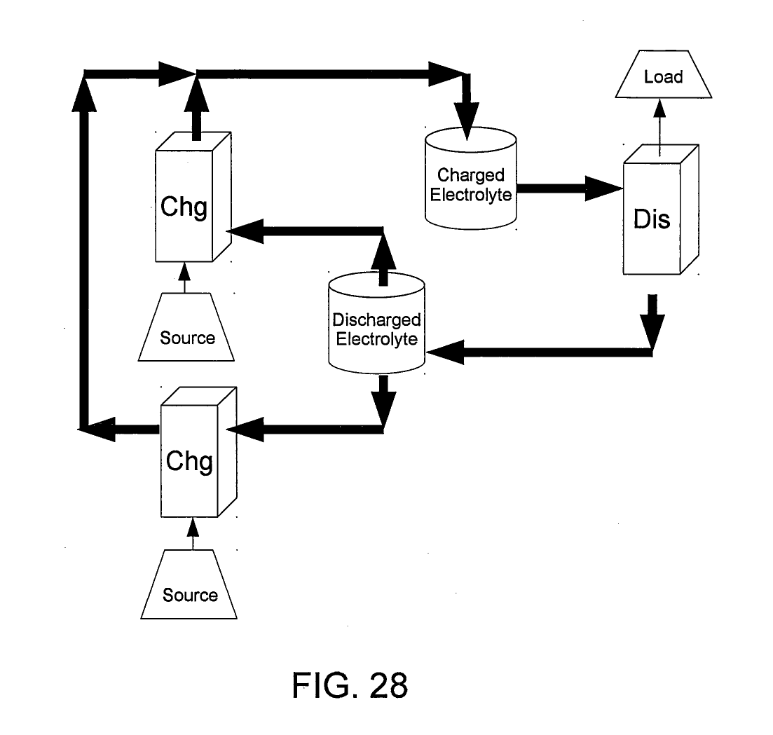

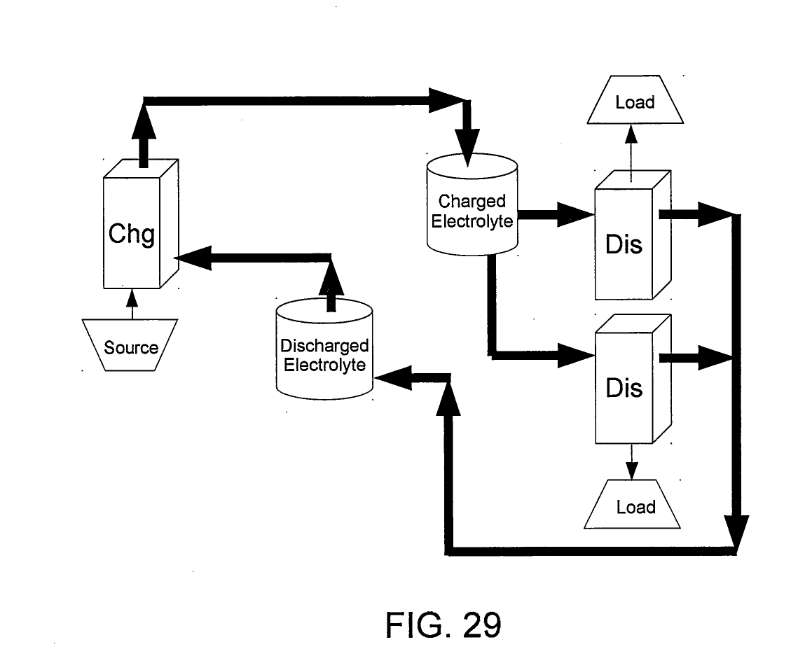

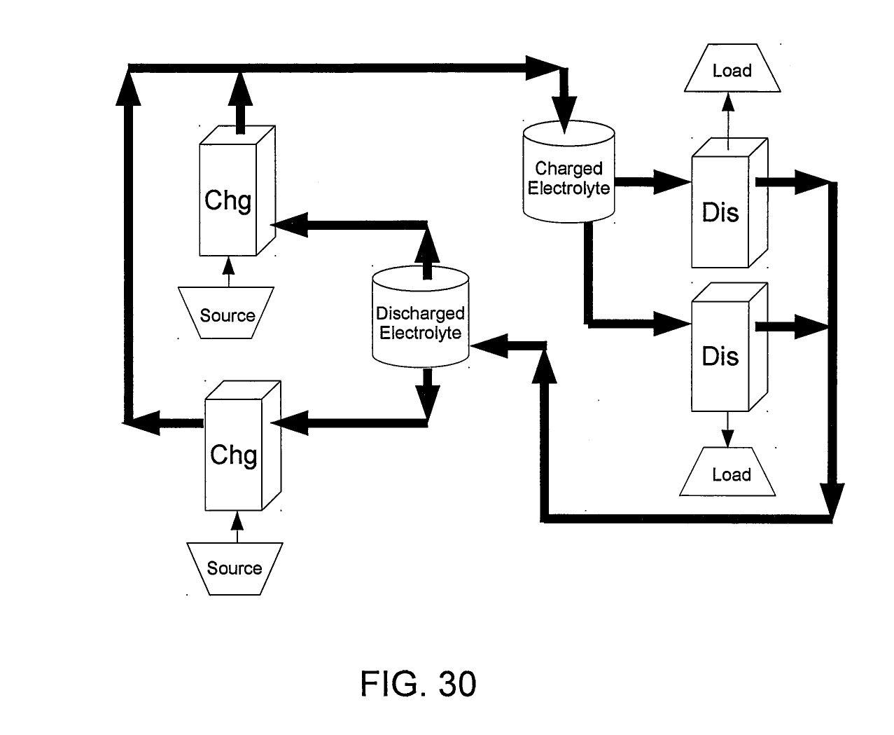

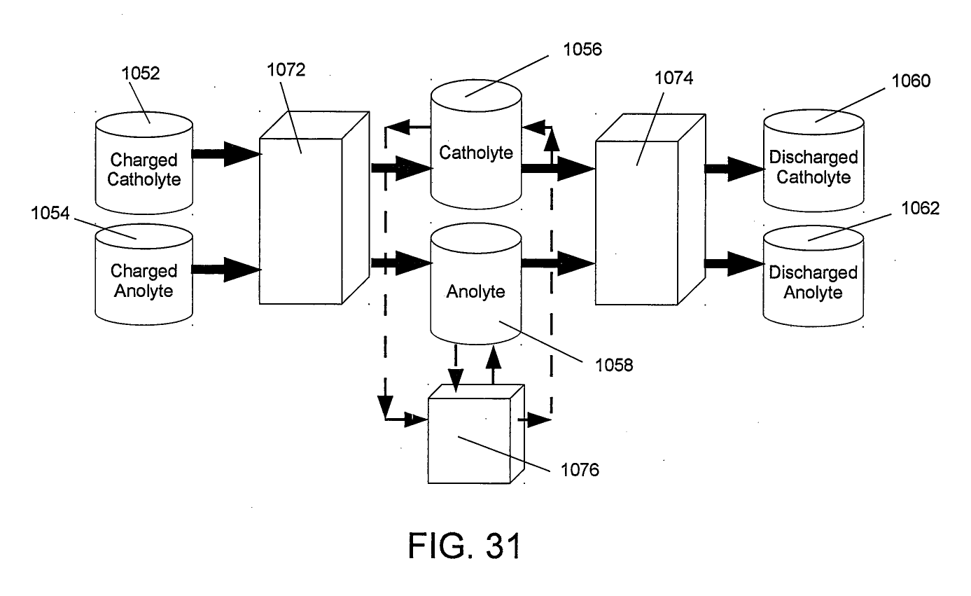

The tank separator embodiments include two forms of movable tank separator designs; a tank separator with flow passages which can be opened to enable electrolyte to flow through the separator, and a tank separator with no flow passages. Operation of these two embodiment configurations are illustrated below with reference to FIG. 19A-19F and 20A-20F.

In a first embodiment illustrated in FIG. 19A-19F, the tank separator 502 is formed from a buoyant structure or material which can float on the electrolyte reactant and includes flow passages which when closed inhibit fluids above and below the separator from intermixing, and that can be opened to allow fluids above and below the tank separator to mix. The tank separator 502 may be made, for example, from a polypropylene or polyethylene material which has a lower density than the acidic electrolyte fluid and that is resistant to corrosion by the asset. The tank separator 502 includes a valve mechanism, such as louvers 503 (as illustrated in FIG. 19A-19F), closeable openings, an array of valves, or similar structures which can be opened to allow fluid to pass through the separator structure. Opening such valve mechanisms will allow the tank separator 502 to float to the top of the electrolyte tank 26 when the discharge cycle is over. In the example embodiment illustrated in FIGS. 19A-19F, the tank separator 502 includes a number of louvers 503 which may be an arrangement of slats that form a seal when rotated into a closed position and allow fluid to flow between the slats when rotated into an opened position. In another example embodiment, the tank separator 502 may include a slideable panel on the surface which can be slid to expose a hole through the separator structure which allows the fluid to pass through.

FIGS. 19A-19F show a cross section of an electrolyte tank 26 illustrating movement of the tank separator 502 through a full discharge or full charge cycle of a redox flow battery system. FIG. 19A shows the electrolyte tank 26 with the tank separator 502 floating on the top of the electrolyte liquid 504 with its louvers 503 in the fully closed configuration. This configuration reflects the start of a charge or discharge cycle.

During a charge or discharge cycle, initial (either charged or discharged) electrolyte 504 is drawn from the tank 26 from below the tank separator 502 and passed through the redox flow battery stack assembly 10 while electrolyte exiting the battery 506 is pumped into the tank 26 on top of the tank separator 502. This is illustrated in FIG. 19B which shows the configuration of the electrolyte tank 26 and the tank separator 502 part way through a charge or discharge cycle with incoming electrolyte 506 being pumped into the electrolyte tank 26 on top of the tank separator 502 while the electrolyte 504 being fed to the redox flow battery stack assembly 10 is drawn from below the tank separator 502 (flow 34). As shown in FIG. 19B the tank separator 502 inhibits mixing of the initial (either charged or discharged) electrolytic liquid 504 with the incoming (either discharged or charged) electrolytic liquid 506.

FIG. 19C shows a portion of the charge or discharge cycle with the tank separator 502 nearing the bottom of the electrolyte tank 26 as will occur near the end of a charge or discharge cycle. At this point the louvers 503 in the tank separator 502 remain closed keeping the charged and discharged electrolytes 504, 506 separated.

FIG. 19D shows the tank separator 502 positioned near the bottom of the tank 26 where it will be at the end of a charge or discharge cycle. At this point the louvers 503 may be opened to allow the electrolyte 506 above the tank separator 502 to pass through the separator structure. Since the tank 26 is full of the same type of electrolyte 506 (either charged or discharged), the valve mechanisms can be opened and the tank separator 502 moved without causing an electrical performance penalty. FIG. 19D shows an embodiment in which louvers 503 are opened by rotating them into an open position, but another embodiment may allow fluid passage through the separator by sliding a panel to expose holes through the tank separator 502, or opening valves to enable fluid to pass through pipes through the separator structure.

Since the tank separator 502 is buoyant, opening the louvers 503 (or other valve structures) enables the tank separator 502 to begin floating towards the top of the tank. This is illustrated in FIG. 19E which shows the tank separator 502 floating back to the top of the electrolyte tank 26 as the electrolyte 506 flows through the open louvers 503. While the tank separator 502 may simply float to the top, a magnetic coupling may also be provided to assist the tank separator 502 in moving back up to the top.

When the tank separator 502 reaches the top of the electrolyte 506 as illustrated in FIG. 19F the next cycle (either charging or discharging) can begin by closing the louvers 503 in the tank separator 502 as illustrated in FIG. 19A before electrolyte 506 from the redox flow battery stack assembly is pumped back into the electrolyte tank 26.

Closing or opening the valve structures of the tank separator 502 can be controlled via an external drive which may be coupled magnetically to the valve mechanism, such as louvers 503. In this manner no wires or other connections are required between an outside controller or power supply and the separator. In a redox flow battery system the electrolyte flows through a completely closed system to avoid contact with air. This makes it difficult to perform maintenance on the valve mechanisms inside the electrolyte tank 26 for long periods. Therefore, an external control mechanism using magnetism as a coupling mechanism, for example, may have advantages for controlling the tank separator 502 inside the electrolyte tank 26.

Alternatively, the valve mechanisms or louvers 503 may be controlled by mechanical mechanisms activated by the position of the tank separator 502 within the tank 26. For example, the valve mechanisms, such as louver 503 may be configured to shut when the structure surfaces, such as a buoyant lever that latches the louvers closed when it rises above the fluid surface, and may be configured to open upon a portion of the structure contacting the bottom of the tank, such as a latch release mechanism.

In an alternative embodiment the tank separator 602 may be vertically oriented and configured to traverse the length of a horizontally disposed electrolyte tank 600 as illustrated in FIGS. 20A-20F. In this embodiment the vertical tank separator 602 does not include louvers or valve structures, and instead is configured to inhibit the fluids on either side from mixing at all times. FIG. 20A shows the electrolyte tank 26 with the vertical tank separator 602 positioned near the left end of the electrolyte tank 600 separating discharged electrolyte 606 from charged electrolyte liquid 604. This reflects the start of a charge cycle. FIG. 20B shows a portion of the charge cycle with freshly charged electrolyte 604 being pumped from the redox flow battery stack assembly 10 into the electrolyte tank 600 on one side of the vertical tank separator 602 while discharged electrolyte 606 exits the electrolyte tank 600 to flow through the redox flow battery stack assembly 10. As shown in FIG. 20B the vertical tank separator 602 inhibits the charged electrolyte 604 and discharged electrolyte 606 from mixing. FIG. 20C shows the system at a point part near the end of the charge cycle with the vertical tank separator 602 nearing the right end of the electrolyte tank 600.

To begin discharging the battery, the direction of the electrolytes flowing through the redox flow battery stack assembly 10 are reversed as shown in FIG. 20D. As discharged electrolyte is pumped into the electrolyte tank 600, the vertical tank separator 602 traverses back along the length of the electrolyte tank 600 as illustrated in FIG. 20E. Thus, as the redox flow battery system is discharged, for example, the vertical tank separator 602 traverses the electrolyte tank 600 in the other direction.

At any time the flow through the redox flow battery stack assembly 10 can be reversed in order to switch from charging to discharging, or discharging to charging. Thus, as illustrated in FIG. 20F, before the battery is fully discharged, the flow can be reversed by pumping discharged electrolyte 606 from the electrolyte tank 600 through the redox flow battery stack assembly 10 and back into the electrolyte tank 600 on the other side of the vertical tank separator 602, such as to return to storing energy.

In the embodiment illustrated in FIGS. 20A-20F the vertical tank separator 602 may be a plastic member that keeps the charged and discharged fluid apart to prevent dilution. The vertical tank separator 602 in this embodiment does not require external control since its position within the electrolyte tank 600 is controlled by the direction of the flow through redox flow battery stack assembly 10. Thus, the vertical tank separator 602 can be a relatively simple plastic panel that is suspended or configure to move freely horizontally through the electrolyte tank 600.

The seal between the tank separator 502, 602 and the electrolyte tank 26, 600 does not need to exceptionally leak proof because a small amount of leakage around the edges will have very little impact on the overall system efficiency if the tank volume is sufficiently large. Also some leakage, while undesirable, does not pose any threat to the flow battery system other than slightly reducing its overall efficiency.

Since the tank separator moves due to electrolyte being extracted from the tank when it is in one state-of-charge and reinjected when it is in the opposite state-of-charge, the position of the tank separator can function as a state-of-charge indicator. By incorporating a passive or active signaling device, such as a RFID chip or a large piece of metal, the position of the tank separator and hence the system state-of-charge, can be determined by a position sensitive reader of the signal from the RFID chip or induced magnetic field of the metal piece. Multiple RFID chips or metal pieces can be used to increase signal strength and/or provide redundancy.

The horizontal or vertical tank embodiments described in FIGS. 17, 19, and 20 can be used in the system designs described above with reference to FIGS. 13A, 13B, 13C, and 13D to create a backup power capability within the systems.

As mention above, the electrolytes stored within the tanks 214, 218 in FIG. 13A also provides a backup power capability in the power system. As an example, when the energizing sources for the charging stack (stack 1) in FIG. 13A are disconnected or go down, the discharged electrolyte from the discharging stack 212 can be directed by a 3-way valve down a piping run (not shown) that bypasses the charging stack 210 and brings the discharged electrolytes into the backend of the tank, behind a tank separator (as illustrated in FIGS. 17, 19, and 20). Charged electrolyte that feeds the discharge stack may be extracted from the front end of the tanks 214, 218 and therefore, in front of the tank separator.

Other design approaches may be used to keep charged and discharged electrolytes separate. In a first alternative approach, a bladder can be provided inside each tank for each electrolyte. The bladder could be sealed to the tank and be sized appropriately to accommodate the full volume of charged and discharged electrolytes. Discharged electrolyte may be pumped into the bladder portion of the tank, with the bladder preventing the discharged electrolyte from mixing with the charged electrolyte in the remainder of the tank. The use of an in-tank bladder is similar to the movable partition embodiment described above with reference to FIGS. 19 and 20 with the tradeoff of a sealed part for a moving part.

In a second alternative approach, a series of tanks is used for each electrolyte that in aggregate have a larger volume than the volume of electrolyte. The tanks for an electrolyte are coupled to the redox flow battery stack assembly such that the discharged and charged electrolytes are distributed among the tanks during each half cycle of the battery system. This “N+1” configuration obviates the need for a movable partition or sealed part with the tradeoff of additional plumbing, valves, and control complexity.

Other alternative designs may leverage the fact that in the discharged state the two electrolytes in the Fe/Cr mixed reactant system have identical chemical compositions. Thus, for a system that is designed to operate over a state-of-charge range that goes to full discharge (i.e., zero state-of-charge), a three tank system may be used where a first tank holds charged anolyte, a second tank holds charged catholyte, and a third, larger tank, holds the combined discharged electrolytes. In a further alternative design, one tank may be sized to hold at minimum the volumes of both the anolyte and catholyte. In a further approach, the one tank may include two partitions inside which move from the middle of the tank to the two ends. In this alternative, charged anolyte is pumped into/out of one end of the tank while charged catholyte is pumped into/out of the other end of the tank, and discharged anolyte and catholytes are pumped into/out of the middle of tank. As discharged electrolyte fills the inner section, its expanding volume pushes the partitions towards each end, compensating for the decreasing volume of the charge electrolytes. In a further alternative, bladders may be used instead of partitions to create the three separate volumes within a single tank.

All tanks in the redox flow battery system embodiments described above (except for those illustrated in FIGS. 14 and 15) can be freestanding inside a building, freestanding outdoors, placed inside a below-grade vault, or buried. Additionally, the tanks can be designed to fit within the volume of standard shipping containers. This not only makes the tanks easy to transport, when suitably sealed the outer skin of the containers can serve as secondary containment for the electrolytes.

Containerizing the electrolyte tanks described above may enable them to be more easily deployed than tanks that are constructed onsite or require custom foundations that must be built onsite. Also packaging the stacks, redox flow battery control system, and the power conditioning system inside standard shipping containers can create an entire system configuration that is easily shipped by rail and/or tractor trailer and deployed with relatively minimal onsite work. Thus, containerized redox flow battery systems can provide turn-key power energy storage systems that need only be connected to a utility grid or other source of electric power. A system design in which the containers housing the redox flow battery stacks, control system, and power conditioning system are placed above containers housing the electrolyte storage tanks yields an energy storage system that can be readily transported and set-up at the destination, and that facilitates control over electrolyte flows and full or partial draining of the stacks when the battery system is idle for short or extended periods of time.

In a further embodiment, the redox flow battery stack assembly may be configured so that the battery can perform charging and discharging operations with reactants flowing in a single direction. In one configuration, electrolyte tanks 26, 28 that allow mixing of charge and discharge electrolytes, such as shown in FIG. 1, may be used to enable rapid switching between charging and discharging modes for short periods of time by using an electrical switch 44. While compromises in design parameters may be made, such as favoring charging over discharging to enable such operations, such an embodiment can switch very quickly from charging to discharging, or from discharging to charging simply by electrically switching connections (e.g., via switch 44) between the stack and the charging power source 45 or the load 46. By maintaining reactant flows in one direction through the redox flow battery stack assembly, the delay in switching modes associated with reversing reactant flows can be avoided. In an alternative configuration, multiple tanks (e.g., described above with reference to FIG. 14) or separator tanks (e.g., described above with reference to FIGS. 17-19E) may be used in this embodiment, with valves, pumps and piping configured to direct charge or discharged electrolytes (depending upon the mode of operation) through the redox flow battery stack assembly in a single direction.

In some embodiments, it may be desirable to provide a redox flow battery system with components customized for a particular charging and/or discharging application. The following paragraphs provide modular approaches to building an all-liquid redox flow battery system in which charging functions are separated from discharging functions. Furthermore, each stack assembly may be configured for the type of power source or load. For example, in some embodiments, system components are configured for intermittent or highly variable power sources or loads. In other embodiments, system components are configured for constant-voltage, constant-power, or minimally variable power sources or loads.

As used herein, the term “flow battery stack assembly” or “stack assembly” refers to a collection of any number of electrochemical reaction cells which are electrically and hydraulically connected to one another in any orientation in order to convert electrical energy into chemical energy and/or vice versa according to system requirements.

For the purposes of the following description, charging battery stack assemblies may be configured for the degree of variability of the power source and discharging battery stack assemblies may be configured for the variability of the load. FIG. 21 illustrates a 2×2 matrix of some possible permutations assuming a simplification of the variability in the source and the load to just two levels, “low variability” and “high variability.” FIG. 21 also provides some examples of power sources and loads suitable for each of the four illustrated stack types. The skilled artisan will recognize that the degree of variability of a power source or load is a continuous range, and involves many other factors. Power variability may be expressed in any of several ways, including power magnitude, voltage, current, phase, power factor and frequency.

As shown in FIG. 21, the four stack types, labeled as Types 1-4 are configured for: (1) Charging from a highly variable source; (2) Discharging to a highly variable load; (3) Charging from a minimally variable source; and (4) Discharging to a minimally variable load.

Thus, in some embodiments a flow battery system may be created by combining at least one charging stack assembly with at least one discharging stack assembly, where one or both is configured for a particular degree of power variability of the source or load. In such embodiments, electrolytes may be charged up from a stack with one set of characteristics configured for the conditions of one or more charging sources and discharged from a stack with a different set of characteristics configured for the conditions of one or more discharge loads. The stack assembly characteristics to be considered when optimizing a stack assembly for a particular set of conditions comprise the following, among others: total power, operating voltage, operating voltage range, operating current, operating temperature, electrolyte flow rate, cell voltaic efficiency, cell coulombic efficiency, shunt currents, standby time, response time, ramp rate, and charge/discharge cycling frequency and turndown ratio.

In many embodiments, configuring a stack assembly for improved performance primarily during the charging half-cycle or the discharging half-cycle involves configuring cell components and operating parameters in order to achieve a desired efficiency of the selected half-cycle under expected operating conditions. For example, in some embodiments, cell characteristics to be configured with a preference for charging or discharging may include any the following, among other factors: operating temperature, chamber volume, mass transport rate, catalyst loading, catalyst activity, electrode design (e.g. flow-through vs. flow-by), electrode porosity, electrode felt conductivity, electrode felt/bipolar plate interface, electrolyte flow distributors, shunt channel dimension, and separator membrane selectivity.

As discussed above, a redox flow battery stack assembly may include a plurality of cells in an engineered cascade configuration, in which the cell characteristics are configured according to their position along the cascade flow path, which may also relate to an expected state-of-charge of electrolyte in the cells. For the purposes of the following discussion, such a system will be referred to as an engineered cascade redox flow battery stack assembly. Groups or blocks of one or more cells with similar configuration and exposed to similar electrolyte state-of-charge within a cascade redox flow battery stack assembly may be referred to herein as a “stage assembly” or simply a “stage”. In this manner, a cascade redox flow battery stack assembly may include two or more stages joined in hydraulic series.

As discussed above with reference to FIG. 13A (among other figures), an engineered redox flow battery stack assembly can be configured primarily or exclusively for either a charging or a discharging reaction. For example, in some embodiments, an engineered redox flow battery stack assembly 210 can be configured primarily or exclusively for a charging reaction such that a charge catalyst loading, a charge catalyst activity, an operating temperature, a mass transport rate, and a separator membrane selectivity increase along with increasing reactant state-of-charge in succeeding cells along the flow path from inlet to outlet. In contrast, a redox flow battery stack 212 may be configured for discharging such that a discharge catalyst loading, a discharge catalyst activity, an operating temperature and a mass transport rate increase, and separator membrane selectivity decrease in succeeding cells along the flow path from inlet to outlet.

The reduction/oxidation reactions used in many flow batteries exhibit a substantial correlation between reaction efficiency and temperature of the liquid electrolytes. For example, in an Fe/Cr redox flow battery, the optimum-efficiency operating temperature varies inversely with the state of charge of the electrolytes. The temperature of liquid electrolytes may be controlled by heating and/or cooling one or both the electrolytes at various points in the flow battery system. Some examples of thermal control of electrolytes in a flow battery system are discussed above. Thus, a flow battery stack assembly configured primarily for a charging reaction or a discharging reaction may be configured to heat or cool electrolytes to an operating temperature substantially near an optimum-efficiency temperature for a designed set of electrolytes and state of charge range.

Configuring a flow battery stack assembly for high performance under high vs. low power variability involves a trade-off of design factors. For example, in systems with a minimal degree of expected power variability, a stack assembly may be configured for a high operating efficiency over a narrow range of operating conditions (e.g., the voltage and/or current of the load and/or source is expected to vary minimally over time). Such low-variability systems may operate very efficiently within the designed operating range, but may also operate very inefficiently at operating conditions outside of the designed range. Alternatively, a lower operating efficiency (even under optimum conditions) may be acceptable in order to make the system operate at a higher average efficiency over a much wider range of operating conditions (e.g., when substantial variability is expected in the voltage and/or current of the load and/or source).

Thus, in configuring a stack assembly for a variable source or load, a higher degree of system efficiency may be sacrificed in favor of increased tolerance to variations in the source or load power or other operating conditions. In order to increase a flow battery stack's tolerance to such variations, the following characteristics may be desirable: a relatively fast response time, a relatively high ramp rate, a relatively large turndown ratio, a wide range of operating voltage, a wide range of operating current, and a wide range of operating temperatures. In alternative embodiments, a stack assembly configured for a highly variable source or load may be defined as one with a relatively high cycling frequency. Cycling frequency refers to the number of power-up/power-down cycles per unit time, where “power-up” refers to a change from a low-power or standby state to a desired power level, and “power-down” refers to a reduction from a desired power output level to a low-power, standby or zero power state.

In configuring a stack assembly for a minimally variable source or load, the stack assembly may be configured to operate at a relatively high efficiency within a narrow range of expected steady state conditions. In some embodiments, such a system may have a relatively slow response time, a relatively low ramp rate, a relatively small turndown ratio, and a relatively narrow range of operating voltage.

Response time refers to the time needed for a stack assembly to change from one power state to another. In some embodiments, the response time may be defined as the time needed to transition from a shutdown state to a full power state. In alternative embodiments, the response time of a stack assembly may be defined as the time to reach full power from a turned-down power state, or from a full power state to a turned-down power state. In further embodiments, the response time of a stack assembly may be defined as the time to reach full power from a standby state. A ramp rate may be defined as a rate of change in power (or other operating variable) over time. Thus, a relatively high ramp rate will correlate with a relatively short response time.

A redox flow battery stack assembly can be configured to spend a significant length of time in a standby state. In some embodiments, a standby state may be defined as a low-power or no-power state in which the stack assembly is storing or delivering a small amount or no power, but from which the stack assembly can reach a desired power level within a short time. For example, in some embodiments, a redox flow battery stack assembly may be configured with a standby state in which electrolyte circulates through reaction cells at a rate that is too fast or too slow for efficient electrochemical reactions to occur, but which allows for rapid adjustment to an operating flow rate. Such a standby state may be desirable for a stack assembly configured for a highly variable load or source, since the time to reach an operating condition may be substantially reduced relative to alternatives. In alternative embodiments, a standby state may be one in which cells are drained of electrolyte and left to contain only a non-reactive fluid. Such a standby state may be desirable for stack assemblies configured for a minimally variable source or load in which time spent in a standby state will be more predictable and less variable.

The turndown ratio of a flow battery stack assembly is a dimensionless number indicating the relative magnitudes of maximum and minimum fluid flow rates. For example, a flow battery configured to operate between a maximum electrolyte flow rate of 100 liters per minute and a minimum electrolyte flow rate of 50 liters per minute would have a turndown ratio of 2:1.

In some embodiments, the total power of a flow battery stack assembly may be configured to match the demands of a particular application. For example, a stack assembly configured for a highly variable power source or load may be configured to charge or discharge over a broad range of total power, based on the expected range of power to be produced or consumed by the source or load. Alternatively, a stack assembly configured for a minimally variable source or load may operate more efficiently by constraining the range of total power supplied to or drawn from the stack assembly.

Total power refers to the total electric power a stack assembly is capable of producing. Electric power may be represented as the product of voltage multiplied by electric current. The voltage produced by a single electrochemical reaction cell will depend on the electrochemical reaction being employed. Therefore, multiple cells may be combined and electrically connected in electrical series to produce a desired stack or system voltage. In some embodiments, cells may be combined into blocks, such that each block produces a desired voltage. Cell blocks may then be combined in electrical series in order to achieve a desired stack voltage.

In some embodiments, inefficiencies in a redox reaction may cause the reaction to be imperfectly reversible. As a result, for example, electrolytes charged to 100% SOC while consuming 100 kW of power will produce slightly less than 100 kW during discharge. In many embodiments, this difference may be managed by PCS and BMS control systems (as described in more detail below). In some embodiments, by providing separate charge and discharge stack assemblies, the difference in charge power and discharge power can be designed into the stack assembly itself.

FIGS. 22 A and 22 B illustrate two embodiments of stack assemblies with the same total operating power, but different total operating current and voltage. FIG. 22B schematically illustrates an example of a stack assembly made up of a plurality of cell blocks 1002 combined into rows and columns. In some embodiments, the stack illustrated in FIG. 22A may be configured for use exclusively as a charging stack, and the stack of FIG. 22 B may be configured for use exclusively as a discharging stack. In this embodiment, the cell blocks in each row may be electrically connected to one another in series, while electrically connecting each row in parallel to the remaining rows. In some embodiments, each cell block 1002 may be configured to receive about 100 Volts at about 300 Amperes from a source, and a group of six such cell blocks may accept about 180 kW of total charging power.

The electric current through an electrochemical reaction cell may be expressed as a function of the total active area of the cell. The active area of a cell may be defined as the area of the interface between separator membrane and porous electrodes (i.e. the area across which electrochemical reactions may occur). An increased active area may produce an increased electric current up to a point. Therefore, in some embodiments, the electric current of a stack assembly may be increased by electrically connecting a plurality of cells or cell blocks in parallel without changing the size of individual cells. This may have the effect of increasing total active area, thereby increasing total stack power without increasing stack voltage. Increasing total active area in this manner can be applied to one or more stage assemblies within an engineered cascade redox flow battery stack assembly to achieve improved performance.

Thus, in some embodiments the total power received or produced by a stack assembly may be varied by varying the number of electrochemical reaction cells (in various combinations of parallel and series connections) and/or the size of reaction cells. In some embodiments, the total power of a stack assembly may be varied by electrically and/or hydraulically connecting and/or disconnecting cell blocks without the need to physically change the arrangement of the stack assembly. In some embodiments, such hydraulic and/or electric additions and/or subtractions may be automatically controlled by an electronic control system.

The operating voltage of a flow battery system refers to the voltage at which a stack assembly is charged or discharged. Some embodiments of engineered cascade redox flow batteries as discussed above may be operated at a constant output voltage. In such embodiments, the operating voltage of an engineered cascade redox flow battery stack assembly may be varied by varying the number of electrochemical reaction cells connected in electrical series. In other embodiments, such as two-tank recirculating flow battery systems, operating voltage may vary as a function of electrolyte state-of-charge (and/or other factors) in addition to the number of cells connected in electrical series. In some embodiments, such hydraulic and/or electric additions and/or subtractions of cell blocks may be automatically controlled by an electronic control system. In alternative embodiments, the operating voltage of a stack assembly may be varied by varying an electrical resistance of a stack assembly system. Such variations in electrical resistance may be achieved by adding or removing electrical resistors (or with a variable resistor) in series with one or more cell blocks. Heat generated by such resistors may be used to heat electrolytes to a desired operating temperature.

The operating voltage range of a flow battery stack assembly refers to the range of minimum to maximum voltages at which a flow battery stack assembly may be operated. The operating voltage range may be varied by providing a stack assembly configured with a desired maximum voltage capability, and providing a control system configured for selectively reducing operating voltage as described above.

In some embodiments, a redox flow battery stack assembly may comprise a plurality of cells or stages arranged in a cascade orientation. In some embodiments, a stack assembly comprises an engineered cascade arrangement as discussed above, in which cell characteristics are configured according to an expected state-of-charge of electrolytes along the cascade flow path. Further examples of engineered cascade systems are shown and described in co-pending U.S. patent application Ser. No. 12/986,892, titled “Cascade Redox Flow Battery System,” Attorney Docket No. 1361-003CP which is incorporated herein by reference.

An engineered cascade stack assembly may be configured to perform an entire charge and/or discharge reaction (i.e. from 0% SOC to 100% SOC or vice versa) or a desired portion of a charge or discharge reaction (e.g. between 10% SOC and 90% SOC or between 10% SOC and 50% SOC) in a single pass of electrolytes (i.e. without cycling electrolytes through the stack assembly a second or subsequent times). Such a single-pass stack assembly provides advantages for a multiple independent stack system for several reasons. For example, electrolyte entering or exiting a stack assembly on charge or discharge may be at a known state-of-charge, thus simplifying controlling system output. Additionally, the state-of-charge of electrolytes in the storage tanks may be known and the overall system state-of-charge may be determined simply via mechanical means (e.g., a level of electrolytes in the charged and discharged tanks or respective sections of divided tanks). Furthermore, a system with an engineered cascade stack assembly may be operated at a markedly steadier voltage for both charge and discharge reactions, thus simplifying the controls plus the cost and complexity of power conversion.

An engineered cascade flow battery stack with a large number of stages can provide highly efficient operation for relatively constant (i.e., minimally variable) power sources and loads. In some embodiments, four or more may be considered a larger number of cascade stages. In other embodiments, three or more stages may be considered a large number. However, a stack assembly with a large number of cascade stages may also be relatively slow to respond to changes in source or load power, due to the increased time needed for all stages to reach a steady state. Therefore, the number of stages in an engineered cascade stack assembly may be inversely proportional to the variability of the source or load power.

In some embodiments, an engineered cascade stack assembly may be configured with a variable number of active stages in which one or more stages may be selectively de-activated. An active stage is one through which electrolyte flows (hydraulically) and electric current flows (electrically) during operation of the stack assembly. By cutting off the flow of electrolyte and/or electric current to a single stage, that stage can be de-activated. This allows for additional operating flexibility. In some embodiments, an engineered cascade stack assembly configured for a highly variable load may include fewer active stages than an engineered cascade stack assembly configured for a minimally variable load.

For example, in some embodiments a de-activatable stage may be sized and configured to be active during charging, but de-activated during discharging. In such embodiments, a single cascade stack assembly may be used for both charging and discharging while better managing the difference between charge power and discharge power. In still further embodiments, it may be desirable to de-activate one or more cascade stages to adjust charge or discharge power to better match source or load conditions.

FIG. 23 schematically illustrates an embodiment of an engineered cascade stack assembly configured with a variable number of active stages. The illustrated stack assembly comprises six cascade stages 1010, some or all of which may be engineered for improved performance according to the expected state-of-charge of electrolytes at each stage. For simplicity of illustration, FIG. 23 illustrates only one electrolyte flow channel 1012. The skilled artisan will recognize that a second electrolyte flow channel may be similarly configured. Electrical interconnections 1014 and an electrical bypass line 1016 are shown along the bottom of the stages 1010. Many other arrangements of cascade flow battery stack assemblies with variable numbers of active stages are also possible.

By providing an electrolyte bypass channel 1020 and valve arrangements 1022 in electrolyte flow lines between adjacent stages 1010, one or more stages may be de-activated by operating valves to direct electrolyte around the stage or stages to be de-activated. For example, a flow of electrolyte into a stage may be shut off by closing a lower branch of a three-way valve. The electrolyte may then be re-directed through the bypass channel 1020 by opening an upper branch of a three-way valve. Such an arrangement of valves may prevent electrochemical reactions from occurring in the cells of the de-activated stage (or stages). Any number of other valve arrangements may alternatively be used.

Similarly, an electrical bypass line 1016 and switch arrangements 1024 may be used to de-activate one or more stages. For example, a two-position switch 1024 between adjacent stages may be operated to open an electric circuit to a single stage, while allowing electric current to flow through the bypass line 1016. The skilled artisan will recognize that any number of other switch arrangements may alternatively be used.

In some embodiments, an engineered cascade stack assembly may be provided with additional control flexibility by providing small electrolyte buffer tanks between adjacent stages in the cascade. Providing buffer tanks allows for increased control flexibility by delaying the time of arrival of electrolytes at down-stream stages, thereby allowing for more dynamic changes of power applied to or drawn from a cascade stack assembly. In some embodiments, such buffer tanks may be sized to have a volume about equal to one, two, three, four stages or non-integer numbers of stages.

In some embodiments, it may be desirable to operate a redox flow battery over a large state-of-charge range to achieve an increased energy storage capacity and/or a smaller tank size. However, operating over a large state-of-charge range can lead to high flow rate requirements, leading to either substantially increased pumping power or to a lower stoich flow in the stacks. As used herein, the term “stoich flow” or simply “stoich” may refer to the stoichiometric ratio of reactants available to the reactants consumed for a particular reacting species. As used herein, the terms “stoich” and “stoich flow” may also refer to the ratio of the rate of supply of oxidation/reduction reactants to the rate of consumption of the oxidation/reduction reactants in an electrochemical reaction cell (or block of cells). This calculation of stoich flow is the same for both charging and discharging reactions. The rate of supply of reactants to a given cell is generally a function of the local concentration of reactants in the electrolytes and the local volumetric flow rate of electrolytes into a cell. The rate of reactant consumption is generally a function of cell construction, reactant concentration, electrolyte flow rate and electric current applied during charge or load applied during discharge.

Stoich is a dimensionless quantity that carries no units. A stoich value of 1 corresponds to conditions under which the rate of supply is equal to the rate of consumption. Thus, a stoich value of 1 is the minimum theoretical value at which a cell may operate. Due to natural inefficiencies, most actual flow battery cells will have a practical minimum operational stoich value greater than one. For example, in some embodiments, depending on a configuration of flow battery components, a minimum allowable stoich value may correspond to a stoich value of 1.3, 1.5 or even 2. A maximum possible stoich value will depend on overall system parameters, such as a total number of cells, a number of cascade stages, an operating range of SOC, operating flow rates, relative electrode chamber volumes and other factors.

For example, a “high stoich” condition in a given cell is generally one in which the cell experiences a relatively high quantity of oxidation/reduction reactants available for charging or discharging. In a flowing system, stoich may be viewed instantaneously or as a product of flow rate and reactant concentration. In some embodiments (e.g., cascade flow batteries), the two may be the same or substantially similar, since concentration may be substantially constant over time. As charging or discharging reactions occur, the concentration of reactants available for the desired charging or discharging reaction is reduced. Thus, if the flow rates and electric current in each stage in a cascade are substantially equal, the stoich in the cells of each stage will decrease linearly from inlet to outlet.

In embodiments of 2-tank re-circulating systems, the stoich can vary from a large value at the beginning of a charge or a discharge cycle, all the way down to a low stoich of ˜1.0 at the end of a cycle (assuming all cycles occur at a common constant flow rate). In embodiments of 4-tank cascade flow battery systems, cells may be arranged in a linear cascade flow in which each stage includes an equal number of cells connected in series electrically. In a linear cascade, reactions in each stage in turn change the state-of-charge by a fraction of the total SOC range of the system, leading to a linear decrease in stoich from the inlet end to the outlet end of the cascade. This occurs because the electrolytes progressively lose available reactants as the electrolytes flow from one stage to the next. Thus, in a 4-tank linear cascade system the cells and stages at the downstream end of the cascade flow path encounter a relatively low stoich. Cells at the downstream end of a cascade with significantly low stoich can experience significant performance loss, possibly causing cells to fail to operate entirely. Such poorly-operating or non-operating cells may substantially impact the overall system efficiency, and may reduce the ability to attain a large SOC range. In addition, during charge cycles, low stoich may lead to high cell voltages which may cause increased parasitic hydrogen generation.

FIG. 24a illustrates an embodiment of a flow battery stack assembly 1150 configured for substantially reducing or eliminating low stoich conditions in downstream cells without increasing the number of stages. In this configuration, referred as a converging cascade, a cascade flow battery stack assembly is configured to cause the electrolyte flow rate per cell to increase from an inlet end of the cascade (e.g. adjacent the tank 1152) to an outlet end of the cascade (e.g. adjacent tank 1154). By combining flows from many cells after each stage, the flow rate is increased on a per-cell basis in each subsequent stage. In some embodiments, this increase in flow rate may be engineered to balance with the expected decrease in electrolyte concentration in order to achieve a substantially constant stoich over the entire cascade.

In the embodiment illustrated in FIG. 24a, the electrolyte flow rate is increased in each stage (progressing from left to right) by decreasing a number of cells per stage, assuming all cells are equal in size. In alternative embodiments, the benefits of a converging cascade may also be achieved by providing cells of decreasing volume (e.g. by decreasing electrode chamber volumes and/or decreasing cell active area) in progressive stages. In such embodiments, Stage 1 may contain the same number of cells as Stage n, while the volume of the cells within each stage may converge from a large total volume in Stage 1 to a small total volume in Stage n. The active area of a cell may be defined as the area of the interface between separator membrane and porous electrodes (i.e. the area across which electrochemical reactions may occur). In some embodiments, the volume of an electrode chamber may include the active area multiplied by an electrode thickness. In other embodiments, an electrode chamber volume may include additional space not occupied by an electrode. Thus, in some embodiments, the flow volume of a cell block may be changed by changing the size of electrode chambers (and/or any other electrolyte flow spaces) in a cell. In other embodiments, flow volume of a cell block may be changed by changing a number of equally-sized cells in a block.

The converging cascade of FIG. 24A includes a linear convergence in the flow volume (i.e. the total volume of fluid passageways, including cell chambers, through which electrolytes flow, represented by the number of cells in FIG. 24A) in each stage. In alternative embodiments, the electrolyte flow volume in progressive stages may vary according to any other linear or non-linear pattern. For example, in some embodiments a converging cascade may be configured with an exponential or a step-wise decrease in electrolyte flow volume and/or the number of cells (or other changes resulting in an increase in flow rate) in each stage. In some embodiments, a converging cascade may be optimized to provide the best possible stoich in every cell. In other embodiments of a converging cascade, some variation in stoich may be acceptably balanced with other design factors, such as allowing for bi-directional flow through the stack assembly. Thus in some embodiments, a converging cascade may include a converging flow volume without necessarily optimizing for equal stoich in all stages. For example, in some embodiments, a converging cascade may comprise only a single stepwise decrease in flow volume at some point along the cascade. In some embodiments, aspects of a converging cascade may simply be used to prevent unacceptably low stoich conditions in one or more cascade stage.

FIG. 24a illustrates a charging reaction, with the low SOC tanks 1152 at the inlet end of the cascade, and the high SOC tanks 1152 at the outlet end. A converging cascade stack assembly may be configured for a discharging reaction by reversing the direction of the converging stages, that is by joining the “stage 1” end of the cascade inlet to the high SOC tanks and the “Stage n” end of the cascade to the low SOC tanks. In some embodiments, a converging cascade stack assembly may be configured to operate as an independent charge-only or discharge-only cascade stack with electrolytes flowing only in one direction (as discussed elsewhere herein). In some embodiments, separately optimized and independent charge-only and discharge-only converging cascade stacks may be utilized in the same flow battery system exclusively or with other non-converging, independent cascades.

In some embodiments, a converging cascade may be combined with other aspects of an engineered cascade by configuring cell characteristics according to an expected state-of-charge in addition to varying an electrolyte flow volume in order to decrease variations in stoich along the cascade flow path.

In alternative embodiments, a stack assembly may be configured with valves and hydraulic connections arranged to direct electrolyte through a converging cascade stage in one direction (e.g. left-to-right in the embodiment illustrated in FIG. 24a) for both charging and discharging reactions. In alternative embodiments, individual stages (or cell blocks) may be configured with valve and switch arrangements to provide a variable number of cells such that individual cells or blocks of cells may be disabled or enabled to achieve the benefits of a converging cascade. In some embodiments, it may be desirable to cause an increased flow rate (and thereby increase stoich) in cells adjacent an outlet end of a stack assembly by dynamically reducing the number of cells through which electrolytes flow in one or more stages adjacent an outlet end of a cascade.

FIG. 24B illustrates an embodiment of a bi-directional stack assembly which may be operated as a converging cascade by dynamically changing the number of cells through which electrolytes flow, thereby increasing an electrolyte flow rate and increasing stoich in the remaining operable cells. In some embodiments, a dynamic cascade such as that shown in FIG. 24B may comprise two pairs of cell blocks 1080, 1082 and 1090, 1088 arranged in hydraulic parallel with one another, and in hydraulic series with one or more central cell blocks 1084 and 1086 located between the respective pairs of parallel blocks 1080, 1082 and 1088, 1090. In each pair of parallel cell blocks, one block (e.g., 1082 & 1088, respectively) may be configured to be disabled by closing valves 1092 and 1093, respectively. For simplicity of this description, all of the individual cells in all blocks of FIG. 24B may be assumed to be the same size as one another, although this is not necessarily the case in all embodiments. In further embodiments, three or more parallel blocks may be provided, any number of which may be configured to be shut off in order to dynamically vary the size of a cascade stage.

In some embodiments, the combined volume of the parallel block pairs 1080, 1082 and 1088, 1090 may be substantially equal to or greater than the volume of the central blocks 1084 and 1086. For example, in some embodiments, the combined volume of a parallel block pair may be 100%, 105%, 110% or 125% or more of the volume of the central block(s). In some embodiments, a switchable block 1082, 1088 may be larger than a corresponding non-switchable block 1080, 1090. In such embodiments, the non-switchable blocks 1080, 1090 may be smaller than the central blocks 1084, 1086 by a designed volume. For example, in some embodiments, a switchable block may have a volume of 90%, 85%, 80%, 75%, 70%, 60% or 50% of the volume of the central block(s). The parallel blocks 1080,1082, 1088, 1090 may be sized relative to the remaining cell blocks such that shutting off a switchable cell block will ultimately have the effect of increasing the electrolyte flow rate in the non-switched block by a sufficient degree that stoich remains above a desired level. In further embodiments, multiple switchable blocks may be provided to allow for more dynamic flexibility in adjusting stoich to different operating conditions.

Thus, in some embodiments, during a charging reaction, the stack assembly of FIG. 24B may be operated with electrolytes flowing left-to-right with cell blocks 1080, 1082 and 1090 actively engaged while cell block 1088 is disabled (e.g. by closing one or both of the valves 1093). In this way, the cell volume adjacent the electrolyte inlet is greater than the cell volume adjacent the electrolyte outlet. The step-down in cell volume will cause an increase in flow rate in cells adjacent the outlet as compared with cells adjacent the inlet. Similarly, the stack assembly of FIG. 24B may be discharged with electrolytes flowing from right-to-left with cell blocks 1090, 1088 and 1080 actively engaged while block 1082 is disabled via valves 1092. By providing blocks 1080 & 1082 and/or blocks 1088 & 1090 with a combined volume greater than the central blocks, a flow rate adjacent a cascade inlet may be reduced relative to the central stages. Such an arrangement may be engineered and optimized to provide reversible bi-directional charging and discharging operations with improved stoich characteristics.

In some embodiments, the bypass plumbing may be designed to minimize the amount of non-flowing electrolyte in the cascade by positioning the blocks 1082 and 1088 vertically above the rest of the cascade and positioning the outlets of blocks 1082 and 1088 at the top of each block with minimal upstream pipe lengths. Such an arrangement may facilitate gravity draining of the stack assemblies 1082 and 1088 as well as their respective connection pipe lengths.

In some embodiments, the design restrictions of shunt channels (i.e. flow channels directing electrolyte into and out of individual cells which are sized to have a very small cross-sectional area in order to decrease incidence of shunt currents) may be relaxed, since a smaller number of cells and a lower stoich suggest a reduced risk of substantial shunt currents in the later cascade stages. Shunt channels, which can be responsible for a majority of the pressure drop in a stack, may be sized to be larger in downstream stages where the risk of shunt currents is reduced. In fact, such an increase in shunt channels for lower stoich cells may be applied to any engineered cascade flow battery stack assembly.

FIG. 25 illustrates another embodiment of a redox flow battery system configured to provide improved stoich and fast response time as well as efficient operation over a broad range of SOC during charging and discharging. The system of FIG. 25 includes an embodiment of a redox flow battery system with two electrochemical stacks 1100, 1102 each of which is arranged to operate in a re-circulating two-tank mode from a common pair of tanks 1104, 1106 configured to contain anolyte and catholyte, respectively.

In some embodiments, the stack on the left 1100 may be part of a hydraulic loop referred to in this embodiment as a “fast loop” which may be optimized for operation at relatively high electric currents and relatively high electrolyte hydraulic flow rates during both charging and discharging over a relatively narrow range of SOC (e.g., zero to 50% in some embodiments). In such embodiments the left stack 1100 may be configured to operate at a relatively high current density as compared with the right-side stack 1102. In some embodiments, the left stack 1100 may be configured with a less selective separator membrane and other cell characteristics selected for efficient operation at relatively high flow rates at low SOC.

The second stack 1102, which is part of a “slow loop,” may be optimized to operate at lower electric currents and lower electrolyte hydraulic flow rates over a much larger range of SOC (e.g., 10% to 90% in some embodiments). The slow stack 1102 may be configured with a less selective separator membrane and other cell characteristics for efficient operation at lower flow rates and higher SOC.

As illustrated, the fast stack 1100 and the slow stack 1102 may each operate in independent hydraulic loops, each of which may have one or more dedicated pumps 1110, 1111. Each stack 1100, 1102 may be operated independently and cycled as many times as needed to fully utilize the electrolytes. For example, in one embodiment of a charge operation, electrolytes may be circulated in the fast stack until a desired level of SOC is achieved (e.g. 50%). The system may then be switched to pump the electrolytes through the slow stack for the remainder of the charge operation at a slower flow rate and possibly a lower electric current.

In some embodiments, an arrangement such as that shown in FIG. 25 may include four pumps as shown. In alternative embodiments, such a stack arrangement may include only two pumps (e.g., one pump for each electrolyte). In such two-pump embodiments the selection of electrolyte flow (e.g. through either the fast loop or the slow loop) may be controlled by valve arrangements.

Because the fast stack is configured to operate at a relatively high flow rate, it may be operated at high stoich conditions during which electrolytes have relatively high levels of available reactants. Desired charge and discharge reactions occur more easily and side reactions are minimized at high stoich values. Once reactants are charged or discharged to a degree that available reactant concentrations fall below a designed threshold value, the electrolytes may be charged in the slow stack, which may be configured to operate more efficiently at low stoich values.

The principles discussed with reference to FIG. 25 may also be applied to systems with more than two stacks, wherein each stack may be optimized for a different range of flow rate and SOC. Each stack may also have its own recirculation pump and/or valve arrangements for cycling electrolyte through each loop as many times as needed to achieve desired electrolyte reactant utilization. Each of the stacks 1100, 1102 may have any number of cells as needed to meet voltage and power needs. In some embodiments, the fast stack and/or the slow stack may comprise an engineered cascade stack assembly. In some particular embodiments, the slow stack 1102 may comprise an engineered cascade with dedicated discharged electrolyte tanks (or partitions within tanks 1104 and 1106). Such a system may provide a combination of fast-response and high efficiency over a wide state-of-charge range.

FIG. 26 provides a flow chart illustrating an example of a generic process for configuring a flow battery stack assembly for a particular application. Assuming a flow battery chemistry has been chosen initially, a flow battery stack assembly may be configured for any particular application, such as charging from a photovoltaic array or discharging to the grid for ancillary support services such as ramp support, frequency regulation or backup reserve. Such a stack assembly may ultimately be combined with other stack assemblies configured for other applications in order to form a complete redox flow battery energy storage system. Once a particular application is selected, one or more constraints for meeting the needs of the application may be defined. For example, such constraints may include the total stack power, total half-cycle time (e.g. total available time for charging or discharging), total stack voltage, total stack current, stack response time, or others.

Once constraints are identified and defined for the stack assembly, a plurality of operating parameters as well as a plurality of interface and/or control system parameters may be defined. Operating parameters may include a stack assembly operating current (e.g., the electric current at which a stack assembly is operated), a current density (e.g., the electric current per unit of active cell area), a power density (e.g., power per unit of active cell area), a number of active electrochemical cells connected in series, an operating voltage, an operating temperature, or other parameters.

After initially defining operating parameters, physical characteristics of a flow battery stack assembly may be designed and configured to meet the defined operating parameters within the constraints of the application for which the stack assembly is being configured. Physical characteristics may include materials and material characteristics (e.g., including qualitative and quantitative characteristics) used for electrodes, catalysts, cell chambers, separator membranes, etc. Physical characteristics may also include pump selections, designed flow rates, use and position of shunt breakers or other shunt-current management structures, the volume of cell chambers, the total number of cells in a stack assembly, heat exchangers, etc. In many embodiments, arriving at a final stack assembly design may involve compromises and trade-offs between physical characteristics and operating parameters in order to meet the demands of the selected application.

Interface parameters may include parameters for a power conditioning system (PCS). Control system parameters may include elements of a battery management system (BMS) or other control system for operating a flow battery stack assembly. In some embodiments, a flow battery stack assembly connected to a flow battery system which includes multiple other stack assemblies may be provided with a dedicated PCS and/or BMS. In alternative embodiments, a single PCS and/or BMS may be provided for a plurality of stack assemblies within a flow battery system.

As shown in FIG. 26, some embodiments may involve using interface and/or control system parameters to define operating parameters and vice-versa. In many embodiments, both interface/control parameters and operating parameters will involve compromises in order obtain a final system design. Once control system parameters have been defined, control algorithms may be formulated in order to operate the flow battery stack assembly within the defined operating parameters to meet the demands of the defined application.

Similarly, a power conditioning system may be configured with physical and control elements to meet the defined interface parameters. A power conditioning system is generally a system configured to take power with one set of properties (e.g., varying AC power) on an input side and deliver power with a predictable set of properties on an output side. The characteristics of the power input to the PCS will often vary depending on the characteristics of the power source. In some embodiments, if the PCS is taking power from a flow battery as an input, the output may have substantially varying load requirements. Thus, depending on the needs for a particular PCS, control algorithms, inverter circuits, input conditioners (e.g., buck/boost systems) may be configured for the defined application.

As one example embodiment, the case of a flow battery stack assembly with an Fe/Cr chemistry configured for storing energy produced by a solar array will now be described. In such an embodiment, application constraints may include: a total power requirement defined by the maximum power output of the solar array and a total charge time based on peak or total sun exposure time. Operating parameters, such as current density may then be configured. In this embodiment, a current density may be selected to be relatively lower than a discharge stack assembly of a similar size. This is due to the fact that, for the Fe/Cr flow battery chemistry, the charge reaction is rate-limiting. Thus, it is desirable to maintain cell voltages within a particular range to avoid undesirable side reactions from occurring. With other chemistries, the discharge reaction may be rate limiting, and may therefore impose practical limitations on operating parameters. The desired current density may be maintained by controlling a charge current or a charging voltage.

Thus, a redox flow battery system configured for a specific combination of power sources and loads may be created by combining at least one charge stack assembly with at least one discharge stack assembly, where one or both stack assemblies may be configured for the power variability of the source or load as discussed and illustrated above. Several examples of such configured redox flow battery systems are described below.

Redox flow battery systems comprising at least one independent charge stack assembly and one or more independent discharge stack assemblies will be described with reference to FIG. 27. In some embodiments, the charge stack assembly of FIG. 27 may be configured for and connected to a highly variable power source, such as a wind turbine, a photovoltaic array, an ocean tidal power system, a wave-power system, among others. During periods when the variable source is not generating electricity (e.g., evenings for solar, or calm periods for wind) the charge stack may be idle. The discharge stack of FIG. 27 may be configured for and electrically connected to a highly variable load, such as a data center (e.g., as a UPS), an electric vehicle charging station, a battery charging/replacement station, or the electric grid to provide ancillary services such as ramp support, frequency regulation, backup reserve or other variable load grid functions such as load following.

In an alternative embodiment, the discharge stack of FIG. 27 may be configured for and electrically connected to a minimally variable or constant-power load, such as the electric grid (thereby providing baseload capacity), or an industrial facility (e.g., factory, water treatment facility, desalination plant) with substantially consistent and predictable power demands. In some embodiments, a flow battery system may include such a stack assembly combined with a charging stack configured for and connected to a highly variable power source. In this manner the two independent stack assemblies provide the means to dispatch predictable and constant power to the electrical grid thereby removing the variability of the variable energy source. The certainty of energy available for dispatch will reduce penalties from over or under-generation assessed to variable energy source system owners while also allowing the variable energy source system to provide ancillary services (frequency regulation, spinning reserve, supplemental reserve, replacement reserve, black start, etc.) and/or qualify for resource adequacy programs.

Alternatively, the charge stack of FIG. 27 may be configured for and electrically connected to a minimally variable power source, such as the electric grid or an individual power generation facility such as a coal-fired power plant, a gas-fired power plant, a diesel-fired power plant, a geothermal power plant, a hydroelectric power plant, a nuclear power plant, or one or more fuel cells, or a high-altitude wind turbine plant. Such a stack assembly may be combined with a discharge stack assembly configured for and electrically connected to a highly variable load such as those described above, thereby forming a redox flow battery energy storage and delivery system.

In further embodiments, a redox flow battery energy storage and delivery system can be formed by combining a charging stack assembly which is configured for and electrically connected to a minimally variable source (such as those described above) with a discharge stack assembly which is configured for and electrically connected to a minimally variable load, such as those described above.

FIG. 28 illustrates a redox flow battery system comprising two charge stack assemblies and one discharge stack assembly. In some embodiments, such a system may include a first charge stack configured for and electrically connected to a minimally variable power source and a second charge stack configured for and electrically connected to a highly variable power source, such as those described above. The discharge stack of FIG. 28 may be configured for and electrically connected to either a highly variable load or a minimally variable load as described above. These configurations would help the system to efficiently manage electricity generation from sites or points on the electrical grid comprising both steady and variable energy resources. An example of this configuration is a redox flow battery system with one charge stack assembly connected to a large photovoltaic array and another charge stack assembly connected to the electrical grid with a discharge stack assembly connected to a data center.

Another example of this configuration is a redox flow battery system with one charge stack assembly connected to a large photovoltaic array and another charge stack assembly connected to a diesel generator set with a discharge stack assembly connected to a set of loads such as a remote village, military forward operating base, water pump, or section of a macro electrical grid with a single point of common coupling that can be disconnected to allow it to function autonomously. In this manner the configured redox flow battery system provides an electrical system operator with the ability to maintain electrical balance amongst generation and load within a local electrical grid (also called a microgrid) as well as optimize the utilization, efficiency, uptime, lifetime, etc., of the generators.

FIG. 29 illustrates a redox flow battery system comprising one charge stack assembly and two discharge stack assemblies. In some embodiments, such a system may include at least a first discharge stack assembly configured for and electrically connected to a minimally variable load and a second charge stack assembly configured for and electrically connected to a highly variable load, such as those described above. The charge stack of FIG. 29 may be configured for and electrically connected to either a highly variable power source or a minimally variable power source as described above.

In other embodiments both discharge stack assemblies may be configured for variable loads so the resulting redox flow battery system can be charged from the grid when electricity prices and power levels are low (e.g. at night, over weekends, etc.) then provide energy for an electric vehicle charge station with one discharge stack assembly and ancillary services or load following to the grid during high price or load periods (e.g. weekday afternoons, etc.) from the other discharge stack assembly.

Alternatively, the configuration of one charge stack assembly connected to a variable source and two discharge stack assemblies helps the battery system to offer both a steady supply of power and an intermittent supply of power to the grid simultaneously to provide both baseload energy services and ancillary services or load following from a variable energy source. In this configuration the load for both discharge stack assemblies may be the same (the electrical grid or a microgrid) but the functionalities, or applications, of each discharge stack assembly may be different (e.g., baseload and ancillary services). This same approach can be utilized to supply sure, reliable power to a data center where the charge stack assembly uses electricity from the grid and one discharge stack assembly provides the baseload power to the center while another discharge stack assembly satisfies the center's varying power requirements above baseload.

A further embodiment of redox flow battery system with independent charge and discharge stack assemblies connected to one load but providing different functionalities may comprise three discharge stack assemblies: one supplying baseload power to the grid, one providing load following services to the grid, and one providing frequency regulation services to the grid. The advantage of this design is that the discharge stack assembly configurations can be optimized according to the time periods of variation for baseload (e.g., on the order of days), for load following (e.g., on the order of 30 min to 4 hrs), and for frequency regulation (e.g., on the order of 30 sec to 30 min).

FIG. 30 illustrates a redox flow battery system comprising two charge stack assemblies and two discharge stack assemblies. Such a system may include a first discharge stack configured for and electrically connected to a minimally variable load and a second charge stack configured for and electrically connected to a highly variable load, such as those described above. Such a system may also include a first charge stack configured for and electrically connected to a minimally variable power source and a second charge stack configured for and electrically connected to a highly variable power source, such as those described above. This redox flow battery system configuration would provide an electrical system operator with increased flexibility in maintaining electrical balance amongst generation and load within a local electrical grid while optimizing the utilization, efficiency, uptime, lifetime, etc of the generators.

In some embodiments, the charge and/or discharge stack assemblies may be configured as a compromise with respect to power variability. In the case of a charge stack configured as a compromise between high and low power variability, this would allow the system to be charged from the grid during times when electricity from a variable power source is not available or at low levels.

In some embodiments, a flow battery stack assembly may be configured for a highly variable load by operating the stack assembly in a two-tank mode. In a two-tank mode of operation, electrolyte is cycled between a stack assembly and a pair of tanks (one tank for each of the catholyte and the anolyte). In some embodiments, a two-tank flow battery system may be configured to cycle electrolytes through the stack assembly multiple times, charging or discharging slightly in each cycle, until the electrolytes reach a desired state of charge. Two-tank flow battery systems may be less efficient than 4-tank systems over a broad range of SOC, but they may also have much faster response times and greater operating flexibility. Two-tank flow battery systems are most efficient when operated at SOC values near 50%.

Any of the stack assemblies in any of the foregoing embodiments may be configured as traditional re-circulating stack assemblies in which electrolytes flow through all cells in parallel, or a cascade arrangement in which electrolytes flow through some cells in series. An advantage of employing a cascade design is that the input voltage for charging and output voltage when discharging may be substantially constant for substantially an entire charge or discharge cycle. The steady voltage characteristic simplifies integrating the redox flow battery system with charge sources and discharge loads. In some embodiments, cascade flow battery stack assemblies may be operated at a substantially constant electrolyte flow rate during substantially an entire charge or discharge cycle.

The embodiments of FIGS. 27 through 30 may provide the advantage of re-using the storage module (i.e. electrolyte and storage tanks) as a central storage repository for multiple independent stack assemblies configured to provide a variety of services to local and macro electrical grids. This results in a more valuable redox flow battery system as it increases the number of applications served by what is typically the highest dollar cost component of a redox flow battery system (the storage module).

FIG. 31 illustrates an embodiment of a flow battery system which is configured to operate in one or both of a two-tank mode and a four-tank mode. The illustrated system is configured as a one-direction discharging system to be electrically connected to an electric load while passing electrolytes in only a single direction. In some embodiments, such a system may be combined with a similar or other charging system. Those skilled in the art will recognize that the system of FIG. 31 may alternatively be configured for charging from a power source. Therefore, the following discussion of structure and operation of the system of FIG. 31 should also be understood to include similar structures and operations configured for charging. In still further embodiments, the system of FIG. 31 may be configured to operate bi-directionally, such that charging occurs in one direction, and discharging occurs in the reverse direction.

The system of FIG. 31 comprises a first stack assembly 1072 through which electrolyte is pumped from a pair of electrolyte tanks 1052, 1054. After exiting the first stack assembly, the electrolytes are directed into a pair of intermediate tanks 1056, 1058. Electrolytes from the intermediate tanks 1056, 1058 may then be directed into a second stack assembly 1074 and finally into a pair of discharged electrolyte tanks 1060, 1062. A third stack assembly 1076 is shown hydraulically connected to the intermediate tanks 1056, 1058.

In some embodiments, the charged electrolyte tanks 1052, 1054 may be combined with discharged electrolyte tanks 1060, 1062 such as by using tank separators or dividers as described above. In some embodiments, the intermediate tanks 1054, 1065 may be sized for a selected operating application, such as frequency regulation or time-shifting. For example, intermediate tanks sized for frequency regulation may be substantially smaller than intermediate tanks sized for time-shifting applications.

Electric interconnections are omitted from FIG. 31 for simplicity, but in some embodiments all three stack assemblies 1072, 1074, and 1076 may be electrically connected to a single load. In alternative embodiments, the first and second stack assemblies 1072, 1074 may be connected to a first load, and the third stack assembly 1076 may be connected to a second load. In further embodiments, a system such as that illustrated in FIG. 31 may be configured for charging, and may be similarly connected to one or more power sources.

In some embodiments, the system of FIG. 31 may comprise valve and flow channel arrangements configured for causing electrolyte to selectively bypass the intermediate tanks. In such arrangements, electrolytes may temporarily flow directly from an outlet of the first stack assembly 1072 to an inlet of the second stack assembly 1074.

In some embodiments, it is desirable to place sensors in electrolyte flow channels at inlets and outlets of each stack assembly, thereby facilitating closed-loop control of stack assembly operating parameters. Such sensors may include voltage meters, current meters, fluid flow meters, or instruments to facilitate measurement of electrolyte state-of-charge. For example, in some embodiments, the SOC of the electrolytes in the intermediate tanks 1056, 1058 may be unknown due to charging and/or discharging operations performed by the third stack assembly 1076. In such embodiments, it is desirable to provide instrumentation to determine the SOC of electrolytes in the intermediate tanks 1056, 1058. One example of instruments capable of measuring SOC is shown and described in U.S. Pat. No. 7,855,005.

In some embodiments, the first stack assembly 1072 may be configured and operated such that electrolyte entering the intermediate tanks 1056, 1058 is at approximately 50% SOC (e.g. between about 35% and about 65% in some embodiments, or between about 40% and about 60% in other embodiments). In such embodiments, the first stack assembly 1072 may be a cascade or an engineered cascade which may be configured to operate at a desired efficiency to perform a charge or discharge reaction over the selected range of SOC. Similarly, the second stack assembly 1074 may be a cascade or an engineered cascade configured to charge or discharge the electrolytes over the remaining range of SOC (or a portion thereof). For example, in an embodiment in which the first stack assembly 1072 is configured to charge electrolytes from about 10% up to about 50% SOC, the second stack assembly may be configured to charge electrolytes from about 50% to about 90% SOC.

The arrangement of the first 1072 and second 1074 stack assemblies with electrolyte flowing in series from one to the other is, itself a cascade arrangement. Thus, in some embodiments, the first and second stack assemblies 1072, 1074 may be operated together as a single cascade stack assembly with large buffer tanks at a mid-point (which may be an exact center or substantially displaced from an exact center in terms of SOC, flow volume, physical dimensions or any other measure). In some embodiments, one or both of the first and second stack assemblies 1072, 1074 may include engineered cascades.

The third stack assembly 1076 may be operated in a re-circulating two-tank mode using electrolytes from the two intermediate tanks 1056, 1058. In some embodiments, it may be desirable to operate the third stack assembly 1076 for charging and discharging at SOC values approximately centered around 50%. Such operation may be used, for example, for frequency regulation on electric power grids. A stack assembly designed for operation in a two-stack mode may be configured for optimum performance over a narrow range of SOC, such as from about 35% to about 65% in some embodiments or about 40% to about 60% in other embodiments, or from about 45% to about 55% in still further embodiments.

In some embodiments, the first and second stack assemblies 1072, 1074 may be operated simultaneously with the third stack assembly. In such embodiments, it may be desirable to bypass the intermediate tanks such that the first and second stack assemblies 1072, 1074 may be operated independently of the third stack assembly 176 while all three stack assemblies 1072, 1074, and 1076 operate simultaneously.

In some embodiments, hydraulic connections may also be provided to allow discharged electrolyte to be pumped from the intermediate tanks 1056, 1058 into the discharged electrolyte tanks 1060, 1062 or into a fourth charging or discharging stack assembly (not shown). For example, in embodiments in which the third stack assembly 1076 is used for time-shifting of electric charge stored in the intermediate tanks, the electrolytes may be discharged to a degree that it is desirable to pump the discharged electrolytes from the intermediate tanks 1056, 1058 to the discharged electrolyte tanks 1060, 1062.

In some embodiments, the third stack assembly 1076 may be electrically connected to a highly variable load, and the first and second stack assemblies 1072, 1074 may be electrically connected to a load with minimal power variability.

Any of the systems described above may be operated as an energy management system for a micro-grid or large, interconnected grid. For example, a system such as that in FIG. 30 may be used at or near an electric vehicle battery replacement station (EVBRS) within a large urban area. The electrolytes may be charged up from the grid or a variable energy resource system located at or near the EVBRS. The flow battery system may then be used to supply electricity to replacement electric vehicle (EV) battery packs being charged at the station, rapid EV chargers co-located at the station, to nearby facilities for reducing their on-peak power level, and/or to the electrical grid for frequency regulation, operating reserves, or ramp support.

Those skilled in the art will recognize that still further embodiments beyond those shown and described above are also possible. For example, any number of customized charge and/or discharge stack assemblies may be joined to a common source of electrolytes and/or to a common control system for coordinated operation of a large-scale energy storage and distribution system.

Embodiments of redox flow battery cells, stack assemblies and systems described herein may be used with any electrochemical reactant combinations that include reactants dissolved in an electrolyte. One example is a stack assembly containing the vanadium reactants V(II)/V(III) or V²⁺/V³⁺ at the negative electrode (anolyte) and V(IV)/V(V) or V⁴⁺/V⁵⁺ at the positive electrode (catholyte). The anolyte and catholyte reactants in such a system are dissolved in sulfuric acid. This type of battery is often called the all-vanadium battery because both the anolyte and catholyte contain vanadium species. Other combinations of reactants in a flow battery that can utilize the features and advantages of the systems described herein include Sn (anolyte)/Fe (catholyte), Mn (anolyte)/Fe (catholyte), V (anolyte)/Fe (catholyte), V (anolyte)/Ce (catholyte), V (anolyte)/Br₂ (catholyte), Fe (anolyte)/Br₂ (catholyte), and S (anolyte)/Br₂ (catholyte). In each of these example chemistries, the reactants are present as dissolved ionic species in the electrolytes, which permits the advantageous use of configured cascade flow battery cell and stack assembly designs in which cells have different physical, chemical or electrochemical properties along the cascade flow path (e.g. cell size, type of membrane or separator, type and amount of catalyst, etc.). A further example of a workable redox flow battery chemistry and system is provided in U.S. Pat. No. 6,475,661, the entire contents of which are incorporated herein by reference. Many of the embodiments herein may be applied to so-called “hybrid” flow batteries (such as a zinc/bromine battery system) which use only a single flowing electrolyte.

By virtue of the foregoing, in one embodiment the present disclosure provides a reduction-oxidation flow battery system that has an electrolyte storage and pumping system for supplying at least one electrolyte flow, a first stack assembly of reduction-oxidation cells in hydraulic communication with the at least one electrolyte flow and configured for only charging from a source of a first power variability as a function of time, and a second stack assembly of reduction-oxidation cells in hydraulic communication with the at least one electrolyte flow and configured only for discharging to a load of a second power variability as a function of time that differs from the first power variability.

In certain embodiments, the first and second stack assemblies are differently configured for one or more selected conditions of power variability consisting of total power, operating voltage, operating voltage range, operating current, operating temperature, electrolyte flow rate, cell voltaic efficiency, cell coulombic efficiency, shunt currents, standby time, response time, ramp rate, and charge/discharge cycling frequency and turndown ratio.

In various embodiments, at least one of the first and second stack assemblies of a reduction-oxidation flow battery system is configured for charge or discharge reaction respectively in a single pass.

In one embodiment, the reduction-oxidation flow battery system has a third stack assembly of reduction-oxidation cells in hydraulic communication with the at least one electrolyte flow and configured only for charging by the source of a third power variability that varies more as a function of time than the first power variability. In exemplary embodiments, the first and third stack assemblies are configured for the source that is selected from a group consisting of a photovoltaic array, a photovoltaic concentrator array, a solar thermal power generation system, a wind turbine, a hydroelectric power plant, a wave power plant, a tidal power plant, a distributed electrical grid, and a local electric grid.

In another embodiment, the reduction-oxidation flow battery system has a third stack assembly of reduction-oxidation cells in hydraulic communication with the at least one electrolyte flow and configured only for discharging by a load of a third power variability that varies more as a function of time than the second power variability. In exemplary embodiments, the second and third stack assemblies are configured for the load that is selected from a group consisting of an electric vehicle charging station, an electric vehicle battery replacement station, an electric grid, a data center, a cellular telephone station, another energy storage system, a vehicle, an irrigation pump, a food processing plant, and a local electrical grid.

In an additional embodiment, at least one of the first and second stack assembly has a first plurality of electrochemical reaction cells arranged in a first block, a second plurality of electrochemical reaction cells arranged in a second block, and a third plurality of electrochemical reaction cells arranged in a third block, wherein the first, second, and third blocks are arranged in hydraulic series along the at least one electrolyte flow, and wherein a number of electrochemical reaction cells in each block comprises a converging cascade.

In another embodiment, the present disclosure provides a reduction-oxidation flow battery energy storage system that has a first plurality of electrochemical reaction cells arranged in a first block, a second plurality of electrochemical reaction cells arranged in a second block, and a third plurality of electrochemical reaction cells arranged in a third block, wherein the first, second, and third blocks are arranged in hydraulic series along a flow path joined to a source of liquid electrolyte, and wherein a combined electrolyte flow volume of each block is based on an expected availability of electrochemical reactants in the liquid electrolyte based on expected reactant consumption of upstream blocks.

In one embodiment, the first block has a greater total electrolyte flow volume than the third block. In an exemplary embodiment the first block comprises a greater number of electrochemical cells than the third block.

In an additional embodiment, the present disclosure provides a reduction-oxidation flow battery energy storage system that has a first pair of electrolyte tanks that communicate via a first hydraulic flow path, a second pair of electrolyte tanks that communicate via a second hydraulic flow path, a first stack assembly of electrochemical reaction cells. a second stack assembly of electrochemical reaction cells, a first intermediate electrolyte tank, and a second intermediate electrolyte tank, wherein the first stack assembly, first intermediate electrolyte tank, and the second stack assembly are arranged in hydraulic series with the first hydraulic flow path between the first pair of electrolyte tanks, and wherein the first stack assembly, second intermediate electrolyte tank, and the second stack are arranged in hydraulic series with the second hydraulic flow path between the second pair of electrolyte tanks.

In one embodiment, the reduction-oxidation flow battery energy storage system has a third stack assembly of electrochemical reaction cells supplied by a third hydraulic flow path between the first and second intermediate electrolyte tanks. In an exemplary aspect, the third stack is configured for a fast response in a two tank mode.

In another embodiment, the reduction-oxidation flow battery energy storage system has at least one of the first and second stack assemblies that comprise a first plurality of electrochemical reaction cells arranged in a first block. a second plurality of electrochemical reaction cells arranged in a second block, and a third plurality of electrochemical reaction cells arranged in a third block, wherein the first, second, and third blocks are arranged in hydraulic series along the first and second flow paths, and wherein the first, second, and third blocks comprise electrochemical reaction cells individually structurally configured according to a reaction efficiency for a reaction at an expected state of charge of electrolyte in each block.

The foregoing description of the various embodiments is provided to enable any person skilled in the art to make or use the present invention. Various modifications or alternate uses of these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

What is claimed is:

1. A reduction-oxidation flow battery system, comprising:
an electrolyte storage and pumping system for supplying at least one electrolyte flow;
a first stack assembly of reduction-oxidation cells in hydraulic communication with the at least one electrolyte flow and configured for only charging from a source of a first power variability as a function of time; and
a second stack assembly of reduction-oxidation cells in hydraulic communication with the at least one electrolyte flow and configured only for discharging to a load of a second power variability as a function of time that differs from the first power variability.

2. The reduction-oxidation flow battery system of claim 1, wherein the first and second stack assemblies are differently configured for one or more selected conditions of power variability consisting of total power, operating voltage, operating voltage range, operating current, operating temperature, electrolyte flow rate, cell voltaic efficiency, cell coulombic efficiency, shunt currents, standby time, response time, ramp rate, and charge/discharge cycling frequency and turndown ratio.

3. The reduction-oxidation flow battery system of claim 1, wherein at least one of the first and second stack assemblies is configured for charge or discharge reaction respectively in a single pass.

4. The reduction-oxidation flow battery system of claim 1, further comprising a third stack assembly of reduction-oxidation cells in hydraulic communication with the at least one electrolyte flow and configured only for charging by the source of a third power variability that varies more as a function of time than the first power variability.

5. The reduction-oxidation flow battery system of claim 4, wherein the first and third stack assemblies are configured for the source that is selected from a group consisting of a photovoltaic array, a photovoltaic concentrator array, a solar thermal power generation system, a wind turbine, a hydroelectric power plant, a wave power plant, a tidal power plant, a distributed electrical grid, and a local electric grid.

6. The reduction-oxidation flow battery system of claim 1, further comprising a third stack assembly of reduction-oxidation cells in hydraulic communication with the at least one electrolyte flow and configured only for discharging by a load of a third power variability that varies more as a function of time than the second power variability.

7. The reduction-oxidation flow battery system of claim 6, wherein the second and third stack assemblies are configured for the load that is selected from a group consisting of an electric vehicle charging station, an electric vehicle battery replacement station, an electric grid, a data center, a cellular telephone station, another energy storage system, a vehicle, an irrigation pump, a food processing plant, and a local electrical grid.

8. The reduction-oxidation flow battery system of claim 1, where at least one of the first and second stack assembly comprises:
a first plurality of electrochemical reaction cells arranged in a first block;
a second plurality of electrochemical reaction cells arranged in a second block; and
a third plurality of electrochemical reaction cells arranged in a third block,
wherein the first, second, and third blocks are arranged in hydraulic series along the at least one electrolyte flow, and
wherein a number of electrochemical reaction cells in each block comprises a converging cascade.

9. A reduction-oxidation flow battery energy storage system, comprising:
a first plurality of electrochemical reaction cells arranged in a first block;
a second plurality of electrochemical reaction cells arranged in a second block; and
a third plurality of electrochemical reaction cells arranged in a third block,
wherein the first, second, and third blocks are arranged in hydraulic series along a flow path joined to a source of liquid electrolyte, and
wherein a combined electrolyte flow volume of each block is based on an expected availability of electrochemical reactants in the liquid electrolyte based on expected reactant consumption of upstream blocks.

10. The reduction-oxidation flow battery energy storage system of claim 9, wherein the first block comprises a greater total electrolyte flow volume than the third block.

11. The reduction-oxidation flow battery energy storage system of claim 10, wherein the first block comprises a greater number of electrochemical cells than the third block.

12. A reduction-oxidation flow battery energy storage system, comprising:
a first pair of electrolyte tanks that communicate via a first hydraulic flow path;
a second pair of electrolyte tanks that communicate via a second hydraulic flow path;
a first stack assembly of electrochemical reaction cells;
a second stack assembly of electrochemical reaction cells;
a first intermediate electrolyte tank; and
a second intermediate electrolyte tank,
wherein the first stack assembly, first intermediate electrolyte tank, and the second stack assembly are arranged in hydraulic series with the first hydraulic flow path between the first pair of electrolyte tanks, and
wherein the first stack assembly, second intermediate electrolyte tank, and the second stack are arranged in hydraulic series with the second hydraulic flow path between the second pair of electrolyte tanks.

13. The reduction-oxidation flow battery energy storage system of claim 12, further comprising a third stack assembly of electrochemical reaction cells supplied by a third hydraulic flow path between the first and second intermediate electrolyte tanks.

14. The reduction-oxidation flow battery energy storage system of claim 13, wherein the third stack is configured for a fast response in a two tank mode.

15. The reduction-oxidation flow battery energy storage system of claim 12, where at least one of the first and second stack assemblies comprises:
a first plurality of electrochemical reaction cells arranged in a first block;
a second plurality of electrochemical reaction cells arranged in a second block; and
a third plurality of electrochemical reaction cells arranged in a third block,
wherein the first, second, and third blocks are arranged in hydraulic series along the first and second flow paths, and
wherein the first, second, and third blocks comprise electrochemical reaction cells individually structurally configured according to a reaction efficiency for a reaction at an expected state of charge of electrolyte in each block.
